(19) United States
(12) Patent Application Publication
(10) Pub. No.: US 2025/0257008 A1
(43) Pub. Date: Aug. 14, 2025

(54) CONCRETE COMPOSITION AND METHOD OF MAKING

(71) Applicant: Colorado School of Mines, Golden, CO (US)

(72) Inventors: Lori E. Tunstall, Golden, CO (US); Julia Rae Hylton, Aurora, CO (US)

(21) Appl. No.: 19/053,104

(22) Filed: Feb. 13, 2025

Related U.S. Application Data
(60) Provisional application No. 63/552,949, filed on Feb. 13, 2024.

(51) Int. Cl. C04B 18/06; C04B 7/13; C04B 40/00; C04B 40/02; C04B 103/40

(52) U.S. Cl. CPC C04B 18/068; C04B 7/13; C04B 40/0032; C04B 40/0268; C04B 2103/408

(57) ABSTRACT

A concrete composition, the concrete composition comprising: cementitious material; carbonaceous material; reactive silica; and insoluble silicon. The concrete composition may comprise a pozzolan. The pozzolan may have pozzolanic activity. A concrete composition comprising: cementitious material; and carbonaceous material, wherein at least a portion of the carbonaceous material has no pozzolanic activity. The carbonaceous material may comprise biochar. A method of making a concrete composition, the method comprising: milling a carbonaceous material to form a milled carbonaceous material, wherein at least a portion of the milled carbonaceous material has no pozzolanic activity; combining the milled carbonaceous material with a cementitious material; contacting the cementitious material with an aggregate; contacting the cementitious material with water; and subjecting the carbonaceous material to pyrolysis.

### CROSS-REFERENCE TO RELATED APPLICATIONS

This application claims priority to and the benefit of the filing of U.S. Provisional Patent Application No. 63/552,949, entitled “BIOCHARS FOR ADDITION TO CEMENTITIOUS COMPOSITIONS, CEMENTITIOUS COMPOSITIONS COMPRISING BIOCHAR, AND METHODS OF MAKING CEMENTITIOUS COMPOSITIONS COMPRISING BIOCHAR”, filed on Feb. 13, 2024, the entirety of which is incorporated herein by reference.

### FIELD OF THE INVENTION

The present invention relates to compositions, methods, and systems for concrete compositions comprising carbonaceous material.

### BACKGROUND

Carbon emission (i.e., carbon dioxide (CO₂) emissions) must be dramatically reduced to reduce global temperatures to preindustrial levels. Carbon emissions are of particular concern in mitigating climate change as CO₂ is the most commonly emitted greenhouse gas. Manufacturing and use of cement (the active ingredient in concrete) is responsible for 8% of all anthropogenic CO₂ emissions. As the external pressure to reduce carbon emissions increases, there is a need for low-cost, high-quality alternatives to reduce their carbon footprint. Over the last decade, biochar (or “char”) has started to emerge as a competitive option to reduce embodied carbon in cement structures. Biochar, a carbon rich material made from a biomass feedstock, has been shown at lab scale to integrate into concrete as a partial cement replacement without reducing concrete's compressive strength at low dosages. Biochar has the potential to unlock carbon neutral or carbon negative concrete without sacrificing structural properties; however, not all biochars are created equal.

In the global push for industrial decarbonization, there is a need to address the concrete industry's contribution. Since cement is responsible for about 70% of the embodied carbon in concrete, replacing cement with a carbon neutral or negative material is one of the most powerful tools for reducing concrete's carbon footprint. Biochar is a carbon negative material produced from the thermochemical conversion of recycled/waste biomass. Conservative calculations estimate that one ton of biochar can sequester about 1.2 tons of CO₂. Including biochar as a carbon-sink in concrete unlocks the potential for carbon neutral or negative concrete while maintaining or improving performance metrics.

Thus, there remains a need for new methods of formulating and making a concrete comprising one or more biochars that may decrease the impact of concrete production and use on the global environment while maintaining or improving the strength of the concrete.

Biochar has been shown to densify a hydrated cement matrix, and through careful integration, may improve concrete strength. Conventionally, a maximum of 5% of the cement is replaced with biochar, limiting carbon sequestration to about 17% less than an ordinary Portland cement (“OPC”) mix. The present disclosure achieves replacement levels of cement mass with biochar up to about 50% yielding comparable compressive strength while achieving a carbon neutral or negative material. Biochar in concrete offers a solution that offsets the emissions associated with cement production, exhibits comparable strength performance, and uses recycled biomass that would otherwise decompose and contribute to global CO₂ emissions.

### BRIEF SUMMARY OF THE INVENTION

Embodiments of the present invention relate to concrete composition, the concrete composition comprising: cementitious material; carbonaceous material; reactive silica; and insoluble silicon. In another embodiment, the concrete composition further comprises a pozzolan. In another embodiment, the pozzolan has pozzolanic activity. In another embodiment, the carbonaceous material comprises biochar. In another embodiment, the composition further comprises a supplementary cementitious material. In another embodiment, the composition further comprises a dispersing agent. In another embodiment, the biochar comprises at least about 60% organic material by weight.

Embodiments of the present invention relate to a concrete composition comprising: cementitious material; and carbonaceous material, wherein at least a portion of the carbonaceous material has no pozzolanic activity. In another embodiment, the carbonaceous material comprises biochar. In another embodiment, the concrete composition further comprises a supplementary cementitious material. In another embodiment, the concrete composition further comprises a dispersing agent. In another embodiment, the biochar comprises at least about 40% organic material by weight. In another embodiment, the concrete composition comprises soluble silicon.

Embodiments of the present invention also relate a method of making a concrete composition, the method comprising: milling a carbonaceous material to form a milled carbonaceous material, wherein at least a portion of the milled carbonaceous material has no pozzolanic activity; combining the milled carbonaceous material with a cementitious material; contacting the cementitious material with an aggregate; contacting the cementitious material with water; and subjecting the carbonaceous material to pyrolysis. In another embodiment, the carbonaceous material comprises a biochar. In another embodiment, the biochar comprises ash. In another embodiment, the method further comprises contacting the cementitious material with a dispersing agent. In another embodiment, the water to cementitious material ratio is about 0.3 to about 0.7. In another embodiment, the pyrolysis is a slow pyrolysis. In another embodiment, the method further comprises curing the milled carbonaceous material and cementitious material.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIGS. 1A and 1B are images showing scanning electron microscopy (“SEM”) images taken of a woody biochar prepared by slow pyrolysis before and after milling, respectively, according to an embodiment of the present invention;

FIG. 2 is a graph showing a comparison of soluble ion concentrations in deionized (“DI”) water for biochar samples prepared from different feedstocks and by different pyrolysis techniques, according to an embodiment of the present invention;

FIG. 3 is a graph showing a comparison of soluble ion concentrations in a simulated cement pore solution for biochar samples prepared from different feedstocks and by different pyrolysis techniques, according to an embodiment of the present invention;

FIG. 4 is a graph showing a comparison of pH values for biochar samples prepared from different feedstocks and by different pyrolysis techniques, according to an embodiment of the present invention;

FIG. 5 is a graph showing the particle size distribution of various biochar samples prepared from different feedstocks and by different pyrolysis techniques, according to an embodiment of the present invention;

FIG. 6 is a graph showing a comparison of the compressive strengths of concrete compositions comprising biochars prepared from different feedstocks and by different pyrolysis techniques, according to an embodiment of the present invention;

FIG. 7 is a graph showing a comparison of unconfined compressive strengths of concrete compositions comprising biochars prepared from different feedstocks and by different pyrolysis techniques, according to an embodiment of the present invention;

FIG. 8 is an image showing a comparison of the fracture behavior of a control concrete composition without biochar and a concrete composition comprising biochar following unconfined compressive strength tests, according to an embodiment of the present invention;

FIG. 9 is a plot showing the results of the principal component analysis performed on the compressive strength data of concrete compositions comprising biochars prepared from different feedstocks and by different pyrolysis techniques, according to an embodiment of the present invention;

FIG. 10 is a plot showing the predicted compressive strength versus the measured compressive strength of concrete compositions comprising biochars prepared from different feedstocks and by different pyrolysis techniques, according to an embodiment of the present invention;

FIG. 11 is an illustration showing a comparison of different methods of thermochemical conversions of biomass and the resulting byproducts, according to an embodiment of the present invention;

FIG. 12 is a table showing a comparison of pyrolysis techniques used to prepare biochars, according to an embodiment of the current invention;

FIG. 13 is a graph showing the mass percent contribution of each component of the control concrete composition without biochar and a concrete composition comprising biochar, according to an embodiment of the current invention;

FIG. 14 is a graph showing the ultimate analysis of each biochar segmented by feedstock, according to an embodiment of the current invention;

FIG. 15 is a graph showing the x-ray fluorescence (“XRF”) analysis of concentrations of select oxides in biochars prepared from different feedstocks and by different pyrolysis techniques reported as wt. % of total ash content, according to an embodiment of the current invention;

FIG. 16 is an illustration showing a model of biochar particles with different amounts of adsorbed ambient moisture and available water uptake potential, according to an embodiment of the current invention;

FIG. 17 is an illustration showing an example of an acidic oxygen functional group deprotonating in an alkaline environment to form water, according to an embodiment of the current invention;

FIG. 18 is a graph showing the interparticle spacing of concrete compositions comprising biochars prepared from different feedstocks and by different pyrolysis techniques, according to an embodiment of the current invention;

FIG. 19 is a graph showing the shear rates of concrete compositions comprising biochars prepared from different feedstocks and by different pyrolysis techniques, according to an embodiment of the current invention;

FIG. 20 is a table showing a comparison of calculated carbon emission values of concrete compositions comprising biochars prepared from different feedstocks versus a control concrete composition without biochar, according to an embodiment of the current invention;

FIG. 21 is a graph showing the compressive strengths (in megapascals (“MPa”)) of concrete compositions comprising biochars prepared from different feedstocks and by different pyrolysis techniques with different percentages of biochar replacement of cement in the compositions, according to an embodiment of the current invention;

FIG. 22 is a table showing the compressive strengths (in MPa) of concrete compositions comprising biochars prepared from different feedstocks with different percentages of biochar replacement of cement in the compositions, according to an embodiment of the current invention;

FIG. 23 is a table showing the carbon emission values of OPC, sample biochars, and fly ash, according to an embodiment of the invention;

FIG. 24 is a table showing the elemental mass percent analysis results of biochars prepared from different feedstocks and by different pyrolysis techniques, according to an embodiment of the current invention;

FIG. 25 is a table showing the linear model coefficients of three identified characteristic variables which may contribute to the relative compressive strengths in concrete compositions comprising biochar, according to an embodiment of the current invention;

FIGS. 26A and 26B are tables showing the summary of results for relevant predictor characteristics for compressive strengths of concrete compositions comprising biochars prepared from different feedstocks and by different pyrolysis techniques and the naming convention key, respectively, according to an embodiment of the current invention;

FIGS. 27A, 27B, 27C, and 27D are tables showing the relative amounts of cement, water, aggregate, sand, superplasticizer, and biochar used in a control concrete composition without biochar, a concrete composition comprising 5 wt. % biochar, a concrete composition comprising 10 wt. % biochar, and a concrete composition comprising 15 wt. % biochar, respectively, according to an embodiment of the current invention;

FIGS. 28A, 28B, and 28C are tables with corresponding graphs showing the concrete slump values for a control concrete composition without biochar and concrete compositions comprising increasing concentrations of biochar and further comprising different superplasticizers, according to an embodiment of the current invention;

FIGS. 29A and 29B are graphs showing the relative compressive strengths for a control concrete composition without biochar and concrete compositions comprising increasing concentrations of biochar and further comprising different superplasticizers for water-cured and air-cured concrete compositions, according to an embodiment of the current invention;

FIG. 30 is a graph showing the CO₂ lost from decomposing carbonates in a control cement paste without biochar and a cement paste comprising biochar, according to an embodiment of the current invention;

FIG. 31 is a table showing a comparison of the ambient saturation percentage, soluble silica content, and O/C ratio for two different biochars, BC10 and BC11, according to an embodiment of the current invention;

FIG. 32 is an illustration showing the experimental setup used to analyze the chemical interactions of biochars contacted with a simulated cement pore solution, according to an embodiment of the current invention;

FIG. 33 is a graph showing inductively coupled plasma (“ICP”) analysis of biochars contacted with a simulated cement pore solution, according to an embodiment of the current invention;

FIGS. 34A, 34B, 34C, and 34D are graphs showing the attenuated total reflectance Fourier transform infrared spectroscopy (“ATR-FTIR”) data of biochars contacted with a simulated cement pore solution, according to an embodiment of the current invention;

FIG. 35 is a scanning electron microscope (“SEM”) image showing a biochar following 18-hour contact with a simulated pore solution showing crystal growth of CaCO₃ on the surface of the biochar particles, according to an embodiment of the current invention;

FIG. 36 is a graph showing the thermal decomposition results of a biochar after contact with a simulated cement pore solution, according to an embodiment of the current invention;

FIG. 37 a graph showing the XRD analysis of a biochar after contact with a simulated cement pore solution, according to an embodiment of the current invention;

FIG. 38 is a graph showing the inductively coupled plasma-atomic emission spectrometry (“ICP-AES”) analysis results for ion concentrations for biochars prepared from different feedstocks and by different pyrolysis methods after contacting the biochars with DI water, according to an embodiment of the current invention;

FIG. 39 is a graph showing the ICP-AES analysis results for ion concentrations for biochars prepared from different feedstocks and by different pyrolysis methods after contacting the biochars with a simulated cement pore solution, according to an embodiment of the current invention;

FIGS. 40A and 40B are graphs showing alkalinity titrations for biochars prepared from different feedstocks and by different pyrolysis methods after contacting the biochars with either DI water or a simulated cement pore solution, respectively, according to an embodiment of the current invention; and

FIGS. 41A and 41B are images showing the CaCO₃ crystal growth on a biochar particle contacted with simulated cement pore solution for 10 minutes and 4 hours, respectively, according to an embodiment of the current invention.

### DETAILED DESCRIPTION OF THE INVENTION

Embodiments of the present disclosure relate to concrete compositions with carbonaceous material as a partial cement replacement. Embodiments of the present disclosure relate to concrete compositions with supplementary cementitious material as a partial cement replacement. Embodiments of the present disclosure also relate to concrete compositions with no cement replacement with carbonaceous material but with carbonaceous material used as a filler material. Embodiments of the present disclosure also relate to concrete compositions with no cement replacement with supplementary cementitious material but with ash used as a filler material. Embodiments of the present disclosure also relate to concrete compositions with a combined carbon offset from carbonaceous material and supplementary cementitious material used as partial cement replacements. Embodiments of the present disclosure also relate to concrete compositions comprising cement and carbonaceous material. Embodiments of the present disclosure also relate to concrete compositions comprising cement, carbonaceous material, ash, active silica, or a combination thereof.

Embodiments of the present disclosure also relate to the identification of characteristics of carbonaceous material that may be used for selecting and/or making carbonaceous material suitable for high cement replacement levels in concrete (e.g., up to about 77 percent by weight (“wt. %”) cement replacement). Non-limiting examples of characteristics that impact an ability of a carbonaceous material to be used in a cement composition include the pozzolanic ability of the carbonaceous material, the weight percentage of carbon in the carbonaceous material, the weight percentage oxygen in the carbonaceous material, the carbonaceous material's ambient saturation percentage, oxygen/nitrogen (“O/N”) atomic ratio, ambient moisture percent, CaO wt. %, Na₂O wt. %, SiO₂ wt. %, SO₃ wt. %, carbon/nitrogen (“C/N”) atomic ratio, Brunauer-Emmett-Teller (“BET”) surface area, D10 particle size, D50 particle size, dissolved anions in water, dissolved cations in water, dissolved mass in water, potassium (K) ions soluble in water, soluble silicon (Si) ions in water, effective water/cement ratio, fixed carbon content, flow percentage of the cement, hydrogen/carbon (“H/C”) atomic ratio, nitrogen wt. %, non-organic oxygen/carbon wt. %, non-organic oxygen wt. %, oxygen/carbon (“O/C”) atomic ratio, interparticle distance, ambient saturation percent, cations consumed from pore solution, mass consumed from pore solution, cations dissolved into pore solution, mass dissolved into pore solution, calcium (Ca) ion concentration in pore solution, magnesium (Mg) ion concentration in pore solution, sodium (Na) ion concentration in pore solution, pore solution sorption capacity, particle shear rate, pyrolysis process, water sorption capacity, (nitrogen+oxygen)/carbon atomic ratio, or a combination thereof.

The composition may be a concrete composition comprising cement and carbonaceous material. The carbonaceous material may comprise carbonaceous material. The carbonaceous material may comprise a non-pozzolanic carbonaceous material. The concrete composition may further comprise supplementary cementitious material. The addition of supplementary cementitious material may be as a partial replacement for cement in a concrete composition. The addition of supplementary cementitious material may result in a decrease in calculated carbon emissions when compared to the control concrete composition without carbonaceous material. The composition may comprise silica. The silica may be reactive.

The concrete composition may further comprise a dispersing agent. The dispersing agent. The dispersing agent may comprise a superplasticizer, water reducer, or a combination thereof. The concrete composition may further comprise water. The water may be in a water to cement (“w/c”) ratio of at least about 0.3, about 0.3 to about 0.7, about 0.4 to about 0.6, or about 0.7.

The concrete composition may further comprise an aggregate. The aggregate may comprise a coarse aggregate. The concrete may comprise a fine aggregate.

The concrete composition may comprise at least about 0.5%, about 0.5% to about 80%, about 1% to about 75%, about 5% to about 70%, about 10% to about 60%, about 15% to about 55%, about 20% to about 50%, about 25% to about 45%, about 30% to about 40%, or about 80% replacement of cement mass with carbonaceous material. The carbonaceous material may comprise at least about 0.5%, about 0.5% to about 80%, about 1% to about 75%, about 5% to about 70%, about 10% to about 60%, about 15% to about 55%, about 20% to about 50%, about 25% to about 45%, about 30% to about 40%, or about 80% organic material by weight, with the remaining material being inorganic material. The concrete composition may comprise at least about 2%, about 2% to about 80%, about 5% to about 75%, about 10% to about 70%, about 15% to about 65%, about 20% to about 60%, about 25% to about 55%, about 30% to about 50%, about 35% to about 45%, or about 80% carbonaceous material by weight. The concrete composition may comprise a plurality of carbonaceous materials. The plurality of carbonaceous materials may be derived from a plurality of carbon inputs.

The concrete composition may demonstrate carbon footprint offsets above 100% compared to concrete that does not comprise carbonaceous material. The carbonaceous material may maintain or improve the strength of a concrete composition comprising carbonaceous material compared to a concrete composition that does not comprise carbonaceous material.

The concrete composition may comprise a compressive strength of at least about 5 MPa, about 5 MPa to about 120 MPa, about 10 MPa to about 110 MPa, about 20 MPa to about 100 MPa, about 30 MPa to about 90 MPa, about 40 MPa to about 80 MPa, about 50 MPa to about 70 MPa, or about 120 MPa. The concrete composition comprising carbonaceous material may comprise an increased compressive strength of at least about 0%, about 0% to about 50%, about 5% to about 45%, about 10% to about 40%, about 15% to about 35%, about 20% to about 30%, or about 50% over the compressive strength of a concrete composition without carbonaceous material. The ability of a carbonaceous material to maintain or increase the compression strength of a concrete composition comprising carbonaceous material may vary depending on parameters used to prepare the carbonaceous material including, but not limited to, the feedstock, pyrolysis type, pyrolysis temperature torrefaction type or temperature, gasification type or temperature, or a combination thereof. The ability of a carbonaceous material to maintain or increase the compression strength of a concrete composition comprising carbonaceous material may vary depending on the characteristics of the carbonaceous material including, but not limited to, oxygen content, carbon content, the O/C ratio, the soluble silicon content, the ambient saturation of the carbonaceous material, or a combination thereof.

The carbonaceous material may comprise a low O/C ratio, e.g., an O/C ratio of at least about 0, about 0 to about 10, about 0.5 to about 9.5, about 1 to about 9, about 1.5 to about 8.5, about 2 to about 8, about 2.5 to about 7.5, about 3 to about 7, about 3.5 to about 6.5, about 4 to about 5, about 4.5 to about 5.5, or about 10. The carbonaceous material may comprise at least about 5%, about 5% to about 95%, about 10% to about 90%, about 20% to about 80%, about 30% to about 70%, about 40% to about 60%, or about 95% carbon by weight. The carbonaceous material may comprise at least about 1 mg/L, about 1 mg/L to about 50 mg/L, about 5 mg/L to about 45 mg/L, about 10 mg/L to about 40 mg/L, about 15 mg/L to about 35 mg/L, about 20 mg/L to about 30 mg/L, or about 50 mg/L soluble silicon. The soluble silicon may comprise at least about 0.01% about 0.01% to about 0.5%, about 0.05% to about 0.45%, about 0.1% to about 0.4%, about 0.15% to about 0.35%, about 0.2% to about 0.3%, or about 0.5% by weight of the total carbonaceous material weight. About one gram of carbonaceous material may be used per about 100 g of water. The carbonaceous material may comprise a low ambient saturation. As used herein, a low ambient saturation means carbonaceous material comprising at least about 0%, about 0% to about 50%, about 5% to about 45%, about 10% to about 40%, about 15% to about 35%, about 20% to about 30%, or about 50% by weight of its total adsorption capacity occupied or filled by ambient moisture.

The concrete composition comprising carbonaceous material may increase carbon sequestration levels compared to concrete compositions that do not comprise carbonaceous material. The concrete compositions comprising carbonaceous material may lower carbon emission levels compared to concrete compositions that do not comprise carbonaceous material. The concrete composition comprising carbonaceous material may comprise a reduced carbon footprint of at least about 2%, about 2% to about 95%, about 5% to about 90%, about 10% to about 85%, about 15% to about 80%, about 20% to about 75%, about 25% to about 70%, about 30% to about 65%, about 35% to about 60%, about 40% to about 55%, about 45% to about 50%, or about 90% compared to the carbon footprint of a concrete composition without carbonaceous material. The concrete composition may be carbon neutral. The concrete composition may be carbon negative.

Embodiments of the present invention may comprise a method of characterizing a carbonaceous material integrated in a concrete composition comprising a carbonaceous material that may comprise: preparing a carbonaceous material comprising a mean particle size (D50) less than about 20 microns; measuring one or more parameters associated with the prepared carbonaceous material; and providing the one or more of the parameters for the prepared carbonaceous material.

Embodiments of the present invention may comprise a method of making a concrete composition, the method comprising: milling a carbonaceous material to form a milled carbonaceous material; contacting the milled carbonaceous material with a cementitious material to form a concrete composition comprising carbonaceous material. The carbonaceous material may comprise a non-pozzolanic carbonaceous material. The carbonaceous material may be milled to a minimum particle size (D10) of at least about 2.5 micrometers (“μm”), about 2.5 μm to about 5 μm, about 3 μm to about 4 μm, or about 5 μm. The carbonaceous material may be milled to a minimum particle size (D95) of at least 15 μm, about 15 μm to about 30 μm, about 20 μm to about 25 μm, or about 30 μm. The carbonaceous material may be milled to a mean particle size (D50) of at least about 0.01 μm, about 0.01 μm to about 20 μm, about 0.05 μm to about 18 μm, about 0.1 μm to about 15 μm, about 0.5 μm to about 12 μm, about 1 μm to about 10 μm, about 2 μm to about 9 μm, about 3 μm to about 8 μm, about 4 μm to about 7 μm, about 5 μm to about 6 μm, or about 20 μm. The milled carbonaceous material particles comprise an average pore size of at least about 12 Angstroms (“Å”), about 12 Å to about 14 Å, about 12.5 Å to about 13.5 Å, or about 14 Å.

The method of making a concrete composition may further comprise contacting the cementitious material and/or carbonaceous material with water. The water to cementitious material ratio (“w/c”) may be at least about 0.3, about 0.3 to about 0.7, about 0.35 to about 0.65, about 0.4 to about 0.6, about 0.45 to about 0.55, or about 0.7. The method of making a concrete composition may further comprise contacting the cementitious material and/or carbonaceous material with a dispersing agent. The method of making a concrete composition may further comprise contacting a dispersing agent with water to form a water-dispersing agent mixture. The method of making a concrete composition may further comprise contacting the cementitious material and/or carbonaceous material with the water-dispersing agent mixture.

The method of making a concrete composition may further comprise contacting the cementitious material and/or carbonaceous material with an aggregate. The method of making a concrete composition may further comprise contacting the cementitious material and/or carbonaceous material with supplementary cementitious material.

In an aspect of the present disclosure, a method of manufacturing a cementitious composition comprising a biochar comprises selecting a biochar from a set of biochars based at least in part on the biochar comprising one or more of a carbon content between about 10 wt. % and about 90 wt. %, an oxygen to carbon ratio between about 0 and about 10, an ambient saturation less than about 20 wt. %, and a soluble silicon content between about 0 and about 1 wt. %; and mixing a cement powder with the selected biochar to form the cementitious composition, wherein the biochar comprises between about 2 and 50 wt. % of the total cementitious composition.

In embodiments, the selected biochar may have a pH between about 6 and about 13.

In embodiments, the selected biochar comprises between about 0 and about 80 wt. % fly ash.

In embodiments, the selected biochar may have a mean particle size (D_{v,50}) less than about 20 microns.

In embodiments, the selected biochar may have a mean particle size (D_{v,50}) less than about 10 microns.

In another aspect of the present disclosure, a biochar for the partial replacement of cement in a concrete composition has one or more of an ambient saturation between about 0 and about 20 wt. %; a carbon content between about 10 and about 90 wt. %; and an oxygen to carbon ratio between about 0 and about 1.

In embodiments, the biochar may have a pH between about 6 and about 13.

In embodiments, the biochar may have a soluble silicon content between about 0 and about 1 wt. %

In embodiments, the biochar may have a mean particle size (D_{v,50}) less than about 20 microns.

In embodiments, the biochar may have a mean particle size (D_{v,50}) less than about 10 microns.

In embodiments, the biochar may be derived from at least one of fast pyrolysis, slow pyrolysis, flash carbonization, and gasification.

In embodiments, the biochar may be derived from a feedstock selected from the group consisting of softwood, hardwood, herbaceous material, agricultural residues, food, wastes, agricultural feedstocks, forestry residues, municipal solid wastes, wastepaper, pulp and paper mill residues, and combinations thereof.

In another aspect of the present disclosure, a cementitious composition comprises a cement; and one or more biochars, wherein the one or more biochars are dispersed within the cement, and wherein a total weight of the cementitious composition comprises between about 5 wt. % and 50 wt. % of the one or more biochars.

In embodiments, the one or more biochars may comprise between about 10 wt. % and about 90 wt. % carbon.

In embodiments, the one or more biochars may have an oxygen to carbon ratio between about 0 and about 1.

In embodiments, the one or more biochars may have an ambient saturation between about 0 and about 20 wt. %

In embodiments, the one or more biochars may have a soluble silicon content between about 0 and about 1 wt. %

In embodiments, the one or more biochars may comprise between about 0 and about 80 wt. % fly ash.

In embodiments, the cementitious composition may be used to manufacture a concrete composition, and the 28-day compressive strength of the concrete composition comprising the cementitious composition may be between about 40 and about 80 MPa.

In embodiments, the compressive strength of the concrete composition may be increased up to about 50% compared to a concrete composition manufactured without biochar.

In another aspect of the present disclosure, a method of preparing a carbon-negative concrete composition comprises combining a cement material, a biochar, and an aggregate material to form a dry mixture; and adding water to the dry mixture to obtain a water to cement ratio (w/c) between about 0.3 and about 0.65, wherein at least about 2 wt. % of the carbon-negative concrete composition comprises the biochar.

In embodiments, prior to adding the water to the dry mixture, about 10 wt. % of the total water may be mixed with a superplasticizer to form a superplasticizer mixture and about 90 wt. % of the total water may be added to the dry mixture to form the cementitious composition, and the method may further comprise adding the superplasticizer-water mixture to the cementitious composition to obtain the water to cement ratio (w/c) between about 0.3 and about 0.65.

In embodiments, the biochar may comprise between about 10 wt. % and about 90 wt. % carbon.

In embodiments, the biochar may have an oxygen to carbon ratio between about 0 and about 1.

In embodiments, the biochar may have an ambient saturation between about 0 and about 20 wt. %

In embodiments, the biochar may have a soluble silicon content between about 0 and about 1 wt. %

In embodiments, the biochar may comprise between about 0 and 80 wt. % ash content.

In embodiments, the carbon-negative concrete composition may have a 28-day compressive strength between about 40 and about 80 MPa.

In embodiments, the strength of the carbon-negative concrete composition may be increased up to about 50% by the addition of the biochar.

In embodiments, the carbon-negative concrete composition may further comprise water, one or more additives, one or more superplasticizers, or a combination thereof.

In embodiments, the aggregate material may be selected from the group consisting of sand, gravel, crushed stone, and combinations thereof.

In another aspect of the present disclosure, a method of manufacturing a biochar for use in a concrete composition comprises selecting a feedstock; applying a pyrolysis method at a set temperature to the feedstock to convert the feedstock to biochar suitable for use in the concrete composition; and milling the biochar to a mean particle size (D_{v,50}) of not greater than 20 microns.

In embodiments, the pyrolysis method may comprise at least one of fast pyrolysis, slow pyrolysis, flash carbonization, and gasification.

In embodiments, the biochar may be milled to a mean particle size of not greater than 10 microns.

In embodiments, the biochar may have a carbon content between about 10 and about 90 wt. %.

In embodiments, the biochar may have an oxygen content between about 3 and about 60 wt. %.

In embodiments, the biochar may have a soluble silicon concentration between about 0 and about 1 wt. %.

In embodiments, the biochar may have an oxygen to carbon ratio between about 0 and about 10.

In embodiments, the biochar may have an ash content between about 2 wt. % and about 80 wt. % based on the weight of the biochar.

In embodiments, the biochar may have a water holding capacity between about 50 wt. % and about 130 wt. % based on the weight of the biochar.

In embodiments, the biochar may have an ambient saturation between about 1 wt. % and about 20 wt. %.

In embodiments, the biochar may have an ambient moisture content between about 1 wt. % and about 20 wt. %.

In embodiments, the feedstock may be selected from the group consisting of softwood, hardwood, herbaceous material, agricultural residues, food, wastes, agricultural feedstocks, forestry residues, municipal solid wastes, wastepaper, pulp and paper mill residues, and combinations thereof.

The term “cement” as used herein refers to an inorganic or organic material or a mixture of inorganic and organic materials that sets, hardens, and adheres to other materials to bind them together. The cement may comprise hydraulic cement, Portland cement, Type 1L cement (Portland cement with a portion of the cement replaced with ground limestone), or a combination thereof.

The term “hydraulic cement” as used herein refers to an inorganic material or a mixture of inorganic materials that sets and develops strength by chemical reaction with water through the formation of hydrates. Examples of hydraulic cements include, but are not limited to, Portland cement, slag cement, and blended cement, or a combination thereof.

The term “Portland cement” as used herein refers to a type of hydraulic cement containing primarily calcium silicates. Portland cement is in the form of a finely ground powder that is manufactured by burning and grinding a mixture of limestone and clay or shale. It may have a high CaO content (e.g., about 63%), and lower amounts of SiO₂ (e.g., about 20%) and Al₂O₃ (e.g., about 6%). Portland cement may conforms to ASTM C150—“Standard Specification for Portland Cement” (e.g., ASTM-C150-2021 Edition, a/k/a ASTM C150/C150M-21).

The term “concrete” as used herein is a composite material comprising cement and an aggregate that hardens over time. Concrete may be used to refer to a wet mixture or a cured mixture.

The terms “cementitious material,” “cementitious mixture,” or “cementitious composition,” are used interchangeably to refer to a composition that comprises cement and an aggregate. A cementitious material may refer to a free-flowing particulate mixture, a liquid mixture, or a cured solid mixture.

The term “concrete composition” as used herein refers to a composition that comprises a cementitious composition. Concrete composition may be used to refer to a wet mixture or a cured mixture.

The term “carbonaceous material” as used herein means carbon from organic sources and includes, but is not limited to, biochar, carbon black, activated carbon, charcoal, coal, solid organic carbon, ash, or a combination thereof.

The term “biochar” as used herein means carbon produced from a biomass.

The terms “biochar replacement level” or “% biochar,” are used interchangeably to refer to the amount of cement replaced by biochar. The biochar replacement level is the mass of biochar divided by the total mass of cement and biochar.

The term “mortar” as used herein refers to a workable paste which hardens and comprises cement and a fine aggregate material, for example sand and/or other fine aggregates. Mortar may be used to refer to a wet mixture or a cured mixture. “Mortar” and “concrete” may be used herein interchangeably.

The term “feedstock” as used herein refers to a variety of plants and plant materials, such as, but not limited to, wood and wood-related materials (e.g., softwood, hardwood), lumber, saw dust, particle board, leaves, trees, herbaceous material, agricultural residues, food, wastes, agricultural feedstocks, forestry residues, municipal solid wastes, wastepaper, pulp and paper mill residues, non-wood materials, a biofuel crop (e.g., a crop grown for use in producing a biofuel, such as bioethanol), a grass (e.g., switchgrass, grass clippings), rice hulls, olive pits, nut shells (e.g., walnut shells), bagasse (e.g., sugar cane bagasse), jute, hemp, flax, bamboo, miscanthus, sorghum residue, sisal, abaca, hay, straw, corn cobs, corn stover, whole plant corn, coconut hair, sewage, sludge, a biosolid, or a combination thereof.

The term “agricultural feedstock” as used herein refers to non-wood feedstocks including, but not limited, to starch and sugar crops (e.g., corn, sorghum), grass crops (e.g., switch grass, miscanthus), oil crops (e.g., soybean, sunflowers), crop residues (e.g., corn stover, corn cobs, nut shells), or a combination thereof.

The terms “pozzolans” or “pozzolanic materials,” are used interchangeably to refer to a class of siliceous or siliceous and aluminous materials that, on their own, possess little or no cementitious value but will, in finely divided form and in the presence of moisture, chemically react with calcium hydroxide (lime) at ordinary temperatures to form compounds having cementitious properties (e.g., calcium silicate hydrate).

The terms “pozzolanic activity” or “pozzolanic behavior” are used interchangeably to refer to the ability of a pozzolan to react with calcium hydroxide. The pozzolanic activity is a measure of either the degree of reaction over time, or the reaction rate between a pozzolan and Ca²⁺ or calcium hydroxide (Ca(OH)₂, or CH in cement chemistry notation) in the presence of water. The pozzolanic activity of a material may be determined using a reactivity test (e.g., R3 reactivity test), and/or the Chapelle Test.

The term “aggregate” as used herein refers to fine or course inert granular materials including, but not limited to, sand, gravel, crushed stone, rock, or a combination thereof.

The term “superplasticizer” as used herein refers to a class of compounds or additives capable of reducing the amount of mixing water of concrete required for a given workability. Superplasticizers increase the flow of concrete and/or reduce the water to cement ratio required to reach a desired flow.

The term “compressive strength” as used herein refers to the maximum compressive stress that, under an applied load, a given solid material may sustain without failure or collapse. The compressive strength of hydraulic cement mortars may be determined according to standards set by one or more international standards setting organizations, such as the American Society for Testing and Materials, International (ASTM). The compressive strength may be determined by ASTM C109-“Standard Test Method for Compressive Strength of Hydraulic Cement Mortars” (e.g., ASTMC109-2020B Edition, a/k/a ASTM C109-20B).

The term “particle size” as used herein refers to the median particle size (D50), unless otherwise specified, which may be determined by sieving according to ASTM D2862—“Standard Test Method for Particle Size Distribution of Granular Activated Carbon” (e.g., ASTM-D2862-2017 Edition, a/k/a ASTM D2862-16) or other methods. The D50 is the maximum particle diameter below which 50% of the sample volume exists. The D90 is the maximum particle diameter below which 90% of the sample volume exists. The D10 is the maximum particle diameter below which 10% of the sample volume exists.

The term “pore volume” as used herein refers to void volume due to the presence of pores, expressed in cubic centimeters per gram (“cm³/g”). The pore volume may be measured using gas adsorption techniques (e.g., CO₂ adsorption, Brunauer-Emmett-Teller (“BET”) surface area analysis).

The term “pore-size distribution” as used herein is the relative abundance of each pore size in a representative volume. It may be represented with a function f (r), which has a value proportional to the combined volume of all pores whose effective radius is within an infinitesimal range centered on r.

The term “pore solution” as used herein refers to liquid that is in a concrete's pores. Typically, a pore solution comprises ions from the cement and has an alkaline pH (greater than pH 7).

The term “flow” as used herein refers to the spread of mortars and may be used to determine the workability and ease of application of the mortar.

The term “ultimate analysis” as used herein refers to the carbon (C), hydrogen (H), nitrogen (N), sulfur(S), and oxygen (O) content in a composition.

The term “pyrolysis” refers to the chemical decomposition of organic materials at elevated temperatures in a predominantly inert atmosphere (little to no oxygen or steam). Pyrolysis produces condensable liquids, non-condensable gases, and carbonaceous material. Pyrolysis processes are divided into different subgroups depending upon the operating conditions. In “slow pyrolysis,” feedstock is slowly heated at a low heating rate (<10° C./min) by using large particle sizes or piles of biomass (>1 cm) to temperatures of between about 300° C. to about 800° C. for a period of time ranging from minutes, hours, to even days. Slow pyrolysis may be performed at ambient pressure. In “flash carbonization,” feedstock is slowly heated at a low heating rate (<10° C./min) by using large particle sizes or piles of biomass (>1 cm) to temperatures of between about 300° C. to about 800° C. for a period of time ranging from minutes, hours, to even days, and at pressures greater than ambient pressure. In “fast pyrolysis,” feedstock is heated at a more rapid heating rate (about 60,000° C./minute) by using small particle sizes (<6 mm) to a temperature between about 400° C. to about 900° C. for a period of time on the order of seconds to tens of seconds.

“Gasification” refers to a process in which feedstock is very rapidly heated (about 60,000° C./minute) to a temperature between about 700° C. to about 1500° C. for a period of time of seconds or minutes.

“Torrefaction” refers to a process in which feedstock is heated at a temperature of about 200° C. to about 300° C. in which water and/or volatile organic compounds are removed.

The terms “water to cement ratio” or “w/c” are used interchangeably to refer to the ratio of the weight of water to the weight of cement used in a cementitious mix. In the present disclosure, for the purposes of determining the w/c, the carbonaceous material is not included as part of the cement. The water in the w/c may be the sum of the water and any water content of the carbonaceous material.

The term “fixed carbon” as used herein refers to the solid carbon remains after biomass has been combusted. The fixed carbon content is determined by subtracting percentages of moisture, volatile matter, and ash from a sample.

The term “volatile matter” as used herein refers to the chemical compounds that are released from a biomass material during combustion.

The term “soluble silicon” as used herein refers to silicon capable of being dissolved in a solution. The solution may include, but is not limited to, deionized water, water, an aqueous solution, or a combination thereof. By contrast, quartz comprises silicon, but the silicon is not soluble and as such would remain solid in solution.

The term “ambient moisture content” as used herein refers to the amount of moisture that is held by the carbonaceous material under ambient conditions. This value may fluctuate with changes in storage conditions and humidity.

The term “ambient saturation” as used herein refers to a ratio between a carbonaceous material's ambient moisture and the total water uptake capacity (i.e., ambient saturation=ambient moisture content/total uptake capacity).

The terms “water uptake capacity,” “total water uptake capacity,” “water holding capacity,” “water sorption capacity,” “water adsorption capacity,” and “sorption capacity,” are used interchangeably to refer to the maximum amount of water that may be adsorbed by a carbonaceous material after exposure to an aqueous environment.

The term “carbon neutral” as used herein refers to the reduction of an entity's carbon footprint to neutral, so that the entity has a net effect of not adding more carbon to the atmosphere than the amount it is removing.

The term “carbon negative” as used herein refers to the reduction of an entity's carbon footprint to less than neutral, so that the entity has a net effect of removing carbon dioxide from the atmosphere rather than adding it.

The term “ASTM C1437” as used herein refers to a test method used to determine the flow of hydraulic cement mortars as well as mortars comprising cementitious materials other than hydraulic cement.

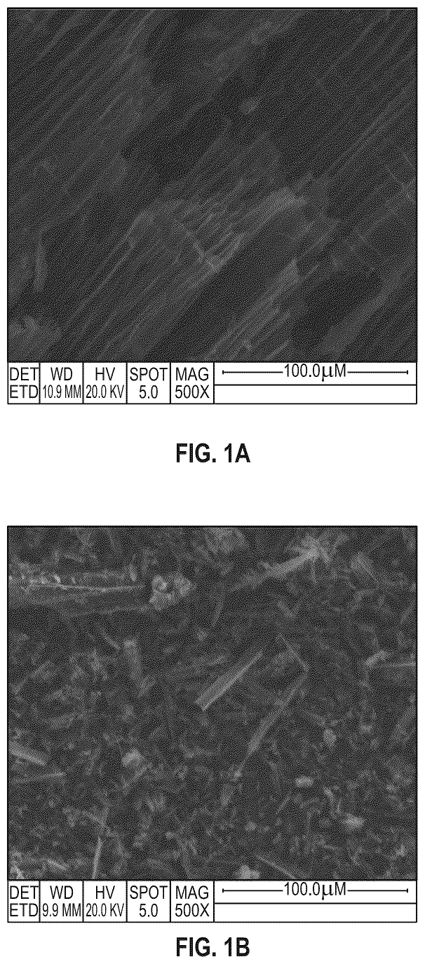

Turning now to the figures, FIGS. 1A and 1B show scanning electron microscopy (SEM) images of a woody biochar prepared by slow pyrolysis before and after milling, respectively. The milling process reduces the pore size of the biochar particles. The biochar is milled to an average particle size of 10 μm to 20 μm to eliminate the fragility caused by its macropores. After exposure to the same milling process, the particle size distributions of each biochar samples are comparable. All biochars tested have an average particle size, D50, below both the cement powder and sand.

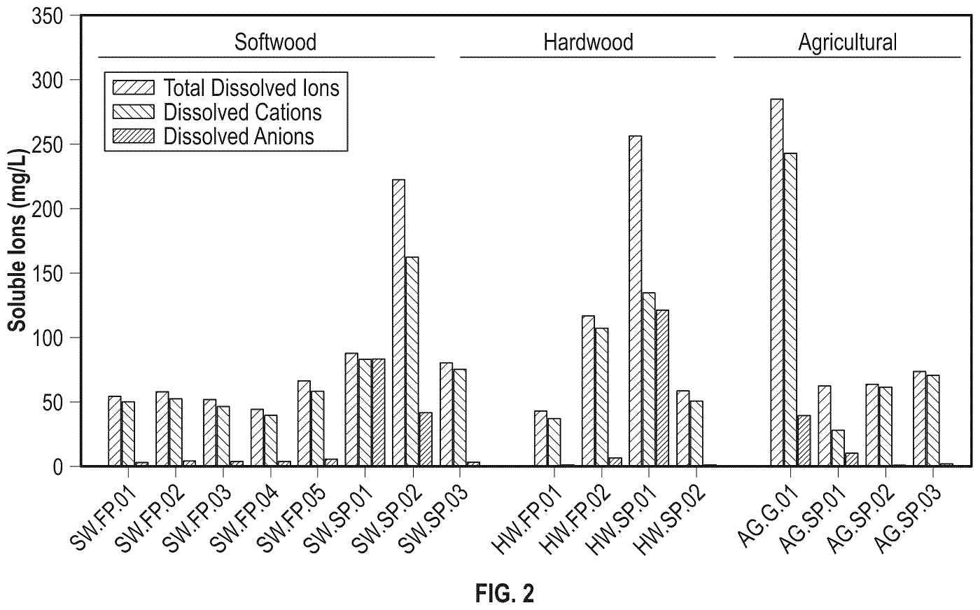

FIG. 2 shows the soluble ion concentrations in DI water for biochar samples prepared from different feedstocks by different pyrolysis techniques. The soluble ion concentration is quantified using inductively coupled plasma-atomic emission spectrometry (“ICP-AES”). The soluble ion concentration is a measure of how strongly the inorganic content, or ash, is bound to the surface of the biochar. The composition of the inorganic content is determined by the feedstock source of the biochar. The fast pyrolysis biochars have a lower quantity of total soluble ions, except for HW.FP.02. For all the biochars except SW.SP.01 and HW.SP.01, most of the dissolved ionic content comprises cations. Without being bound by any particular theory, the addition of biochar with soluble ions may have the potential to alter the chemical process occurring during cement hydration. There is equilibrium between cations and anions.

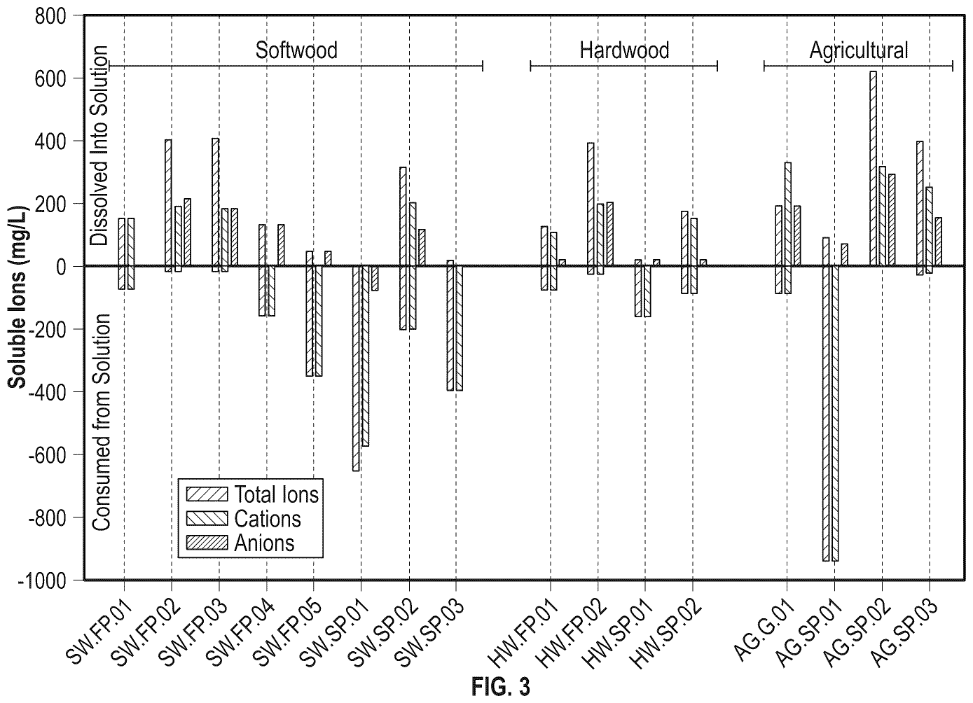

FIG. 3 shows the soluble ion concentrations in simulated cement pore solution for biochar samples prepared from different feedstocks by different pyrolysis techniques. The simulated cement pore solution is comprised of four salts (KOH, Na₂SO₄, K₂SO₄, and Ca(OH)₂) to create an alkaline environment that mimics concrete's highly alkaline environment with a pH of about 13. An alkaline pH changes the solubility limits and overall kinetics of the solution. The soluble ion concentration is quantified using inductively coupled plasma-atomic emission spectrometry (“ICP-AES”). A “blank” of filtered pore solution is used to deduct the starting ion concentration from the biochar samples. Positive concentrations indicate ions released into the pore solution. Negative concentrations indicate ions consumed from the pore solution. The soluble ion concentrations are highly dependent upon the feedstock and pyrolysis technique. Without being bound by any particular theory, the great variability in the ion concentrations dissolved into solution versus consumed from the solution indicates that the composition of the biochar may influence the compressive strength of the concrete composition comprising biochar, as concrete develops its strength through a complex precipitation reaction which ultimate forms hydration products in place of anhydrous cement grains. The progressive dissolution of cement powder and subsequent precipitation of hydration products out of the cement solution drives the precipitation reaction as the concrete composition tries to maintain ionic equilibrium. Negative concentrations indicate ions consumed from simulated cement pore solution by the biochar.

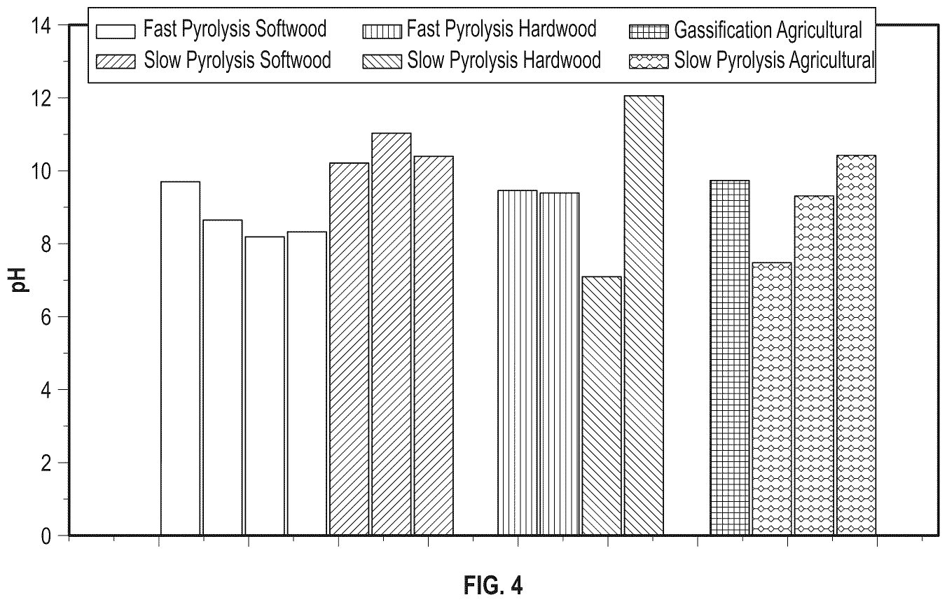

FIG. 4 shows a comparison of pH values for biochar samples prepared from different feedstocks and by different pyrolysis techniques. All the biochar samples have alkaline pHs, but none are as alkaline as cement pore solution, which has a pH of about 13. There is a general trend of biochars pyrolyzed at a higher temperature to have a more alkaline pH than the biochars pyrolyzed at a lower temperature (data not shown).

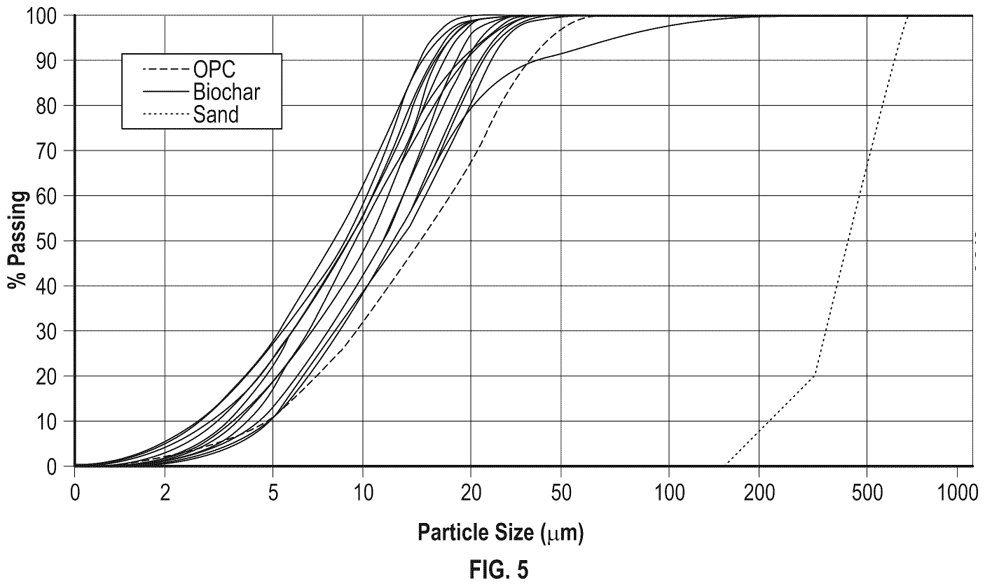

FIG. 5 shows the particle size distribution of biochar samples prepared from different feedstocks and by different pyrolysis techniques after milling. The milled biochar samples are analyzed with a laser particle size analyzer with isopropanol as the solvent. The refractive index of each biochar sample is set at 2.42. After milling, the particle size distributions of each biochar sample are comparable. Each biochar exhibits a minimum particle size (D10) between about 2.5 μm to about 5 μm and a maximum particle size (D95) of between about 15 μm to about 30 μm with one exception in the biochar sample, HW.FP.02, which has a maximum particle size of about 50 μm. All of the tested biochars have an average particle size (D50) less than 15 μm, showing that the milling process is effective at reducing the biochars to below the macroporosity of the original feedstock.

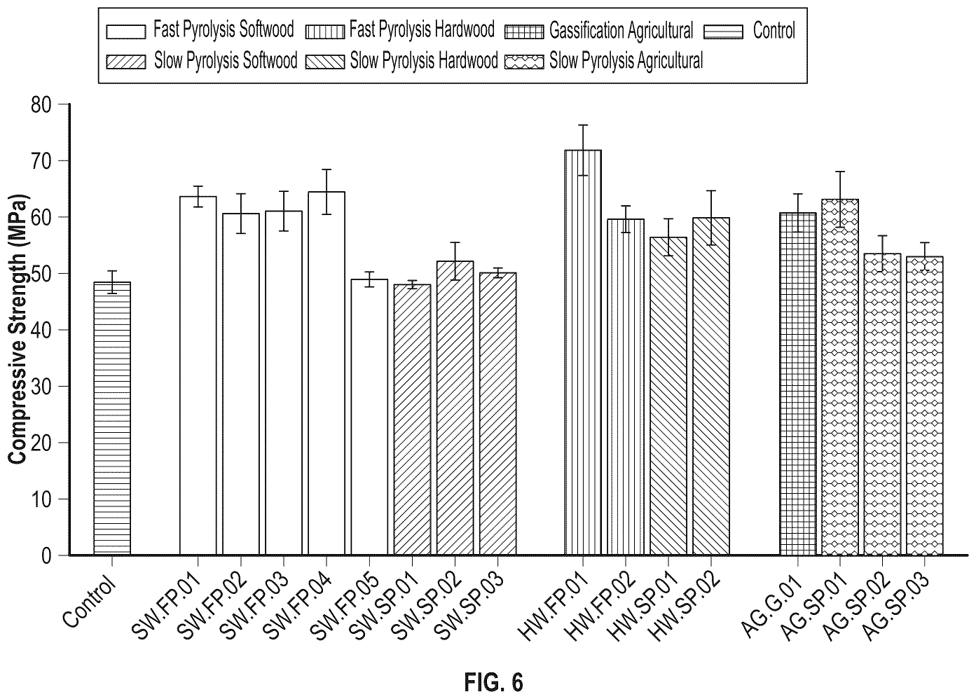

FIG. 6 shows the comparison of the 28-day compressive strengths of different concrete compositions comprising biochars prepared from different feedstocks and by different pyrolysis techniques. A concrete composition without biochar is used as a control and comprises cement, sand, water, and superplasticizer. The concrete compositions comprising biochars have an identical composition as the concrete composition without biochar, except that 10% of the cement mass of the concrete composition without biochar is replaced with an equal mass of a sample biochar. Compressive strength is used as a performance metric to evaluate how variance in biochar properties affects the cement structure. Compared to the control concrete composition, 13 of the 16 biochar samples have comparable or improved compressive strength after 28 days of limewater curing. Unlike many other published works in this field, a 10% replacement of cement powder with milled biochar exhibits comparable or improved compressive strength after 28 days of curing, regardless of feedstock type or pyrolysis conditions for this subset. However, not all biochars behave the same way. Most notably, HW.FP.01 shows a 48% increase in compressive strength when compared to the control concrete composition without biochar. Without being bound by any particular theory, while both feedstock and the pyrolysis process are important predictors of biochar characteristics, it is the physical and chemical characteristics of biochar that may directly affect concrete strength development. These final compressive strengths may be used as response variables to track which biochar characteristics best correlate with increased compressive strength.

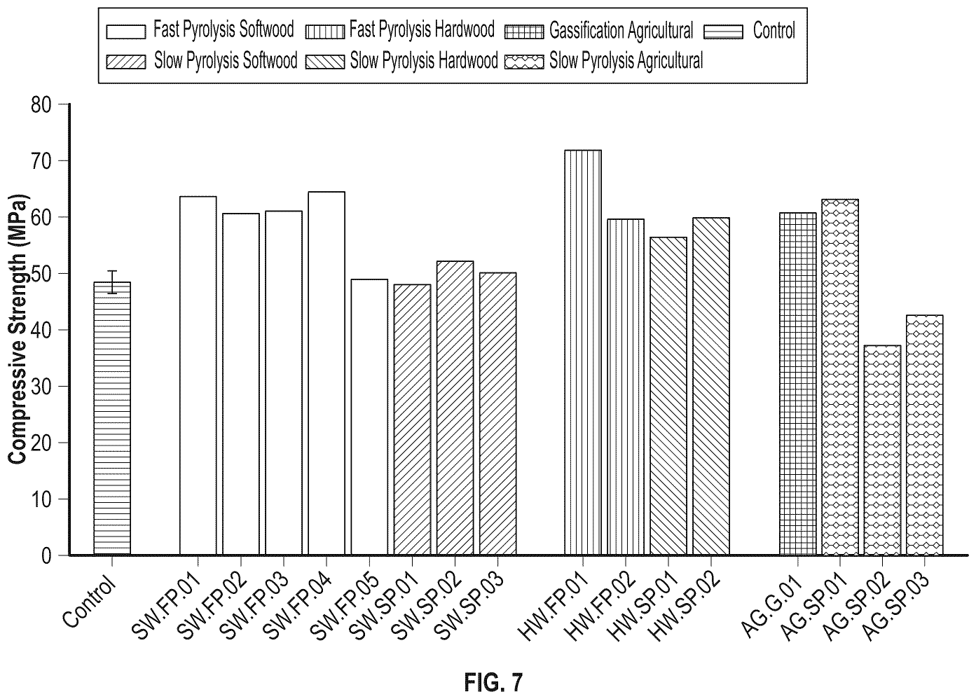

FIG. 7 shows the comparison of the 28-day unconfined compressive strengths of concrete compositions comprising biochars prepared from different feedstocks and by different pyrolysis techniques. A concrete composition without biochar is used as a control and comprises cement, sand, water, and superplasticizer. The concrete compositions comprising biochars have an identical composition as the concrete composition without biochar, except that 10% of the cement mass of the concrete composition without biochar is replaced with an equal mass of a sample biochar. HW.FP.01 shows a 48% increase in compressive strength when compared to the control concrete composition that does not comprise biochar.

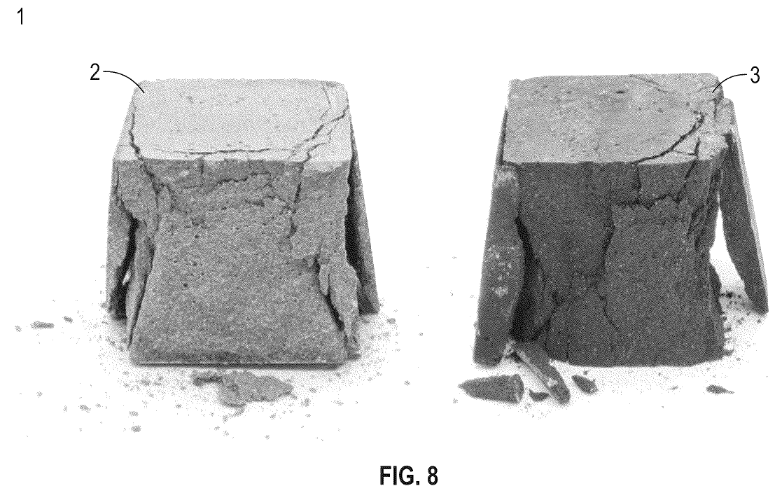

FIG. 8 shows image 1 of the fracture behavior of a control concrete composition without biochar 2 and a concrete composition comprising biochar 3 following unconfined compressive strength tests. The concrete composition without biochar is used as a control and comprises cement, sand, water, and superplasticizer. The concrete composition comprising biochar has an identical composition to the concrete composition without biochar, except that 10% of the cement mass of the concrete composition without biochar is replaced with an equal mass of biochar in the concrete composition comprising biochar.

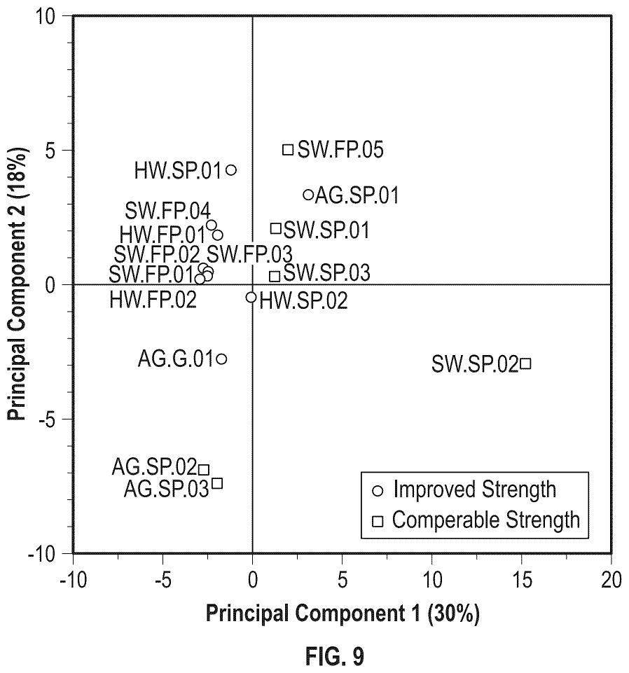

FIG. 9 shows the results of the principal component analysis performed on the compressive strength data of different concrete compositions comprising biochars prepared from different feedstocks and by different pyrolysis techniques. Pearson correlations, random forests, and boosted trees (“GBM”) are employed to study the intercorrelation and importance of individual predictor variables for the compressive strengths of the cement compositions comprising biochars. The final selection of the most important variables is optimized for a multivariate linear model. Principle component analysis (“PCA”) is conducted on the entire set of characteristic variables to condense the dimensionality of this dataset to see what variables and biochar samples are driving variances. The first and second principal components of the biochar samples explain 30% and 18% of the variance in the dataset, respectively. The farther from (0,0) a biochar is plotted on the 2D PCA graph, the more that biochar varies from the rest. Much of the variance within the entire characteristic dataset is driven by AG.SP.02, AG.SP.03, SW.SP.02, and SW.FP.05.

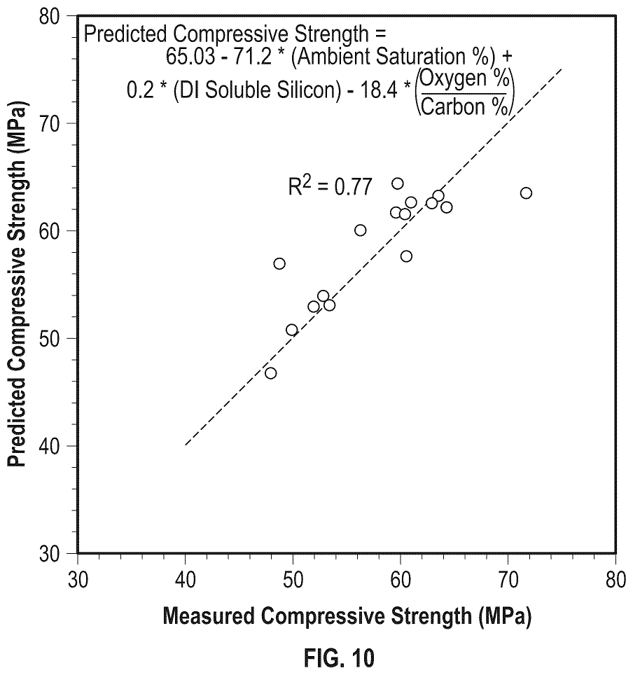

FIG. 10 shows the predicted compressive strengths versus the measured compressive strengths of concrete compositions comprising biochars prepared from different feedstocks and by different pyrolysis techniques. The biochar characteristics are paired down to the most impactful 40 variables via random forest and GBM, then the top 1, 2, 3, and 4 variable models are considered from the 10-fold exhaustive and forward best subsets, and several combinations of best variable subsets are linearly modeled. One variable combination emerges as a good linear model for the compressive strength results: oxygen to carbon atomic ratio (“O/C ratio”), ambient saturation %, and soluble silica wt. %. This linear combination has an average root mean squared error (“RMSE”) of 3.2 MPa, an average variance across the 10 folds of 7.3 MPa, and a multiple R2 value of 0.77 and an adjusted R2 value of 0.71. This model has a strong negative dependence on ambient saturation percentage, showing that the higher the ambient saturation of a biochar, the less compressive strength it will likely contribute in a concrete composition comprising biochar. Additionally, there is a negative correlation between O/C ratio and compressive strength. This model shows a positive dependence on soluble silicon concentration in each biochar, demonstrating that more soluble silicon is beneficial for strength development in concrete compositions comprising biochar. FIG. 10 shows a correlation between the measured compressive strength values for each concrete composition comprising biochar and the predicted compressive strength taking these three key characteristic variables into consideration.

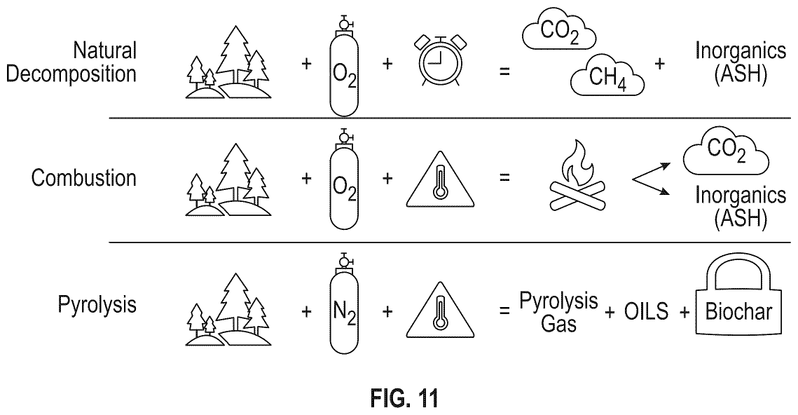

FIG. 11 shows a comparison of different methods of thermochemical conversions of biomass and the resulting byproducts. Pyrolysis locks the carbon in biochar, rather than releasing oxidized carbon into the atmosphere as CO₂. Without being bound by any particular theory, by preventing the carbon-rich biomass from oxidizing, either during high heat combustion or over time during natural decomposition, pyrolysis may produce a decomposition-resistant form of carbon, sequestering carbon that would otherwise be emitted into the environment, either as CO₂ or CH₄. Additionally, by integrating biochar into concrete as a carbon sink, the embodied carbon emission from the concrete production may be partially sequestered into the final building material.

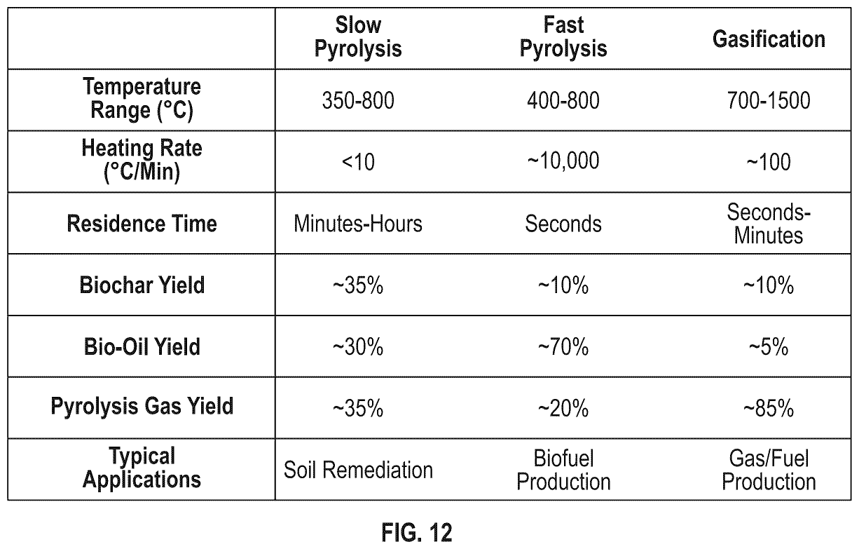

FIG. 12 shows a comparison of pyrolysis techniques used to prepare biochars. Pyrolysis conditions are the most general way to classify biochars as the production techniques dictate several of the biochar's final characteristics. For instance, in slow pyrolysis there is a two-step decomposition process where the pyrolysis gas is released and then the carbon body softens, collapses, and condenses while the carbon structure polymerizes. With fast pyrolysis, when the biomass decomposes, the softening and condensing happens simultaneously; the pyrolysis gas escapes quickly through the softened carbon matrix of the biomass, significantly increasing the surface area of the final biochar. Without being limited by any particular theory, while these comparisons are reliable for the processing of a particular feedstock group, the feedstock itself also may have a considerable impact on the final chemical and physical properties of the biochar.

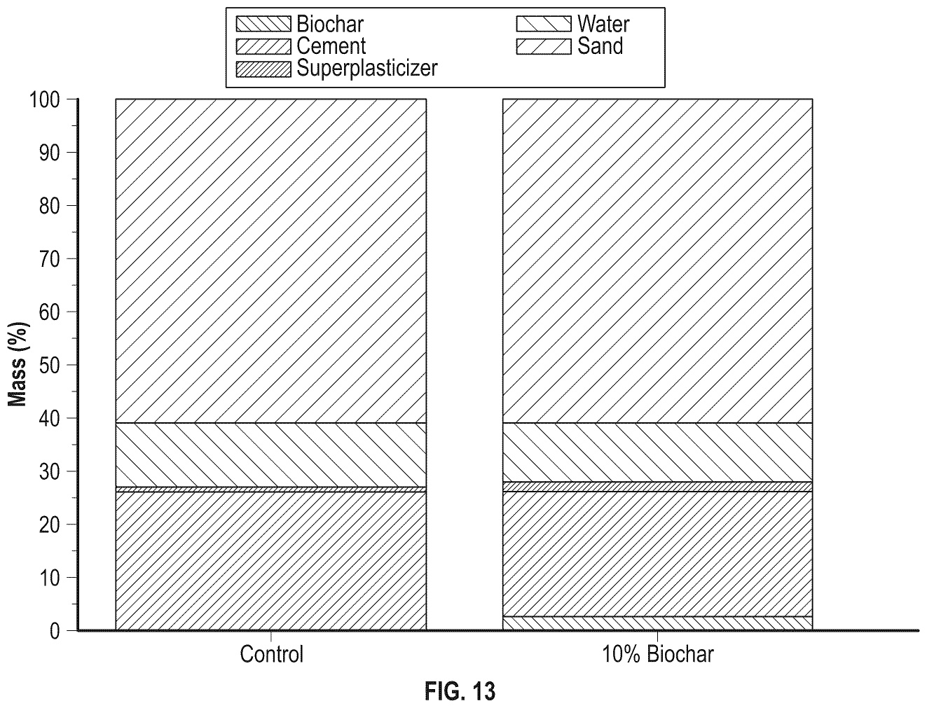

FIG. 13 shows the mass percent contribution of each component of the control concrete composition without biochar and a concrete composition comprising biochar. In the concrete composition comprising biochar, 10% of the cement of the control concrete composition was replaced with biochar.

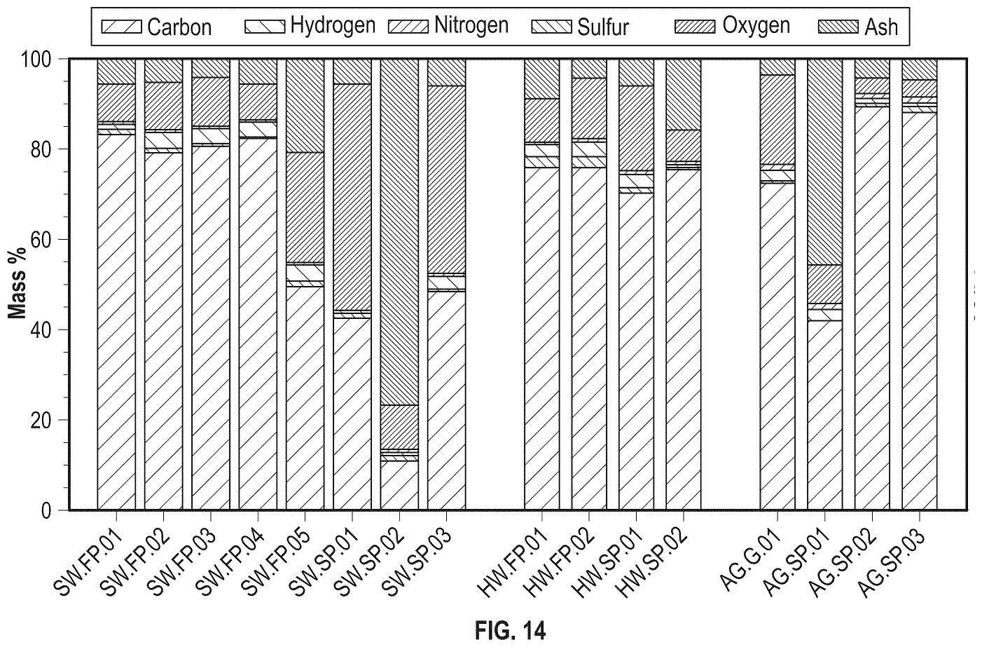

FIG. 14 shows the ultimate analysis of each biochar segmented by feedstock. Fast pyrolysis biochar exhibits a higher carbon content, making its carbon sequestration potential higher than that of slow pyrolysis biochar. One common way to interpret ultimate analysis is to calculate atomic ratios of the elemental components within a sample in relation to the carbon content. Without being limited to any particular theory, the H/C ratio is used to model the stability of the biochar or the degree of aromaticity; the O/C ratio demonstrates the degree of carbonization and the abundance of oxygen-containing functional groups; and the N/C ratio is used to model the abundance of nitrogen-containing functional groups. There is a fundamental correlation between inorganic ash content and carbon content for all biochars; the percentage of organic content increases as the inorganic content decreases. Similarly, as carbon content increases, so does surface area, since the inorganic ash is less porous than the carbon structures. C % and O % have a statistically significant relationship with compressive strength (p=0.08 and R²=0.46 for C % and p=0.02 and R²=−0.56 for O %); though a relatively weak single variable correlation, the statistical significance indicates that these may be important variables to consider.

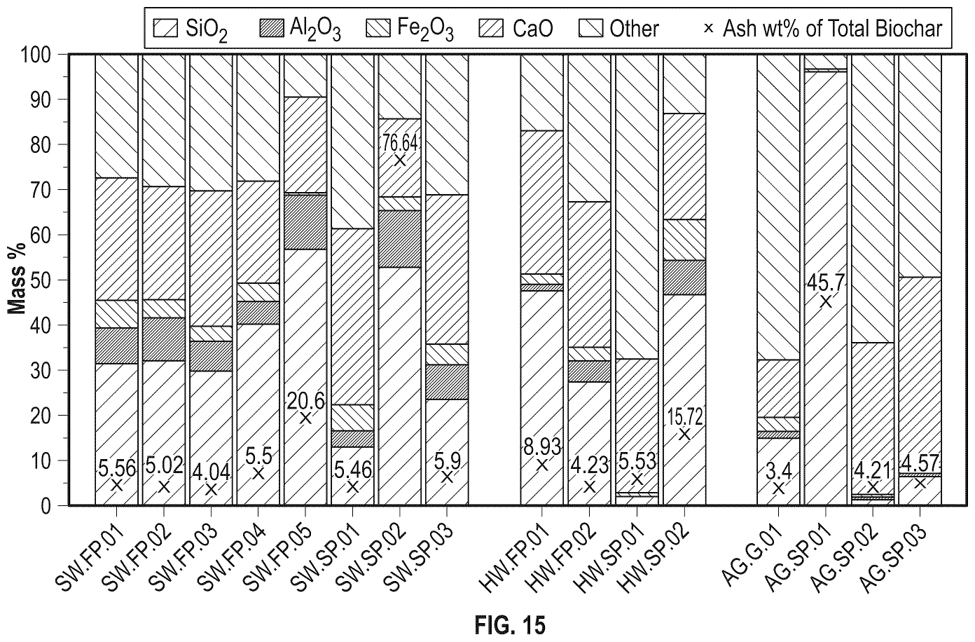

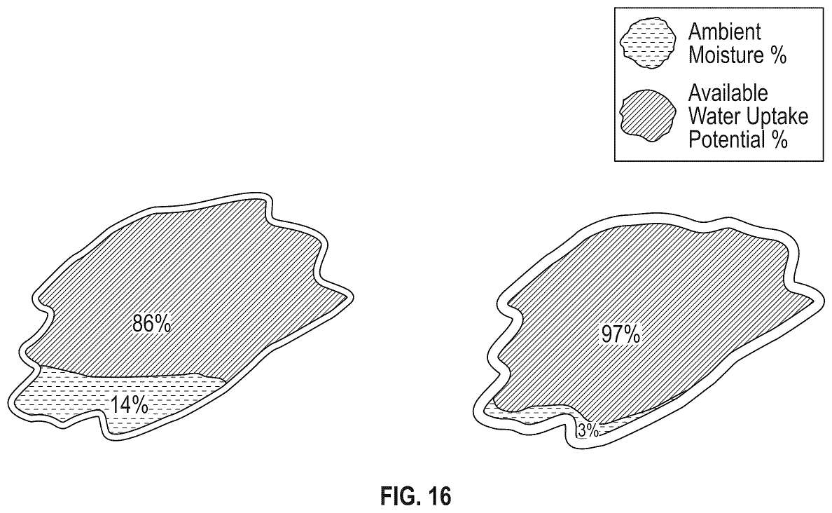

FIG. 15 shows XRF analysis results of select oxides in biochars prepared from different feedstocks and by different pyrolysis techniques as wt. % of total ash content. The red X shows the total wt. % of ash content for each biochar. The CaO, SiO₂, Al₂O₃, and Fe₂O₃ content in the ash for each biochar is measured, since these may contribute pozzolanic properties in concrete systems. There is no statistically significant single-variable correlations between any of the measured oxides and compressive strength, which may be because most of the biochars have less than 10 wt. % inorganic ash content.

FIG. 16 shows a model of biochar particles with different amounts of adsorbed ambient moisture and available water uptake potential. The ambient saturation % of each biochar (the ratio of ambient moisture content and total water uptake capacity) has a negative influence on compressive strength. Without being limited by any particular theory, this may mean that the biochars that are more saturated (normalized by their total capacity) before integration into a mortar mix may ultimately develop less compressive strength than biochars that are less saturated and have more available liquid uptake capacity.

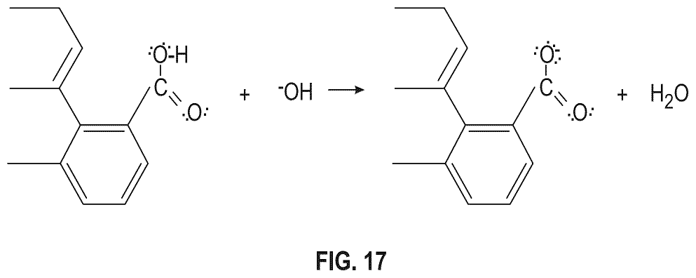

FIG. 17 shows an example of an acidic oxygen functional group on the surface of biochar deprotonating in an alkaline environment to form water. Without being bound by any particular theory, oxygen functional groups may be present on the surface of biochar particles due to incomplete pyrolysis, leaving behind oxygen, or because of surface oxidation from long-term exposure to the atmosphere. Of all the possible oxygen functional groups located on the surface of biochar (phenols, ethers, epoxy, carbonyls, carboxyls, carboxylic anhydrides, and quinones, all but two types (quinones and carbonyls) are considered acidic or weakly acidic functional groups. In the highly alkaline environment of cement solutions, these acidic functional groups may be deprotonated, forming water molecules and leaving the remaining functional group charged and more reactive.

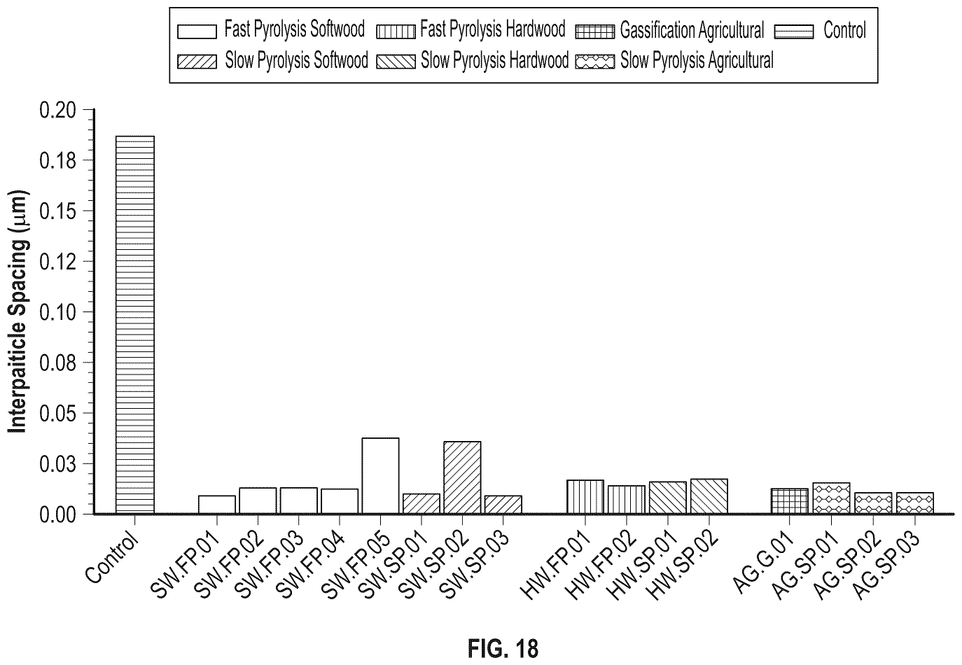

FIG. 18 shows the interparticle spacing of concrete compositions comprising biochars prepared from different feedstocks and by different pyrolysis techniques. All concrete compositions comprising biochars tested have a lower interparticle distance than that of the control concrete composition without biochar.

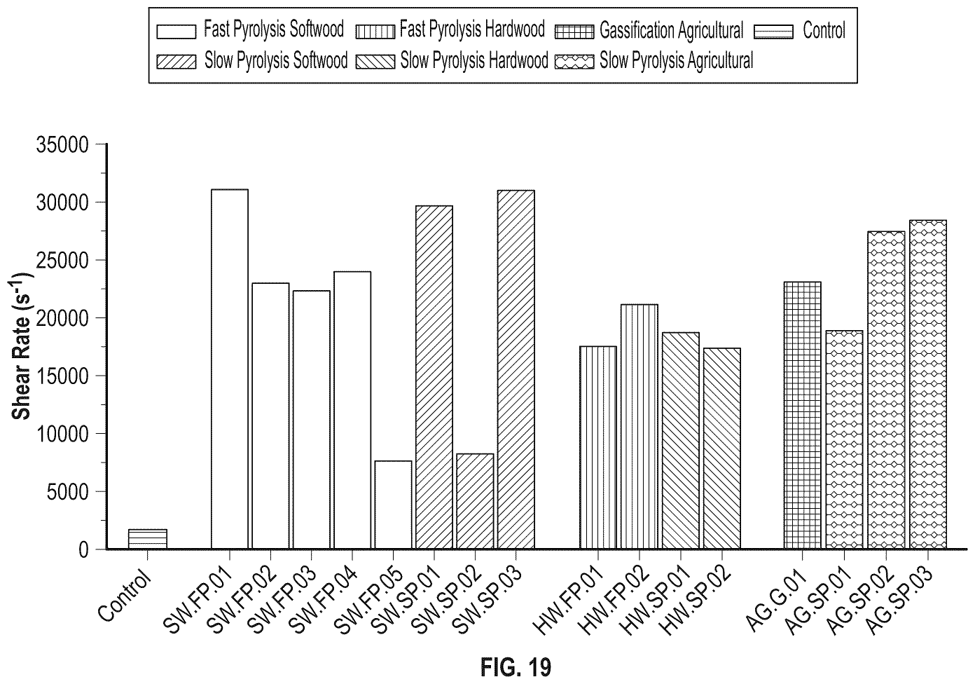

FIG. 19 shows the shear rates of concrete compositions comprising biochars prepared from different feedstocks and by different pyrolysis techniques. Calculations are used to investigate the impact of biochar particles on the shear rate the cement grains experience, taking into account the measurements of cement, biochar, and sand surface areas, particle size distributions, and mix design proportions. All concrete compositions comprising biochars tested have a greater shear rate than that of the control concrete composition without biochar. Without being bound by any particular theory, this is likely due to a lower interparticle spacing in the concrete compositions comprising biochars observed compared to the interparticle spacing of the control concrete composition, as seen in FIG. 18.

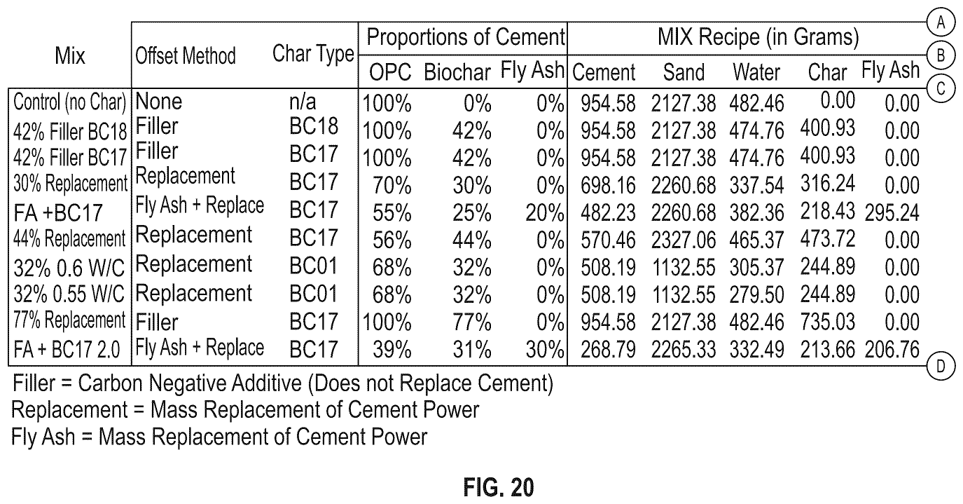

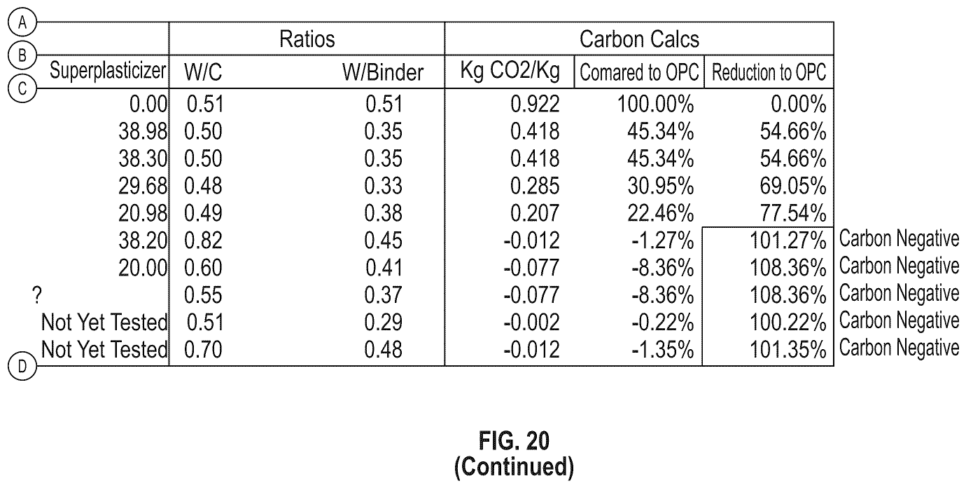

FIG. 20 shows a comparison of calculated carbon emission values of concrete compositions comprising biochars prepared from different feedstocks versus a control concrete composition without biochar. The concrete compositions comprising biochar show a reduction in the carbon emissions relative to the control concrete composition without biochar. Replacing a portion of the cement in the concrete composition with biochar results in a greater reduction of calculated carbon emissions compared to compositions where the biochar is used as an additional filler, rather than a replacement for cement, in a concrete composition. Additionally using fly ash (“FA”) as a partial replacement for cement in a concrete composition comprising biochar also results in a decrease in calculated carbon emissions when compared to the control concrete composition without biochar.

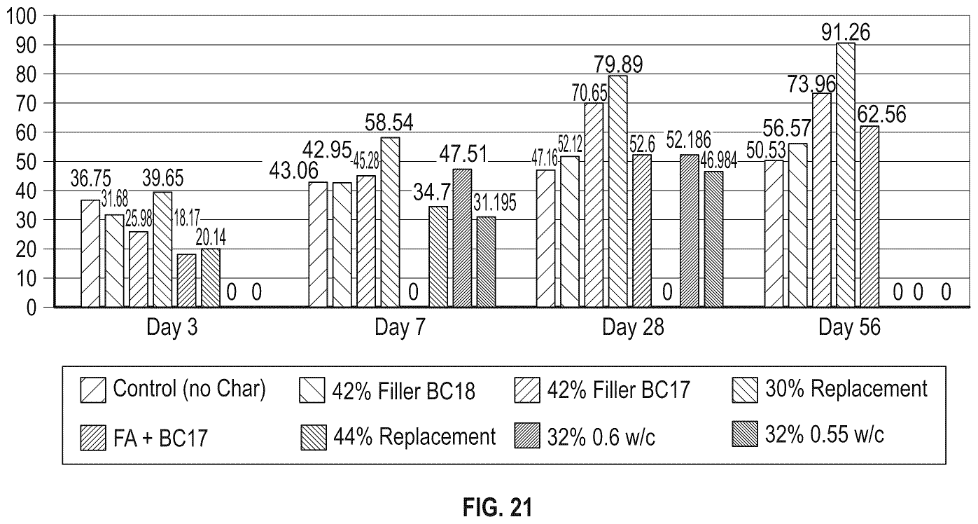

FIG. 21 shows the compressive strengths (MPa) of concrete compositions comprising biochars prepared from different feedstocks and by different pyrolysis techniques with different percentages of biochar replacement of cement. Using 42% filler biochar in a concrete composition comprising biochar (BC17, derived from rice hull feedstock) increases the 56-day compressive strength to about 46% over the control concrete composition without biochar. Using 42% filler biochar in a concrete composition comprising biochar (BC18, derived from pine feedstock) increases the 56-day compressive strength to about 12% over a control concrete composition without biochar. However, concrete compositions with biochar show delayed compressive strength gains, as the control concrete composition without biochar has a 3-day compressive strength about 41% and 16% greater than concrete compositions comprising biochars BC17 and BC18, respectively. A concrete composition comprising biochar BC17 and fly ash, has only about 49% of the compressive strength of the control concrete composition without biochar after 3 days, but shows an increase in the 56-day compressive strength of about 24% over the control concrete composition without biochar.

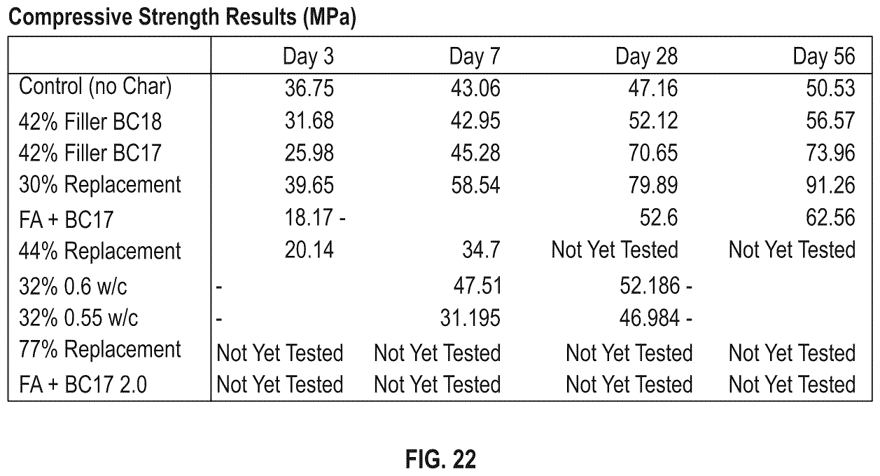

FIG. 22 shows the compressive strengths (MPa) of concrete compositions comprising biochars prepared from different feedstocks and by different pyrolysis techniques with different percentages of biochar replacement. Although the addition of biochar and fly ash to the control concrete composition delays compressive strength gains, the addition of biochar and fly ash ultimately result in greater compressive strength of concrete compositions comprising biochar when compared to the control concrete composition without biochar.

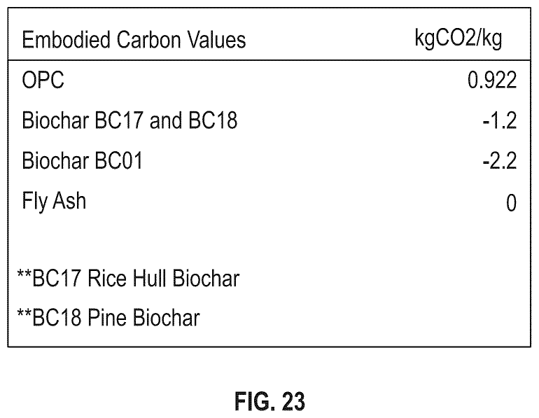

FIG. 23 shows the carbon emission values of OPC and sample biochars. OPC has a positive carbon emission of 0.922 kg CO₂/kg OPC. In contrast, biochars BC17 and BC18 both have a negative carbon emission of −1.2 kg CO₂/kg biochar. Biochar BC01 has a negative carbon emission of −2.2 kg CO₂/kg biochar. Fly ash is carbon neutral.

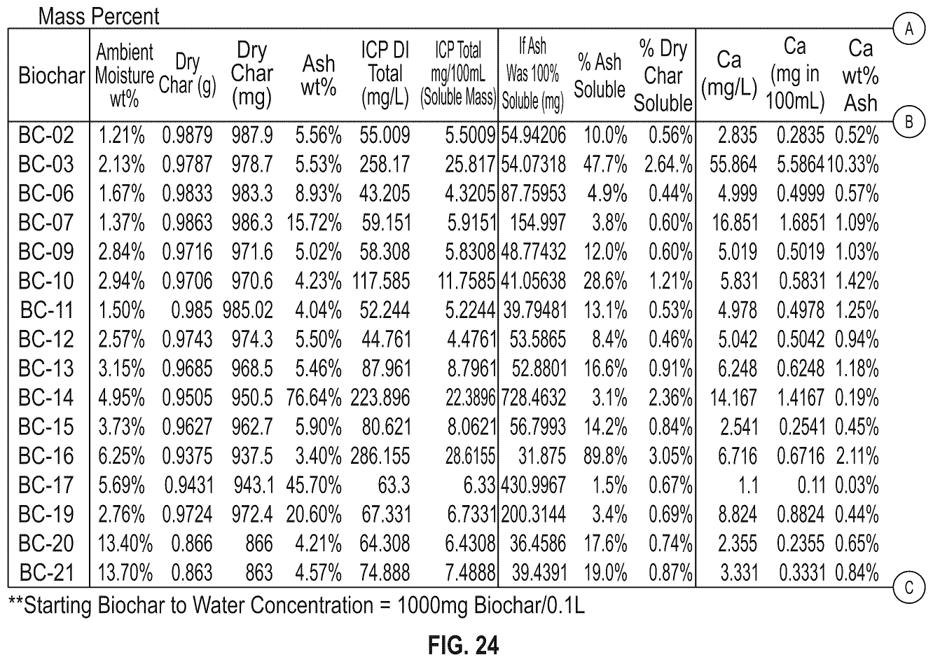

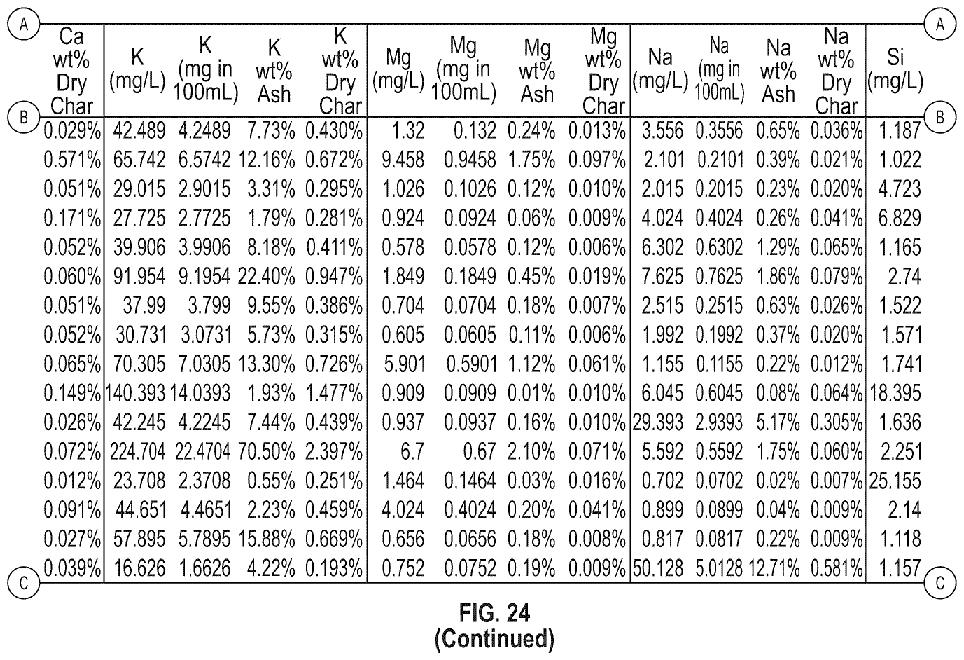

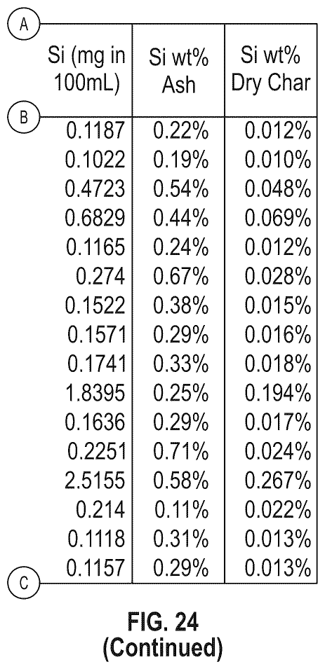

FIG. 24 shows the elemental mass percentage results of biochars prepared from different feedstocks and different pyrolysis techniques. The elemental content of the different biochars was assessed using ICP-AES, with a starting biochar to water concentration of One gram biochar to 100 mL of DI water. The results show variation in the elemental compositions of biochars which may be due to biochar preparation from different feedstocks and using different pyrolysis techniques.

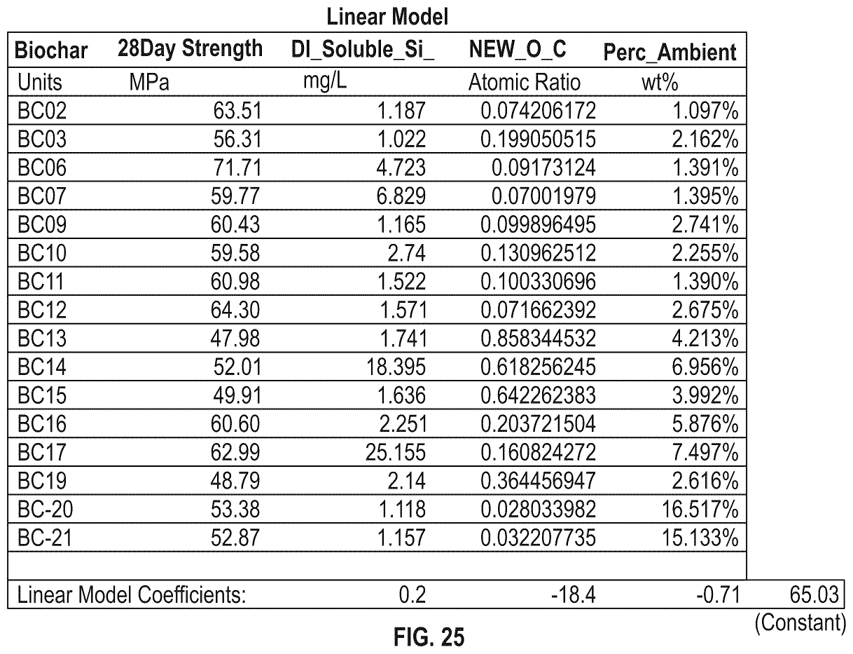

FIG. 25 shows the linear model coefficients of three identified characteristic variables influencing the relative compressive strength in concrete compositions comprising biochar. This model has a strong negative dependence on ambient saturation percentage, showing that the higher the ambient saturation of a biochar, the less compressive strength the biochar may contribute in mortars. Additionally, there is a negative correlation between O/C and compressive strength. This model shows a positive dependence on soluble silicon concentration in each biochar, demonstrating that more soluble silicon may be beneficial for strength development in mortars.

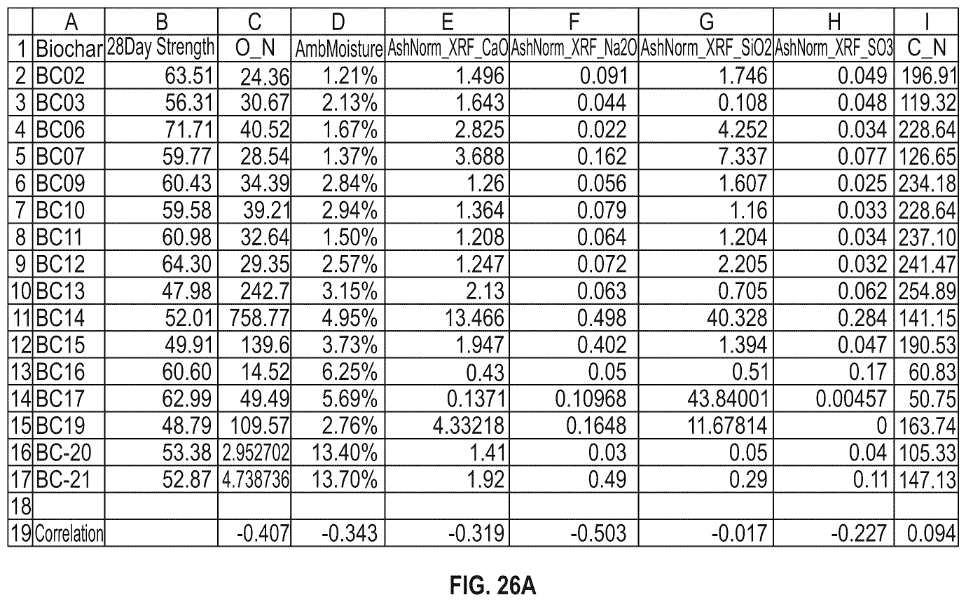

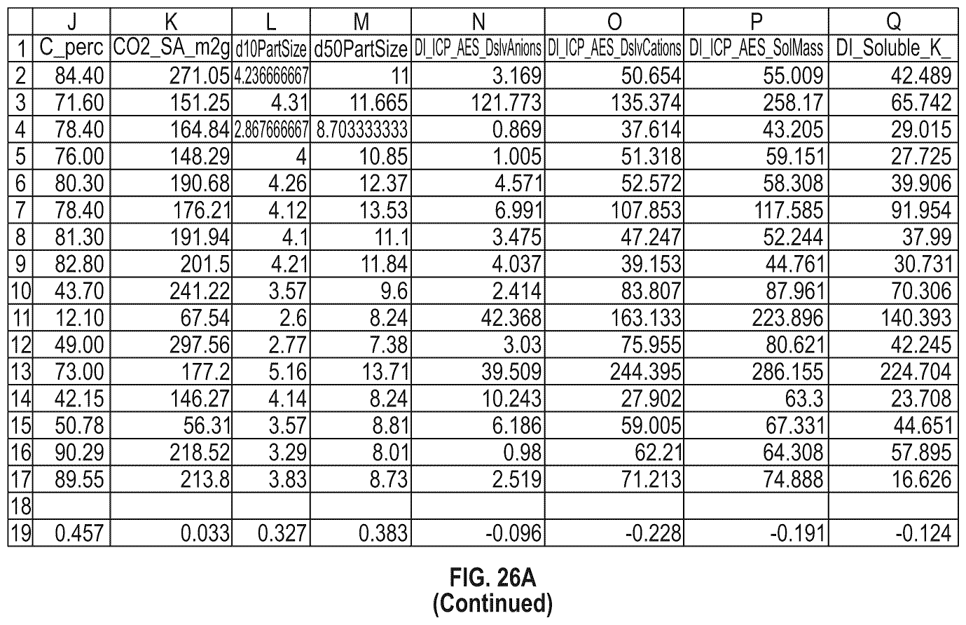

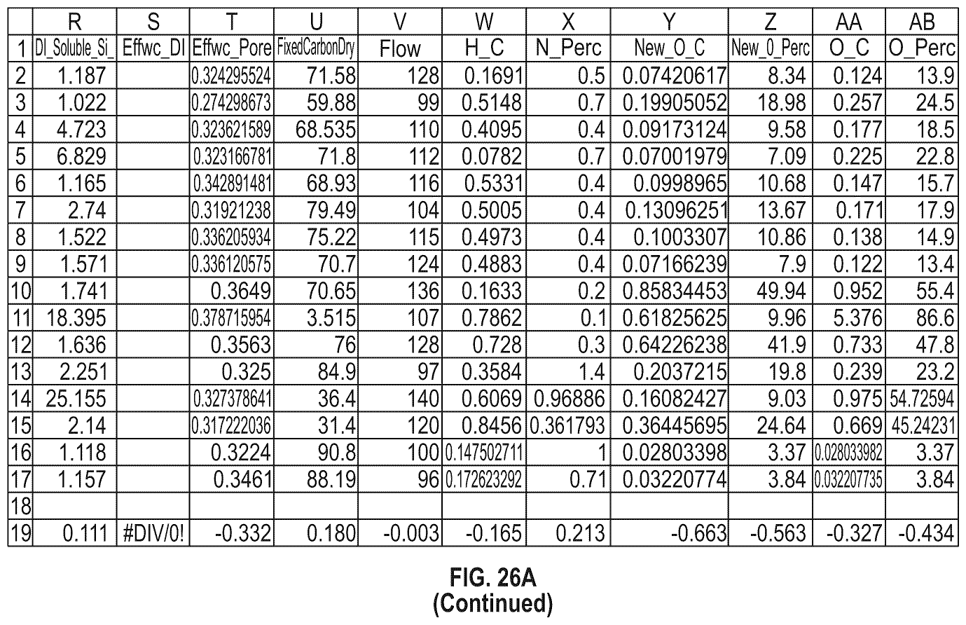

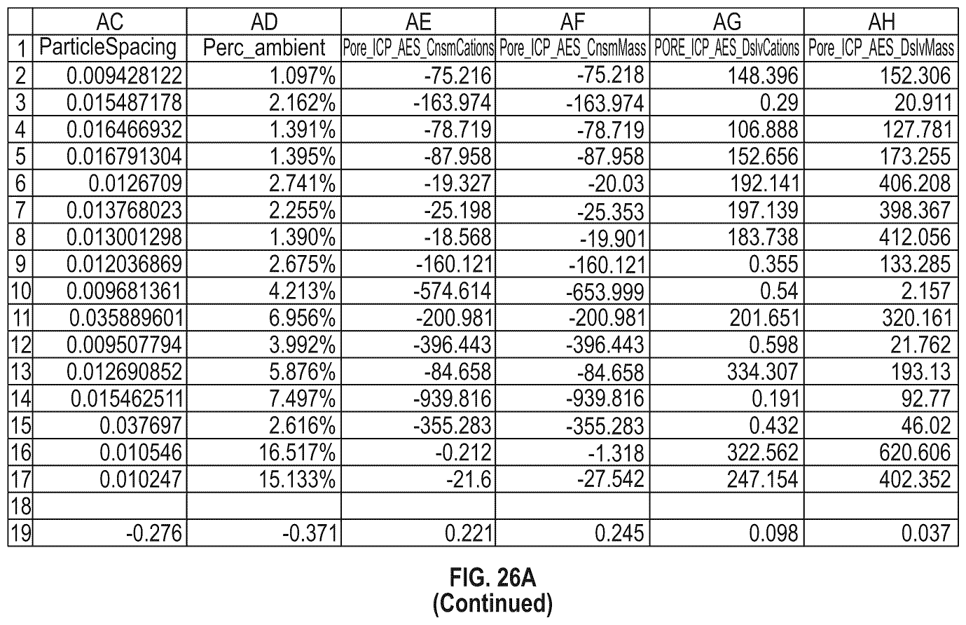

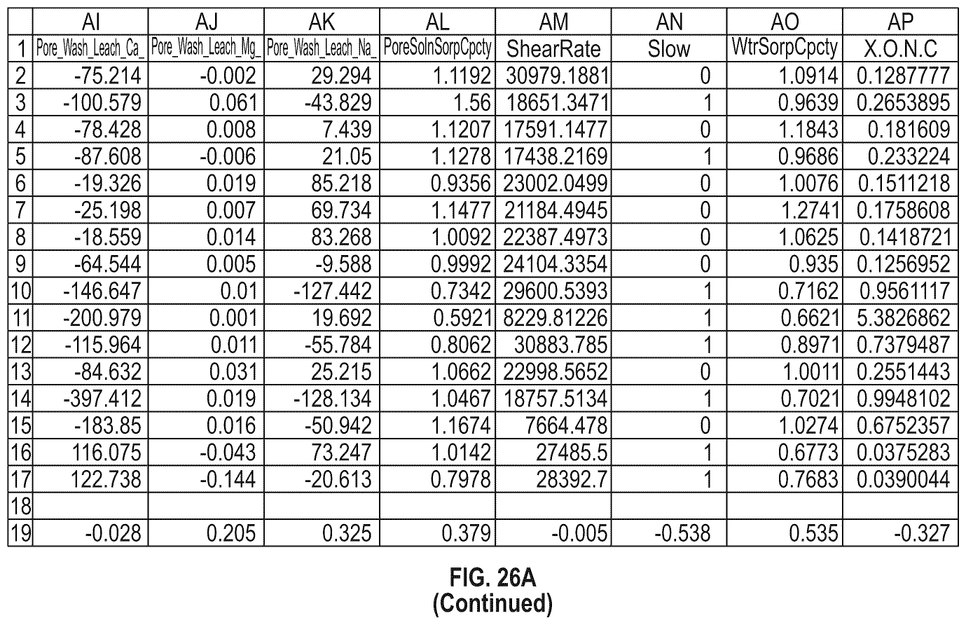

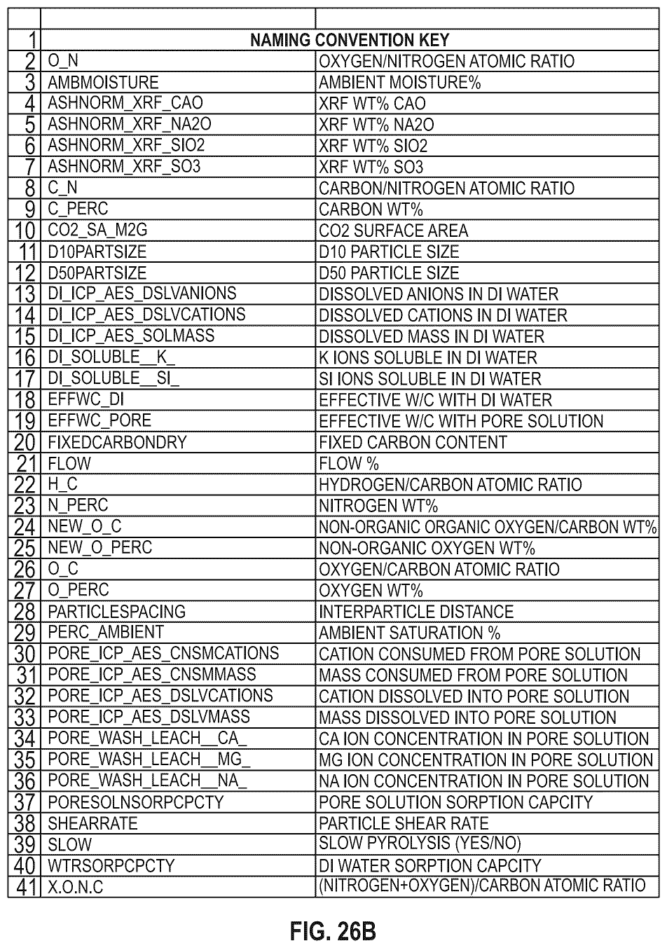

FIGS. 26A and 26B show a summary of results for relevant predictor characteristics for compressive strengths of compositions comprising biochars prepared from different feedstocks and by different pyrolysis techniques and the naming convention key, respectively. Pearson correlations, random forests, and boosted trees (“GBM”) were employed to study the intercorrelation and importance of individual predictor variables. The ultimate goal of these processing techniques is to optimize the final selection of the most important variables for a multivariate linear model. After pairing down the biochar characteristics to the most impactful 40 variables via random forest and GBM, then considering the top one, two, three, and four variable models from the 10-fold exhaustive and forward best subsets, several combinations of best variable subsets are linearly modeled. One variable combination emerges as a good linear model for the compressive strength results: oxygen to carbon atomic ratio (“O/C”), ambient saturation percentage, and soluble silica wt. %.

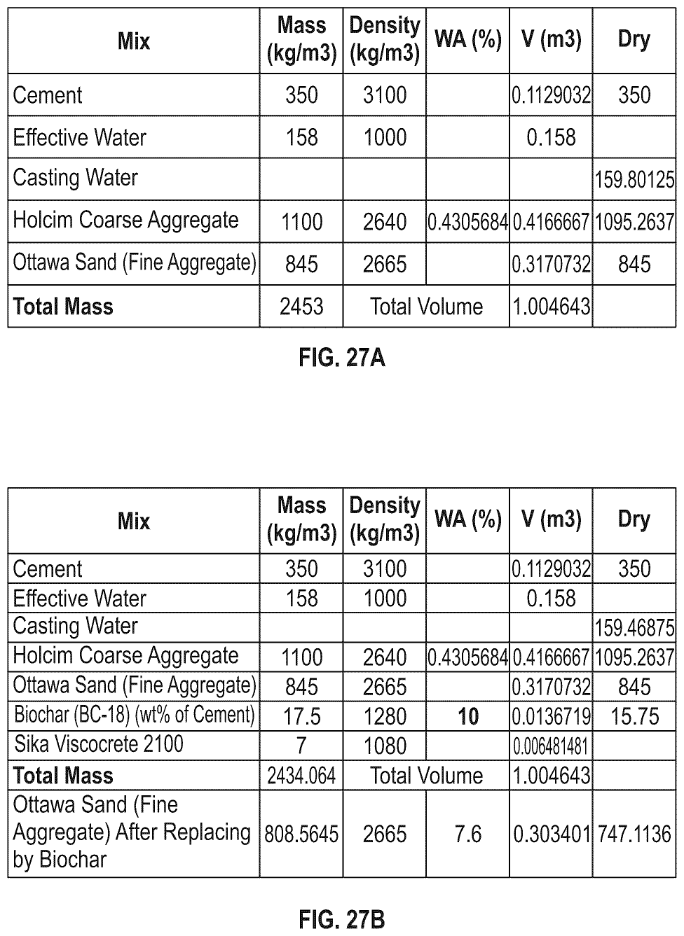

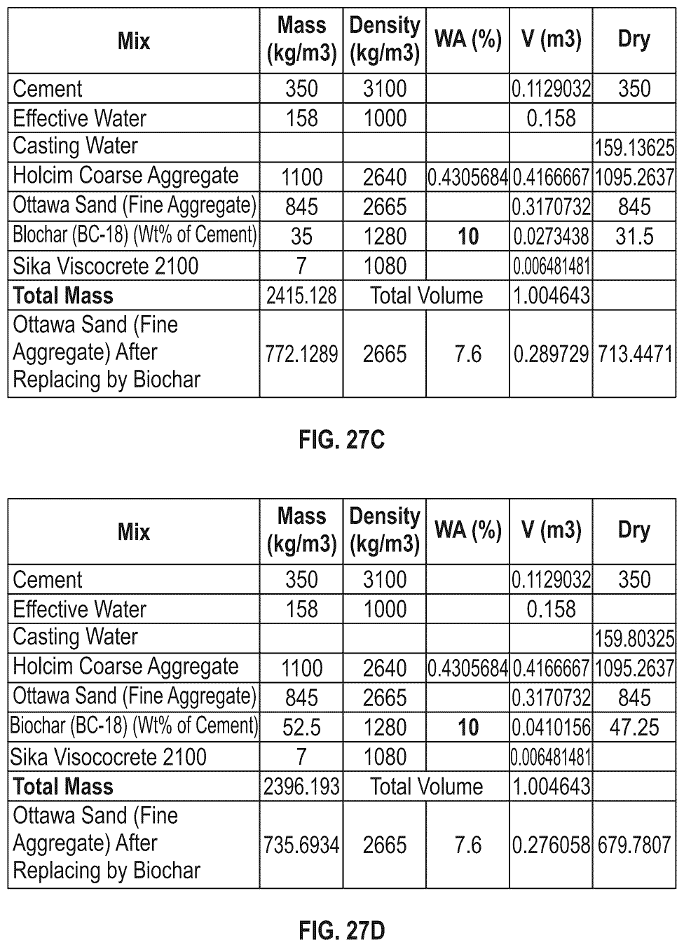

FIGS. 27A, 27B, 27C, and 27D show the relative amounts of cement, water, aggregate, sand, superplasticizer, and biochar used in a control concrete composition without biochar, a concrete composition comprising 5 wt. % biochar, a concrete composition comprising 10 wt. % biochar, and a concrete composition comprising 15 wt. % biochar, respectively. The concrete compositions show sand replaced in the composition. The addition of increasing amounts of biochar to the concrete compositions comprising biochar necessitates the addition of increasing amounts of superplasticizer (over the amount added to the control) to the concrete compositions comprising biochar. The increased concentrations of superplasticizer in the concrete compositions comprising biochar increase the flow to be comparable to the flow of the control concrete composition without biochar.

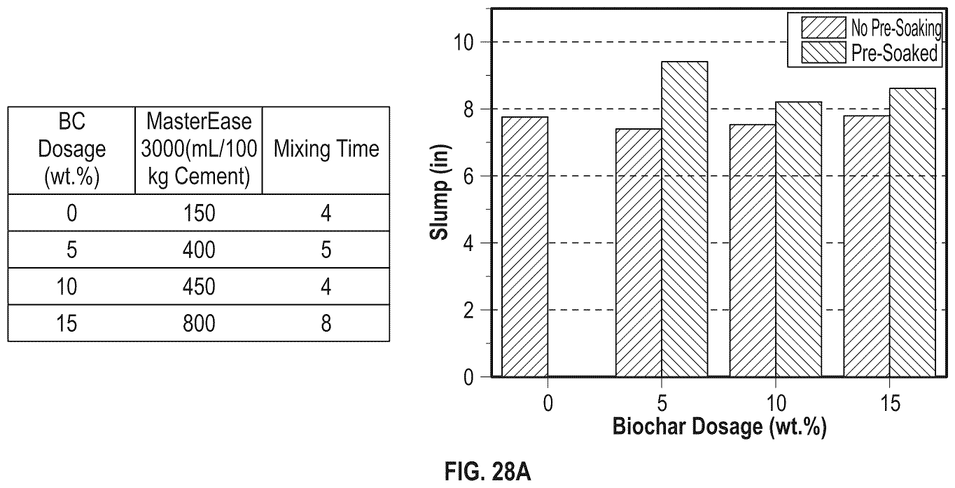

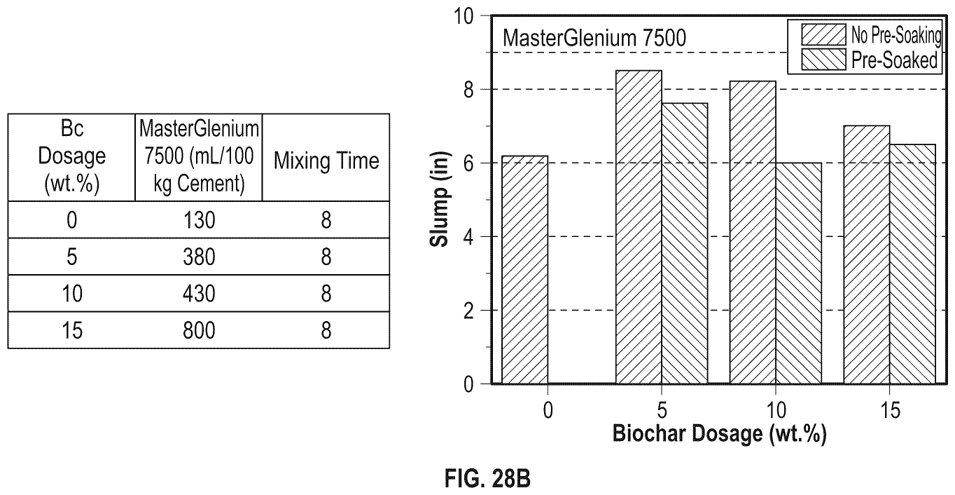

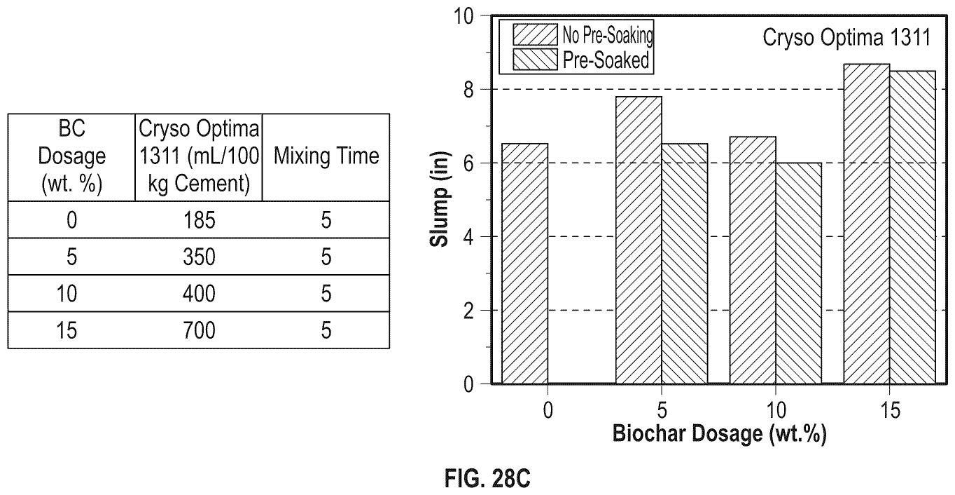

FIGS. 28A, 28B, and 28C show the concrete slump values for a control concrete composition without biochar and concrete compositions comprising increasing concentrations of biochar and further comprising different superplasticizers. The concrete compositions show sand replaced in the composition. The concrete compositions comprising biochar require more superplasticizer than the control concrete composition without biochar to maintain a comparable slump value. Concrete slump is a measure of the fluidity and workability of concrete before it sets. All of the concrete compositions comprising biochar show a similar or greater degree of concrete slump than the control concrete composition without biochar. This demonstrates that even with increasing concentrations of biochar, the concrete compositions comprising biochar may maintain a flow and workability comparable to that of a control concrete composition without biochar through the addition of an increased amount of superplasticizer over the amount added to the control composition.

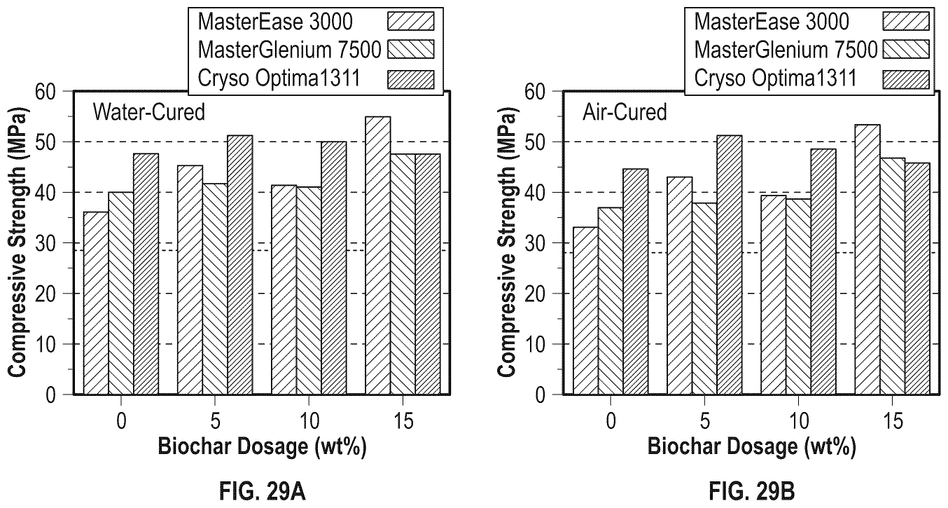

FIGS. 29A and 29B show the relative compressive strengths for a control concrete composition without biochar and concrete compositions comprising increasing concentrations of biochar and further comprising different superplasticizers for water-cured and air cured concrete compositions, respectively. The concrete compositions show sand replaced in the composition. The concrete compositions comprising increasing concentrations of biochar show similar or increased compressive strengths compared to the control concrete composition without biochar. The compressive strengths of concrete compositions comprising biochar and further comprising different superplasticizers are approximately the same for both water-cured and air-cured concrete compositions.

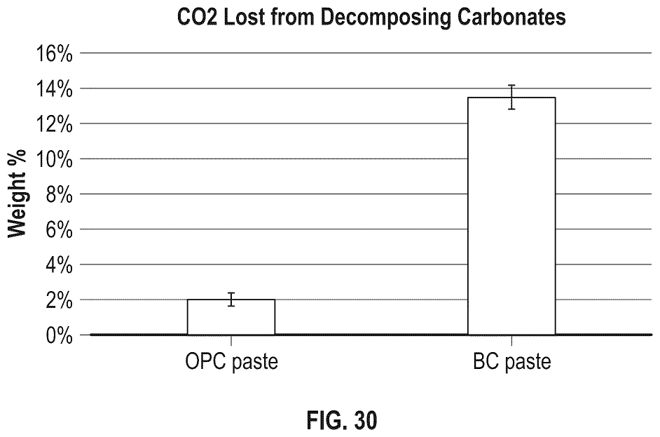

FIG. 30 shows the CO₂ lost from decomposing carbonates in a control cement paste without biochar and a cement paste comprising biochar. Cement paste comprising biochar and a control cement paste without biochar are mixed and analyzed via hyphenated thermogravimetric analysis with Fourier transform infrared spectroscopy (“TGA-FTIR”) to thermally decompose the hydrated pastes and analyze the evolved CO₂ gas via FTIR. The contribution of the biochar hydrates and carbonates is subtracted from the final chemically bound H₂O and CO₂ quantities. The control cement paste without biochar does not produce as much CO₂ as a cement paste comprising biochar.

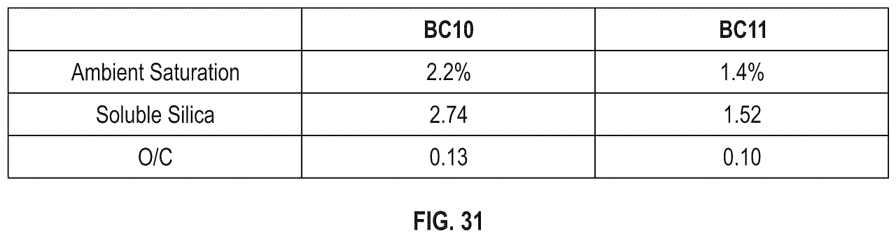

FIG. 31 shows a comparison of the ambient saturation percentage, soluble silica content, and O/C ratio for two different biochars, BC10 and BC11. BC11 and BC10 were procured from the same manufacturer with identical pyrolysis parameters. BC10 (also referred to as HW.SP.02) is classified as hardwood because the feedstock blend is forest residue that contains a higher fraction of hardwood than softwood. BC11 (also referred to as SW.FP.03) is a comparable feedstock blend but contains a higher fraction of softwood than hardwood. Without being limited by any particular theory, the similarities in the ambient saturation percentage, soluble silica content, and O/C ratio for the two different biochars suggest that they may be able to be used interchangeably in a concrete composition comprising biochar and expected to impart similar physical and chemical properties in the composition.

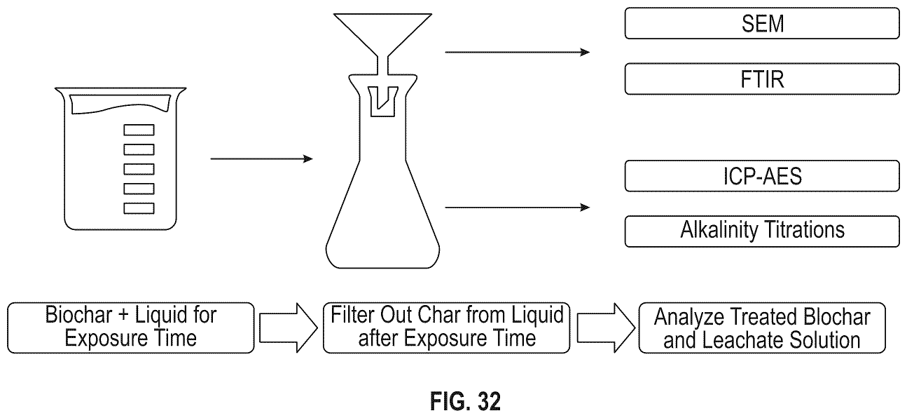

FIG. 32 shows a summary of the experimental setup used to analyze the chemical interactions of biochars contacted with a simulated cement pore solution. The simulated cement pore solution is used in cementitious studies to model the key ionic concentrations and pH present in cement slurries and is used here to study the chemical interactions of biochars separate from cement.

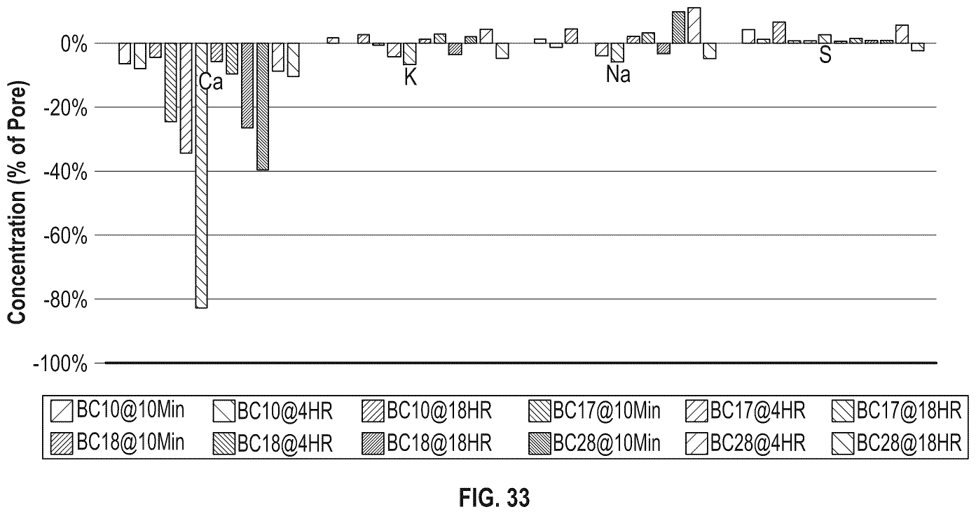

FIG. 33 shows the results of an ICP analysis of biochars contacted with a simulated cement pore solution. Each biochar contacted with a simulated cement pore solution shows consumption of calcium ions from the simulated cement pore solution; the calcium ion concentration of the simulated cement pore solution is higher prior to the biochars being contacted with the simulated cement pore solution.

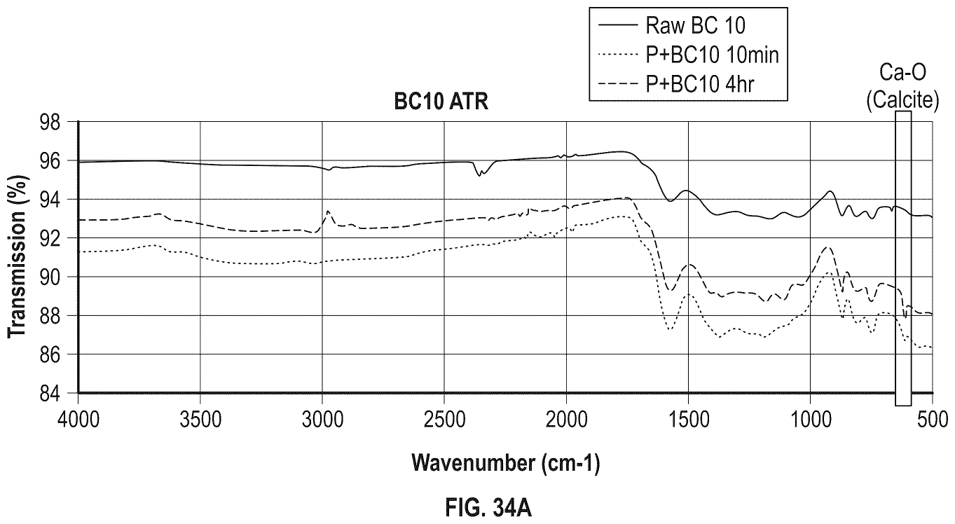

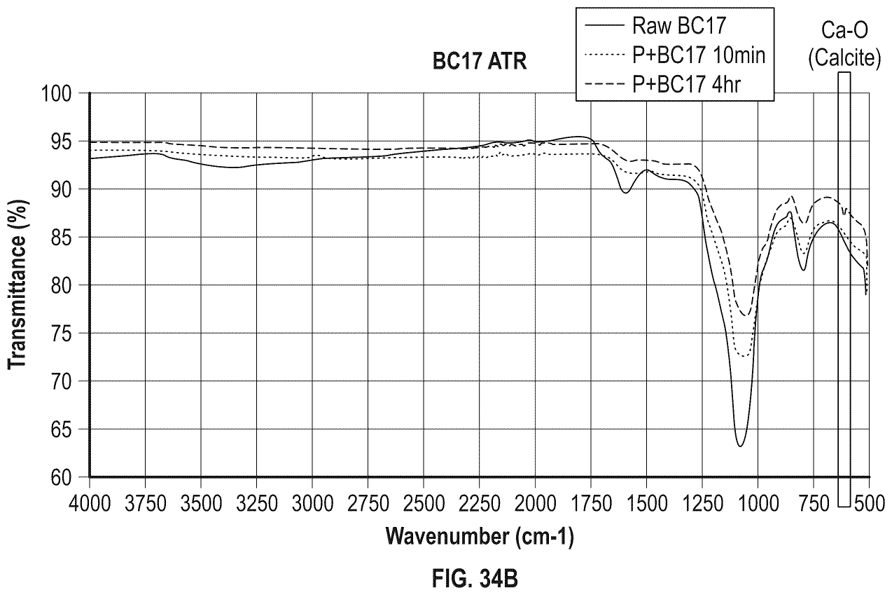

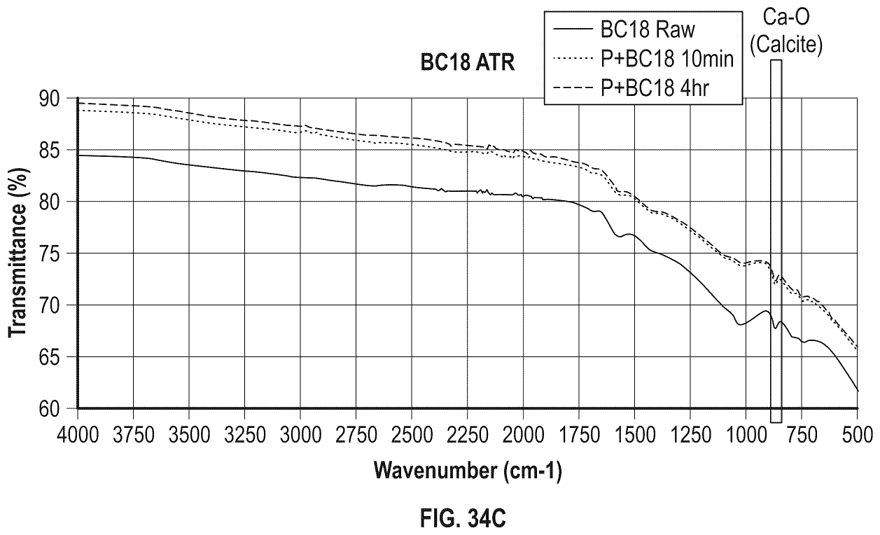

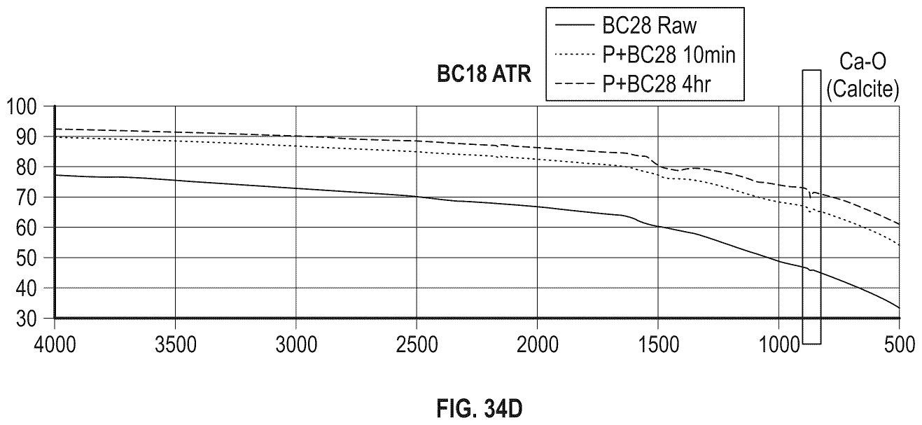

FIGS. 34A, 34B, 34C, and 34D show ATR-FTIR data of biochars contacted with a simulated cement pore solution. As the contacting time of biochars to the simulated cement pore solution increases, the peak indicating Ca—O bonding increases in intensity, showing CaCO₃ formation. This peak was observed for all four biochars tested in Example 11.

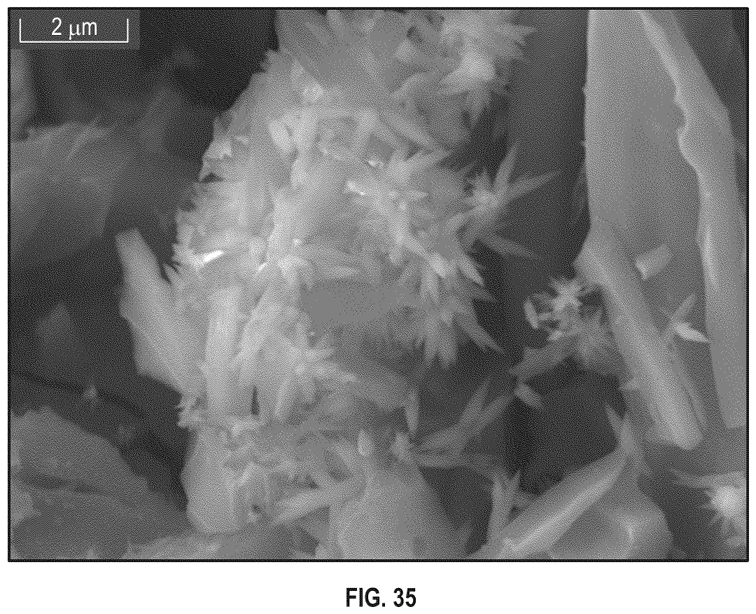

FIG. 35 shows an SEM image of a biochar following 18-hour contact with a simulated pore solution. Crystal growth of CaCO₃ on the surface of the biochar particles is observed.

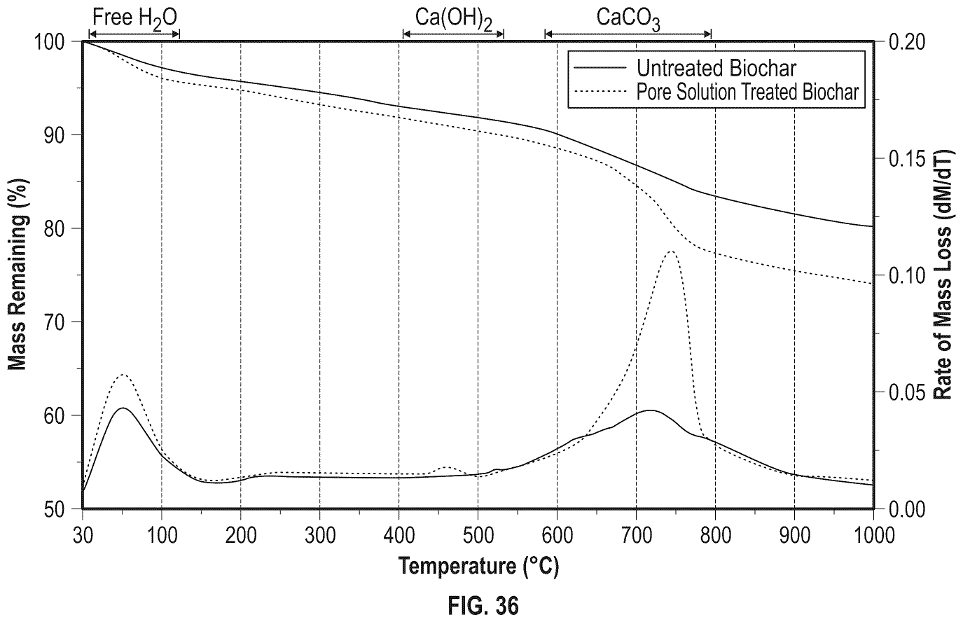

FIG. 36 shows the thermal decomposition results of a biochar BC10 (also referred to as HW.SP.02) after contact with a simulated cement pore solution. CaCO₃ is known to decompose from about 600° C. to about 900° C. in inert environments. The results show that the biochar forms more CaCO₃ after contact with a simulated cement pore solution than an untreated biochar.

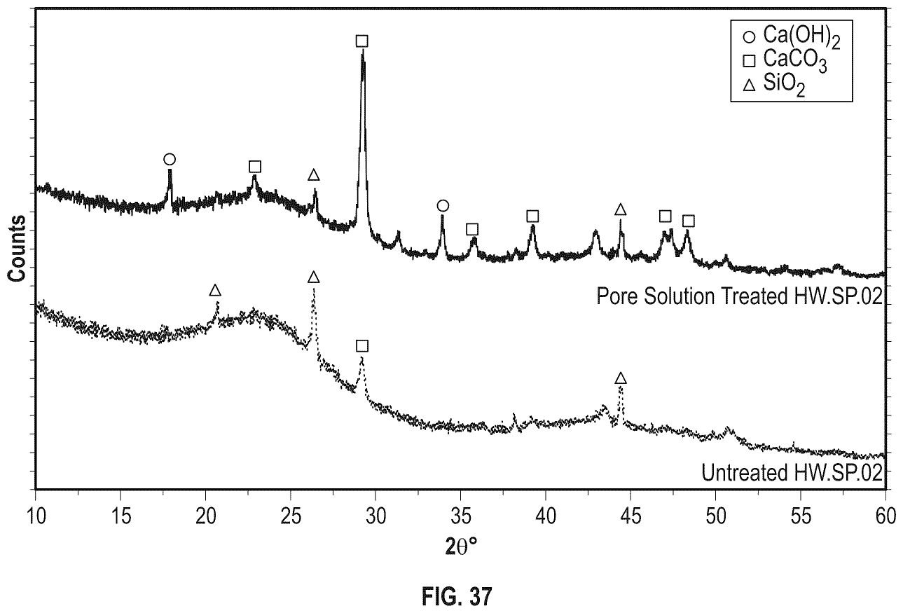

FIG. 37 shows the XRD analysis results of a biochar BC10 (also referred to as HW.SP.02) after contact with a simulated cement pore solution. CaCO₃ is known to decompose at temperatures from between about 600° C. to about 900° C. in inert environments. The results show that the biochar forms more CaCO₃ after contact with a simulated cement pore solution than a biochar uncontacted by a simulated cement pore solution.

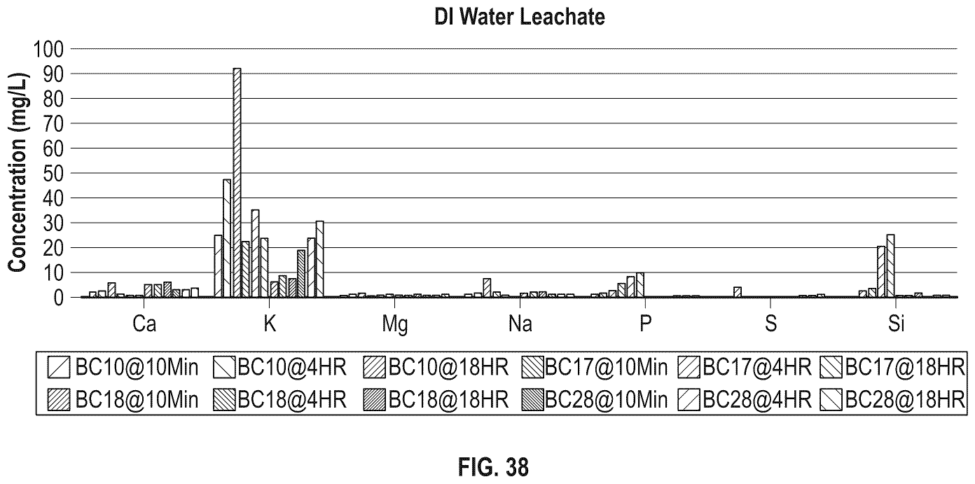

FIG. 38 shows the ICP-AES analysis results for ion concentrations for biochars prepared from different feedstocks and by different pyrolysis methods after contacting the biochars with DI water. One gram of ambiently dry biochar is added to a 250 mL flask with a magnetic stir bar, then 100 mL of DI water is added to the flask and mixed for three different exposure times (10 minutes, 4 hours, and 18 hours—note each exposure time was a new One gram biochar/100 mL liquid setup) before being vacuum filtered to separate the chemically treated biochar and the leachate. A portion of the leachate is additionally filtered through a 0.45 μm filter and acidified for ICP-AES analysis. The biochars show variation in the ion concentrations in the leachate after contacting the biochars with DI water, indicating that the type of feedstock and pyrolysis method used to prepare the biochar may affect the chemical composition of the biochar.

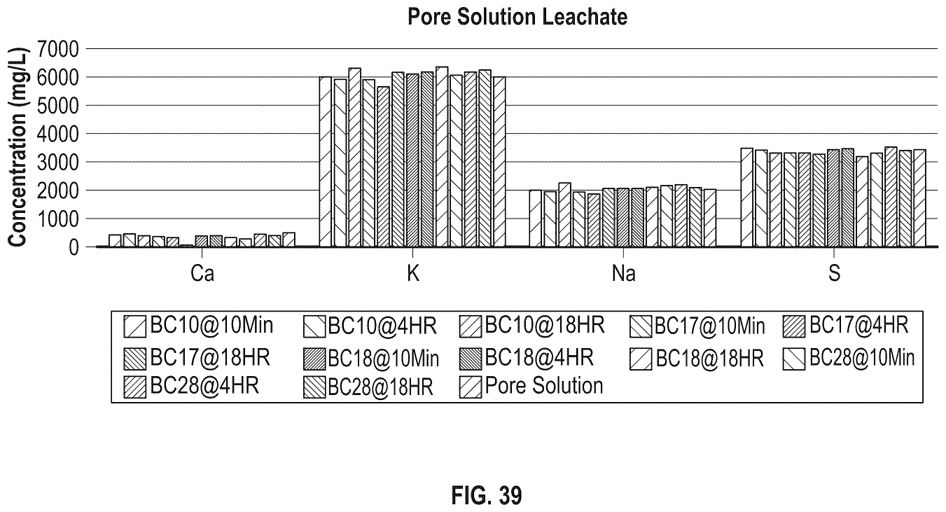

FIG. 39 shows the ICP-AES analysis results for ion concentrations for biochars prepared from different feedstocks and by different pyrolysis methods after contacting the biochars with simulated cement pore solution. One gram of ambiently dry biochar is added to a 250 mL flask with a magnetic stir bar, then 100 mL of simulated cement pore solution is added to the flask and mixed for three different exposure times (10 minutes, 4 hours, and 18 hours—note each exposure time was a new One gram biochar/100 mL liquid setup) before being vacuum filtered to separate the chemically treated biochar and the leachate. A portion of the leachate is additionally filtered through a 0.45 μm filter and acidified for ICP-AES analysis. The biochars show variation in the ion concentrations in the leachate after contacting the biochars with simulated cement pore solution, indicating that the type of feedstock and pyrolysis method used to prepare the biochar may affect the chemical composition of the biochar.

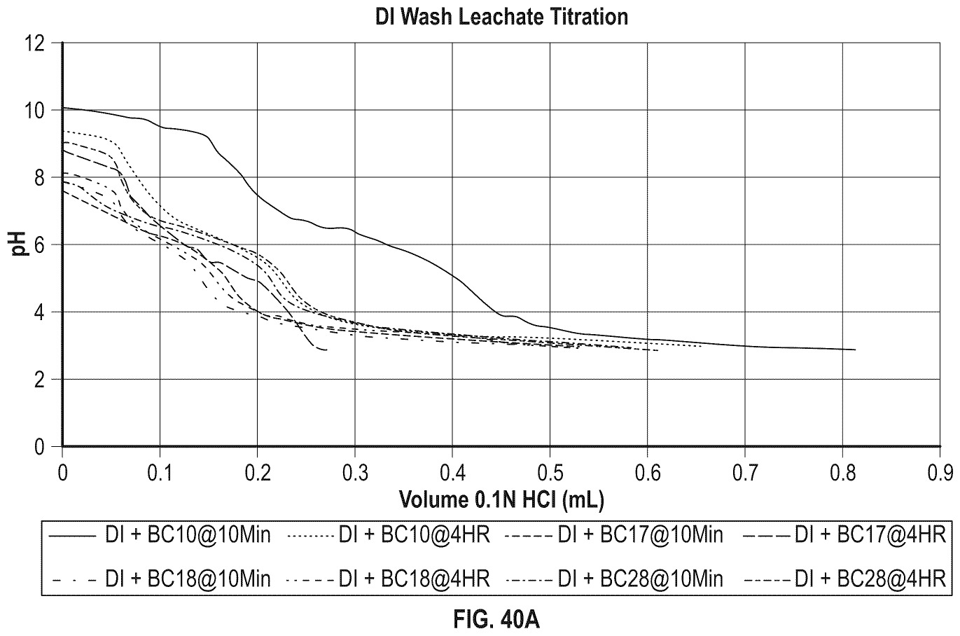

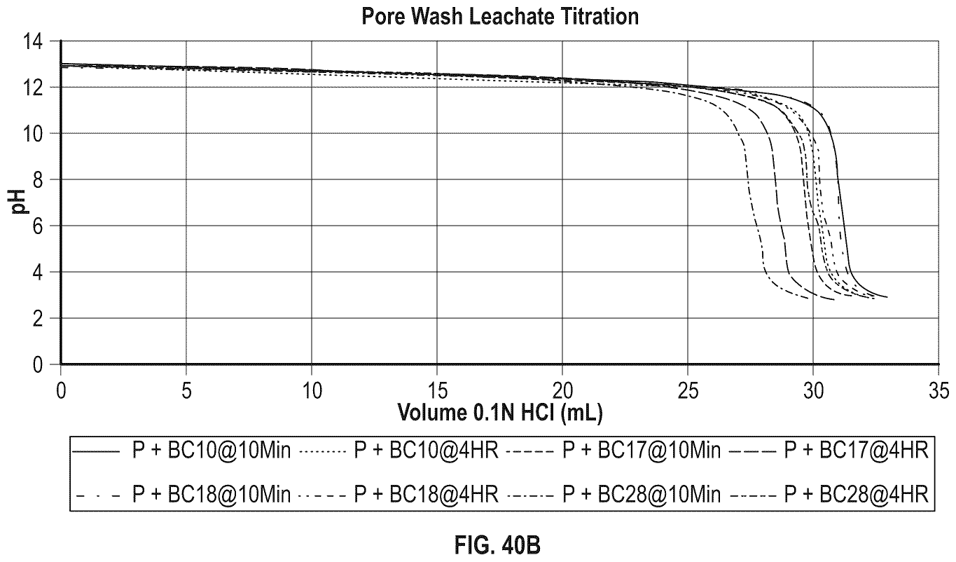

FIGS. 40A and 40B show alkalinity titrations for biochars prepared from different feedstocks and by different pyrolysis methods, after contacting the biochars with either DI water or simulated cement pore solution, respectively. One gram of ambiently dry biochar is added to a 250 mL flask with a magnetic stir bar, then 100 mL of either DI water or simulated cement pore solution is added to the flask and mixed for three different exposure times (10 minutes, 4 hours, and 18 hours—note each exposure time was a new One gram biochar/100 mL liquid setup) before being vacuum filtered to separate the chemically treated biochar and the leachate. About 30 mL of leachate is collected for alkalinity titrations. Increasing contact time contributes to a more alkaline initial pH in DI water, indicating that the biochar is contributing soluble anions to the DI water. Increasing contact time with the simulated cement pore solution contributes to a stronger buffering capacity for all but one of the tested biochars, BC28.

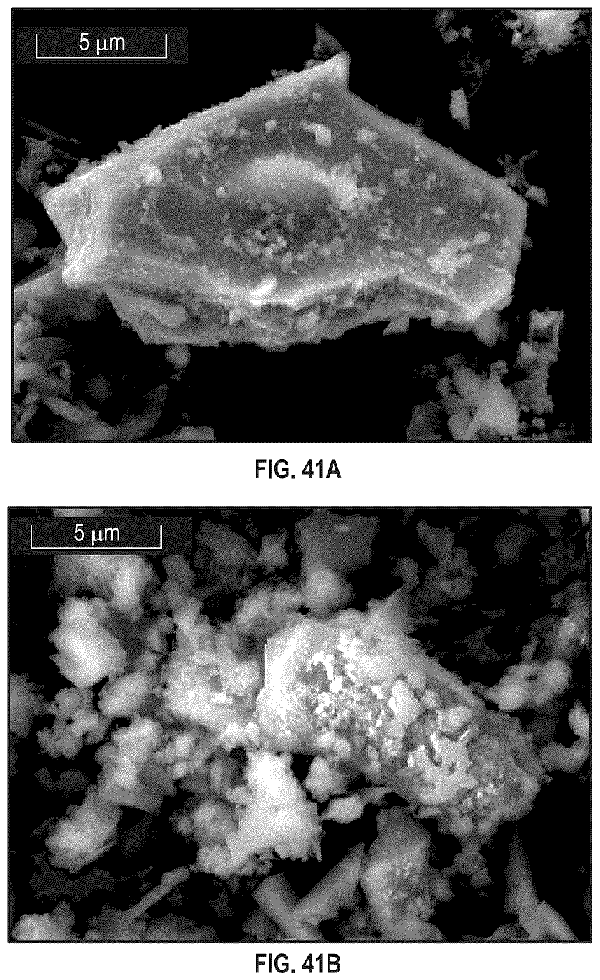

FIGS. 41A and 41B show the CaCO₃ crystal growth on a biochar particle contacted with simulated cement pore solution for 10 minutes and 4 hours, respectively. CaCO₃ crystal growth is observable after only 10 minutes of contact of the biochar particles with the simulated cement pore solution. The CaCO₃ crystal growth after 4 hours of contact between the biochar particles and the simulated cement pore solution is observed to be greater than the observable CaCO₃ crystal growth after only 10 minutes of contact.

The concrete composition may comprise a non-pozzolanic carbonaceous material. The concrete composition may comprise a compressive strength of at least about 40 MPa, about 40 MPa to about 80 MPa, about 45 MPa to about 75 MPa, about 50 MPa to about 70 MPa, about 55 MPa to about 65 MPa, or about 80 MPa. The concrete composition comprising a carbonaceous material may comprise an increased compressive strength of at least about 0%, about 0% to about 50%, about 5% to about 45%, about 10% to about 40%, about 15% to about 35%, about 20% to about 30%, or about 50% over the compressive strength of a concrete composition without carbonaceous material. The concrete composition comprising carbonaceous material may comprise at least about 2%, about 2% to about 80%, about 5% to about 75%, about 10% to about 70%, about 15% to about 65%, about 20% to about 60%, about 25% to about 55%, about 30% to about 50%, about 35% to about 45%, or about 80% carbonaceous material by weight. The concrete composition comprising carbonaceous material may comprise more than one carbonaceous material. The concrete composition comprising carbonaceous material may comprise at least about 0.5%, about 0.5% to about 50%, about 1% to about 45%, about 5% to about 40%, about 10% to about 35%, about 15% to about 30%, about 20% to about 25%, or about 50% replacement of cement mass with carbonaceous material. The concrete composition comprising carbonaceous material may comprise at least about 0%, about 0% to about 30%, about 5% to about 25%, about 10% to about 20%, or about 30% replacement of cement mass with supplementary cementitious material.

The carbonaceous material may comprise a non-pozzolanic carbonaceous material. The carbonaceous material may comprise at least about 10%, about 10% to about 90%, about 15% to about 85%, about 20% to about 80%, about 25% to about 75%, about 30% to about 70%, about 35% to about 65%, about 40% to about 60%, about 45% to about 55%, or about 90% carbon content by weight. The carbonaceous material may comprise an at least about 3%, about 3% to about 60%, about 5% to about 55%, about 10% to about 50%, about 15% to about 45%, about 20% to about 40%, about 25% to about 35%, or about 50% oxygen content by weight. The carbonaceous material may comprise an oxygen to carbon ratio of at least about 0, about 0 to about 10, about 1 to about 9, about 2 to about 8, about 3 to about 7, about 4 to about 6, or about 10. The carbonaceous material may comprise an ambient saturation of at least about 0%, about 0% to about 50%, about 5% to about 45%, about 10% to about 40%, about 15% to about 35%, about 20% to about 30%, or about 50% by weight. The carbonaceous material may comprise an ambient moisture content of at least about 0%, about 0% to about 20%, about 5% to about 15%, or about 20% by weight. The carbonaceous material may comprise a soluble silicon content of at least about 0%, about 0% to about 1%, about 0.1% to about 0.9%, about 0.2% to about 0.8%, about 0.3% to about 0.7%, about 0.4% to about 0.6%, or about 1% by weight. The carbonaceous material may comprise between about 0 wt. % to about 80 wt. % inorganic ash. The carbonaceous material may comprise a pH of between about 6 to about 13. The carbonaceous material may comprise between about 0 wt. % to about 80 wt. % ash. The carbonaceous material may comprise a mean particle size (D50) of between about 0.01 microns to about 20 microns. The carbonaceous material may comprise an average pore size of between about 12 Å to about 14 Å. The carbonaceous material may comprise a water holding capacity of between about 50 wt. % to about 130 wt. % based on the weight of the carbonaceous material. The carbonaceous material may replace a portion of the mass of cement in the concrete composition comprising carbonaceous material. The carbonaceous material may be subjected to pyrolysis torrefaction, gasification, or a combination thereof. The carbonaceous material may be subjected to a fast pyrolysis. The carbonaceous material may be subjected to a slow pyrolysis. The carbonaceous material may be subjected to a flash carbonization. The carbonaceous material may be subjected to gasification. The carbonaceous material may be subjected to torrefaction.

The carbonaceous material may contribute to the formation of CaCO₃ in a concrete composition comprising carbonaceous material. Carbonaceous material particles may form CaCO₃ crystals after contact with an alkaline solution. Contact between the carbonaceous material and the alkaline solution may occur for a time of at least about 10 minutes, about 10 minutes to about 18 hours, about 30 minutes to about 12 hours, about 1 hour to about 6 hours, or about 18 hours. Contacting a carbonaceous material with cement may form CO₂ gas. Contacting a carbonaceous material with cement in an alkaline solution may form CO₂ gas. Heating a concrete composition comprising carbonaceous material to a temperature of at least about 600° C., about 600° C. to about 900° C., about 700° C. to about 800° C., or about 900° C. may decompose CaCO₃ in the concrete composition comprising carbonaceous material. Heating a concrete composition comprising carbonaceous material to a temperature of between about 600° C. to about 900° C. may form CO₂ gas. Heating a concrete composition comprising carbonaceous material to a temperature of at least about 600° C., about 600° C. to about 900° C., about 700° C. to about 800° C., or about 900° C. in an inert environment may decompose CaCO₃ in the concrete composition comprising carbonaceous material. Heating a concrete composition comprising carbonaceous material to a temperature of at least about 600° C., about 600° C. to about 900° C., about 700° C. to about 800° C., or about 900° C. in an inert environment may form CO₂ gas.

The carbonaceous material may contribute soluble ions to a concrete composition comprising carbonaceous material. The soluble ions may increase the alkalinity of the concrete composition comprising carbonaceous material. The soluble ions may comprise cations. The soluble ions may comprise anions. The soluble ions may change the hydration products of the concrete composition comprising carbonaceous material.

The carbonaceous material may be derived from a feedstock. The feedstock may comprise softwood. The feedstock may comprise hardwood. The feedstock may comprise herbaceous material. The feedstock may comprise agricultural residues. The feedstock may comprise food. The feedstock may comprise wastes. The feedstock may comprise agricultural feedstocks. The feedstock may comprise forestry residues. The feedstock may comprise municipal solid wastes. The feedstock may comprise wastepaper. The feedstock may comprise pulp. The feedstock may comprise paper mill residues.

The concrete composition comprising carbonaceous material may further comprise a supplementary cementitious material (“SCM”). The SCM may include, but is not limited to, fly ash, slag, silica fume, or a combination thereof. The SCM may improve the compressive strength of the concrete composition comprising carbonaceous material compared to a concrete composition without carbonaceous material. The SCM may delay gains in compressive strength of the concrete composition comprising carbonaceous material compared to a concrete composition without carbonaceous material. The concrete composition comprising carbonaceous material may further comprise at least about 0 wt. %, about 0 wt. % to about 80 wt. %, about 10 wt. % and about 70 wt. % about 25 wt. % and about 50 wt. %, or about 80 wt. % SCM. The SCM may replace at least about 0%, about 0% to about 30%, about 5% to about 25%, about 10% to about 20%, or about 30%, of the mass of cement in the concrete composition comprising carbonaceous material. The SCM may be pozzolanic. The SCM may be carbon neutral.

The concrete composition comprising carbonaceous material may further comprise water. The concrete composition comprising carbonaceous material may comprise at least about 5 wt. %, about 5 wt. % to about 20 wt. %, about 10 wt. % to about 15 wt. %, or about 20 wt. % water. The water to cement ratio (w/c) may be at least about 0.3, about 0.3 to about 0.7, about 0.4 to about 0.6, or about 0.7. Carbonaceous material may not be included in the cement concentration used to calculate the w/c.

The concrete composition comprising carbonaceous material may further comprise a dispersing agent. The dispersing agent may increase the flow of concrete. The dispersing agent may reduce the water to cement ratio required for the concrete composition comprising carbonaceous material. The concrete composition comprising carbonaceous material may further comprise dispersing agent in a concentration sufficient for the concrete composition comprising carbonaceous material to comprise a flow of at least about 99%, about 99% to about 140%, about 105% to about 135%, about 115% to about 125%, or about 140% according to ASTM C1437. The concrete composition comprising carbonaceous material may further comprise at least about 130 mL dispersing agent/100 kg cement, about 130 mL dispersing agent/100 kg cement to about 800 mL dispersing agent/100 kg cement, about 200 mL dispersing agent/100 kg cement to about 600 mL dispersing agent/100 kg cement, about 400 mL dispersing agent/100 kg cement to about 500 mL dispersing agent/100 kg cement, or about 800 mL dispersing agent/100 kg cement. A concrete composition comprising carbonaceous material and further comprising dispersing agent may have a concrete slump value that is the same or greater than the concrete slump value of a control concrete composition without carbonaceous material. A concrete composition comprising carbonaceous material and further comprising dispersing agent may have a compressive strength that is the same or greater than the compressive strength of a control concrete composition without carbonaceous material. The compressive strength of a concrete composition comprising carbonaceous material and further comprising dispersing agent may be at least about 35 MPa, about 35 MPa and about 55 MPa, about 40 MPa and about 50 MPa, or about 55 MPa for moist-cured concrete compositions. The compressive strength of a concrete composition comprising carbonaceous material and further comprising dispersing agent may be at least about 35 MPa, about 35 MPa and about 55 MPa, about 40 MPa and about 50 MPa, or about 55 MPa for air-cured concrete compositions.

The concrete composition comprising carbonaceous material may further comprise an aggregate. The concrete composition comprising carbonaceous material may further comprise at least about 40 wt. %, about 40 wt. % to about 95 wt. %, about 50 wt. % to about 90 wt. %, about 60 wt. % to about 80 wt. %, about 95 wt. % aggregate. The aggregate may comprise sand. The aggregate may comprise gravel. The aggregate may comprise crushed stone. The aggregate may comprise coarse aggregate. The aggregate may comprise fine aggregate. The aggregate may comprise silica. The silica may be reactive silica.

The method may comprise the steps of: milling a carbonaceous material to form a milled carbonaceous material; and combining the milled with cement to form a concrete composition comprising carbonaceous material. The method may further comprise a non-pozzolanic carbonaceous material.

The method may further comprise milling the carbonaceous material to a minimum particle size (D10) of at least about 2.5 μm, about 2.5 μm to about 5 μm, about 3 μm to about 4 μm, or about 5 μm. The method may further comprise milling the carbonaceous material to a minimum particle size (D95) of at least about 15 μm, about 15 μm to about 30 μm, about 20 μm to about 25 μm, or about 30 μm. The method may further comprise milling the carbonaceous material to a mean particle size (D50) of at least about 0.01 μm, about 0.01 μm to about 20 μm, about 0.1 μm to about 15 μm, about 0.5 μm to about 10 μm, about 1 μm to about 5 μm, or about 20 μm. The milled carbonaceous material particles may comprise an average pore size of at least about 12 Å, about 12 Å to about 14 Å, about 12.5 Å to about 13 Å, or about 14 Å.

The method may further comprise the step of combining the concrete composition comprising carbonaceous material with water. The water to cement ratio (w/c) may be at least about 0.3, about 0.3 to about 0.7, about 0.4 to about 0.6, or about 0.7. The method may further comprise combining the concrete composition comprising carbonaceous material with a dispersing agent. The method may further comprise combining a dispersing agent with water to form a water-dispersing agent mixture. The method may further comprise combining the concrete composition comprising carbonaceous material with the water-dispersing agent mixture.

The method may further comprise combining an aggregate with the concrete composition comprising carbonaceous material. The method may further comprise combining supplementary cementitious material with the concrete composition comprising carbonaceous material.

Embodiments of the present invention provide a technology-based solution that overcomes existing problems with the current state of the art in a technical way to satisfy an existing problem for reducing concrete's carbon footprint. Embodiments of the present invention achieve important benefits over the current state of the art, such as maintaining or improving the compressive strength of concrete and increased sequestration of CO₂ to reduce concrete-associated carbon emissions. Some of the unconventional steps of embodiments of the present invention include milling the carbonaceous material to a minimum particle size (D10) of between about 2.5 μm to about 5 μm, milling the carbonaceous material to a minimum particle size (D95) of between about 15 μm to about 30 μm, milling the carbonaceous material to a mean particle size (D50) of between about 0.01 μm to about 20 μm, milling the carbonaceous material particles until the carbonaceous material particles comprise an average pore size of between about 12 Å to about 14 Å, and using a non-pozzolanic carbonaceous material in a concrete composition comprising carbonaceous material.

### EXAMPLES

The invention is further illustrated by the following non-limiting examples.

### Example 1

Biochars produced commercially from a variety of vendors and feedstocks were used in this experiment to cover a wide range of production parameters that are currently relevant to the market. Many of these biochar samples are produced from proprietary methods that are not disclosed. However, it is well documented that feedstock and pyrolysis conditions (e.g., pyrolysis temperature, pyrolysis heating rate) dictate many of the main differences between biochars so that is how the biochars are organized in this disclosure. Table 1 lists the samples and naming parameters used herein, in addition to the feedstock category, pyrolysis type, and temperatures for each sample.

TABLE 1
Biochar samples and pyrolysis parameters used herein.

| | Biochar | Feedstock | Pyrolysis | Temperature |
|---|---|---|---|---|
| Sample ID | Sample Name | Category | Type | (° C.) |
| BC02 | SW.FP.01 | Softwood | Fast | 760 |
| BC09 | SW.FP.02 | Softwood | Fast | 500 |
| BC11 | SW.FP.03 | Softwood | Fast | 500 |
| BC12 | SW.FP.04 | Softwood | Fast | 500 |
| BC19 | SW.FP.05 | Softwood | Fast | 500 |
| BC13 | SW.SP.01 | Softwood | Slow | 700 |
| BC14 | SW.SP.02 | Softwood | Slow | 700 |
| BC15 | SW.SP.03 | Softwood | Slow | 700 |
| BC06 | HW.FP.01 | Hardwood | Fast | 500 |
| BC10 | HW.FP.02 | Hardwood | Fast | 500 |
| BC03 | HW.SP.01 | Hardwood | Slow | 400 |
| BC07 | HW.SP.02 | Hardwood | Slow | 500 |
| BC16 | AG.G.01 | Agricultural | Gasification | 1100 |
| BC17 | AG.SP.01 | Agricultural | Slow | 450 |
| BC20 | AG.SP.02 | Agricultural | Slow | 800 |
| BC21 | AG.SP.03 | Agricultural | Slow | 800 |

“SW” softwood;
“HW” hardwood;
“AG” agricultural feedstock;
“FP” fast pyrolysis;
“SP” slow pyrolysis;
“G” gasification

After pyrolysis, the biochar samples were milled to below their macroporosity level, which took between 3 to 4 minutes. Unmilled biochar retains the biomass's cellular pore structure, and thus is brittle, resulting in decreased compressive strength in concrete compositions comprising biochar. FIGS. 1A and 1B show an example of what the milling step does to the biochar structure, before and after milling, respectively.

### Example 2

The particle size distribution (“PSD”) was measured for each biochar sample after milling, done in Example 1, using a laser particle size analyzer with isopropanol as the solvent. The refractive index of each biochar sample was set at 2.42. After milling, the particle size distributions of each biochar sample were comparable. Each biochar exhibited a minimum particle size (D10) from about 2.5 μm to 5 μm and a maximum particle size (D95) of about 15 μm to 30 μm, with one exception in the biochar sample, HW.FP.02, which had a maximum particle size of about 50 μm. All of the tested biochars had an average particle size (D50) that fell below 15 μm, showing that the milling process was effective at reducing the chars to below the macroporosity of the original feedstock.

Table 2 summarizes the particle size distribution of each milled biochar sample before being added to the concrete composition comprising biochar. Included in this table are the D10, D50, and D95 for the OPC and sand used in the tested mortar presented in later examples. All biochars had an average particle size, D50, below that of both the cement powder and sand.

TABLE 2
Particle size values for lower limit (D10), median
particle size (D50), and upper limit (D95)

| Sample/Mix | D10 (μm) | D50 (μm) | D95 (μm) |
|---|---|---|---|
| OPC Type I/II | 4.38 | 15.29 | 41.60 |
| Ottawa Sand | 240.00 | 396.00 | 581.00 |
| SW.FP.01 | 4.24 | 11.00 | 20.23 |
| SW.FP.02 | 4.26 | 12.37 | 26.95 |
| SW.FP.03 | 4.10 | 11.10 | 22.10 |
| SW.FP.04 | 4.21 | 11.84 | 24.56 |
| SW.FP.05 | 3.57 | 8.81 | 17.13 |
| SW.SP.01 | 3.57 | 9.60 | 17.63 |
| SW.SP.02 | 2.60 | 8.24 | 18.74 |
| SW.SP.03 | 2.77 | 7.38 | 16.25 |
| HW.FP.01 | 2.87 | 8.70 | 21.88 |
| HW.FP.02 | 4.12 | 13.53 | 49.83 |
| HW.SP.01 | 4.31 | 11.67 | 25.87 |
| HW.SP.02 | 4.00 | 10.85 | 22.45 |
| AG.G.01 | 5.16 | 13.71 | 22.16 |
| AG.SP.01 | 4.14 | 8.24 | 17.57 |
| AG.SP.02 | 3.29 | 8.01 | 15.57 |
| AG.SP.03 | 3.83 | 8.73 | 17.08 |

Surface area (BET) and average pore sizes of each biochar sample were measured using an ASAP 2020 Plus by Micromeritics. Roughly two grams to four grams of ambiently dry biochar was degassed at 100 degrees and then transferred to the analysis port. CO₂ was used as the analysis gas which has been shown to give more reliable results than N₂ for highly microporous materials like biochar. The sample tube was submerged in an ice bath during analysis where relative pressure was measured at 40 adsorption points and 5 desorption, with maximum P/P^{o} of 0.035.

Table 3 summarizes the surface area and average pore size of the micropores, measured on the desorption portion of the BET isotherm hysteresis. Consistently, the average pore size of the milled biochar is 13 to 14 Å. In relation to other characteristics, biochars with higher inorganic ash content, and thus a lower carbon content, had decreased surface area. However, there is not a strong single variable correlation between surface area and compressive strength, indicating that there may be a chemical influence driving compressive strength.

TABLE 3
Surface area and average pore size for each biochar sample.

| | CO₂ Surface Area | Average Pore Size |
|---|---|---|
| Sample/Mix | (m²/g) | (Å) |
| SW.FP.01 | 271.05 | 13.776 |
| SW.FP.02 | 190.68 | 13.192 |
| SW.FP.03 | 191.94 | 13.263 |
| SW.FP.04 | 201.50 | 12.848 |
| SW.FP.05 | 56.31 | 13.355 |
| SW.SP.01 | 241.22 | 13.057 |
| SW.SP.02 | 67.54 | 14.058 |
| SW.SP.03 | 297.56 | 13.704 |
| HW.FP.01 | 164.84 | 13.503 |
| HW.FP.02 | 176.21 | 13.774 |
| HW.SP.01 | 151.25 | 13.574 |
| HW.SP.02 | 148.29 | 13.182 |
| AG.G.01 | 177.20 | 13.992 |
| AG.SP.01 | 146.27 | 13.336 |
| AG.SP.02 | 218.52 | 13.897 |
| AG.SP.03 | 213.80 | 13.403 |

### Example 3

Proximate analysis of the biochars was conducted per ASTMD7582 in duplicate using TGA and ceramic crucibles. The volatile matter, fixed carbon content, and inorganic ash content were reported as wt. % of the dry biochar (dry basis) to compare all biochars without the influence of variable ambient moisture.

Ultimate complete combustion analysis was run on each biochar in triplicate to determine the carbon, hydrogen, nitrogen, and sulfur mass percentages. Oxygen content was calculated using Equation (1) below, which accounted for the inorganic oxygen and the mass contribution of other inorganic components.

$$O \% = 100 \% - C \% - N \% - S \% - H \% - Ash \% \qquad ( 1 )$$

The carbon content measured from ultimate analysis includes some hydrocarbons that are present as volatile matter whereas fixed carbon is measured after the volatile matter is removed. Table 4 shows the results of proximate and ultimate analysis for all biochars used in these experiments, with all categories reported as wt. % of the dried biochar.

TABLE 4
Proximate and Ultimate analysis of each biochar reported as wt. % of the dry mass.

| | Ash | Volatile | Fixed | | | | | |
|---|---|---|---|---|---|---|---|---|
| Sample/ | content | matter | carbon | Carbon | Hydrogen | Nitrogen | Sulfur | Oxygen |
| Mix | wt. % | wt. % | wt. % | wt. % | wt. % | wt. % | wt. % | wt. % |
| SW.FP.01 | 5.6 | 22.8 | 71.6 | 84.4 | 1.2 | 0.5 | 0.0 | 8.3 |
| SW.FP.02 | 5.0 | 26.1 | 68.9 | 80.3 | 3.6 | 0.4 | 0.0 | 19.0 |
| SW.FP.03 | 4.0 | 20.7 | 75.2 | 81.3 | 3.4 | 0.4 | 0.0 | 9.6 |
| SW.FP.04 | 5.5 | 23.9 | 70.7 | 82.8 | 3.4 | 0.4 | 0.0 | 7.1 |
| SW.FP.05 | 20.6 | 48.1 | 31.4 | 50.8 | 3.6 | 0.4 | 0.1 | 10.7 |
| SW.SP.01 | 5.5 | 23.9 | 70.7 | 43.7 | 0.6 | 0.2 | 0.0 | 13.7 |
| SW.SP.02 | 76.6 | 19.9 | 3.5 | 12.1 | 0.8 | 0.1 | 0.4 | 10.9 |
| SW.SP.03 | 5.9 | 18.1 | 76.0 | 49.0 | 3.0 | 0.3 | 0.0 | 7.9 |
| HW.FP.01 | 8.9 | 22.5 | 68.5 | 78.4 | 2.7 | 0.4 | 0.1 | 49.9 |
| HW.FP.02 | 4.2 | 16.3 | 79.5 | 78.4 | 3.3 | 0.4 | 0.0 | 10.0 |
| HW.SP.01 | 5.5 | 34.6 | 59.9 | 71.6 | 3.1 | 0.7 | 0.0 | 41.9 |
| HW.SP.02 | 15.7 | 12.5 | 71.8 | 76.0 | 0.5 | 0.7 | 0.0 | 19.8 |
| AG.G.01 | 3.4 | 17.3 | 84.9 | 42.2 | 2.2 | 1.0 | 0.1 | 9.0 |
| AG.SP.01 | 45.7 | 17.8 | 36.4 | 50.8 | 3.6 | 0.4 | 0.1 | 24.6 |
| AG.SP.02 | 4.2 | 5.0 | 90.8 | 90.3 | 1.1 | 1.0 | 0.0 | 3.4 |
| AG.SP.03 | 4.6 | 7.2 | 88.2 | 89.6 | 1.3 | 0.7 | 0.0 | 3.8 |

The fast pyrolysis biochar typically exhibits a higher carbon content, making their carbon sequestration potential higher. Again, because the pyrolysis processes of these industrially produced biochars are proprietary, we have no data on pyrolysis pressures, gas environments, or pre-processing steps, all of which may change the final elemental proportions. As carbon content increases, so does surface area as inorganic ash is more dense and less porous than the carbon structures. The H/C elemental ratio is used to model the stability of the biochar or the degree of aromaticity; the O/C ratio demonstrates the degree of carbonization and the abundance of oxygen containing functional groups; the N/C ratio may be used to model the abundance of nitrogen containing functional groups. The O/C ratio as determined by ultimate analysis only accounts for the organic oxygen, and not the oxygen associated with inorganic ash.

Without being limited by any particular theory, the O/C ratio may be indicative of the surface functionality and polarity of the biochar. The O/C ratio indicates the density of oxygenated functional groups on the biochar surface. Higher O/C ratios indicate more functional groups that increase surface reactivity due to oxygen's inherent polarity. Oxygen functional groups may be present due to incomplete pyrolysis leaving behind oxygen or because of surface oxidation from long-term exposure to the atmosphere. Of all the possible oxygen functional groups located on the surface of biochar (phenols, ethers, epoxy, carbonyls, carboxyls, carboxylic anhydrides, and quinones, all but two types (quinones and carbonyls) are considered acidic or weakly acidic functional groups. In the highly alkaline environment of cement solutions, these acidic functional groups would be deprotonated, forming water molecules and leaving the remaining functional group charged and therefore more reactive. The deprotonation and formation of a water molecule will reduce the overall alkalinity of the cement solution, slowing the dissolution of cement and overall decreasing the quantity of hydration products formed. Additionally, the newly formed water molecules will increase the effective water to cement ratio within the biochar, creating more void space between hydration products, resulting in reduced density and strength of the final concrete. This may counteract the benefit of the biochar's high sorption capacity, which adsorbs water and densifies the cement matrix.

Without being limited by any particular theory, even if the oxygen functional groups present were not acidic (and therefore were not deprotonated upon exposure to the alkaline cement solution), the polarity of these groups would increase the ambient water adsorption. This would result in the biochars being more saturated prior to mixing and increase the likelihood that the water molecules would be retained, thus reducing the benefit of internal curing. Additionally, the high polarity of oxygen functional groups makes them more interactive with polar molecules and cations, potentially hindering the hydration reactions occurring in the cement hydration reaction. However, although some properties of biochar may counteract strength development in concrete compositions, the overall benefit of the biochar's function as an internal curing agent outweighs these effects, ultimately making all concrete compositions comprising 10% biochar stronger than the control concrete composition without biochar.

To produce inorganic ash for elemental analysis, a 10 mL porcelain crucible was filled with biochar and placed in a benchtop muffle furnace at about 900° C. for at least 24 hours, or until the material maintained a constant weight in a TGA program set to heat at 10° C./min to 1000° C. A vent port in the muffle furnace allowed for the biochar to combust with the ambient atmosphere during the thermal treatment. The ashes of each sample were then analyzed for their oxide content using x-ray fluorescence (“XRF”). The Al, Si, Fe, Ca, Mg, S, Na, K, Cl, P, and Ti elements were measured and assumed to be present as oxides in the inorganic ash samples. These results were normalized by the wt. % ash content of each biochar. The XRF results are below in Table 5.

TABLE 5
XRF results for each biochar reported as simple
oxides and wt. % of total dry biochar

| Sample/ | SiO₂ | Al₂O₃ | Fe₂O₃ | CaO | MgO | SO₃ | Na₂O | K₂O | P₂O₅ | TiO₂ |
|---|---|---|---|---|---|---|---|---|---|---|
| Mix | wt % | wt % | wt % | wt % | wt % | wt % | wt % | wt % | wt % | wt % |
| SW.FP.01 | 1.75 | 0.44 | 0.33 | 1.50 | 0.34 | 0.05 | 0.09 | 0.68 | 0.00 | 0.25 |
| SW.FP.02 | 1.61 | 0.48 | 0.20 | 1.26 | 0.50 | 0.03 | 0.06 | 0.43 | 0.00 | 0.25 |
| SW.FP.03 | 1.20 | 0.26 | 0.14 | 1.21 | 0.40 | 0.03 | 0.06 | 0.31 | 0.00 | 0.31 |
| SW.FP.04 | 2.21 | 0.28 | 0.22 | 1.25 | 0.45 | 0.03 | 0.07 | 0.53 | 0.00 | 0.33 |
| SW.FP.05 | 11.68 | 2.47 | 0.11 | 4.33 | 0.46 | 0.00 | 0.16 | 0.92 | 0.00 | 0.17 |
| SW.SP.01 | 0.71 | 0.21 | 0.30 | 2.13 | 0.97 | 0.06 | 0.06 | 0.23 | 0.00 | 0.43 |
| SW.SP.02 | 40.33 | 9.61 | 2.22 | 13.47 | 2.45 | 0.28 | 0.50 | 4.67 | 0.01 | 1.43 |
| SW.SP.03 | 1.39 | 0.44 | 0.28 | 1.95 | 0.45 | 0.05 | 0.40 | 0.49 | 0.00 | 0.22 |
| HW.FP.01 | 4.25 | 0.11 | 0.21 | 2.83 | 0.38 | 0.03 | 0.02 | 0.69 | 0.00 | 0.22 |
| HW.FP.02 | 1.16 | 0.20 | 0.12 | 1.36 | 0.43 | 0.03 | 0.08 | 0.38 | 0.00 | 0.37 |
| HW.SP.01 | 0.11 | 0.02 | 0.02 | 1.64 | 0.30 | 0.05 | 0.04 | 0.84 | 0.00 | 2.43 |
| HW.SP.02 | 7.34 | 1.19 | 1.42 | 3.69 | 0.49 | 0.08 | 0.16 | 0.87 | 0.00 | 0.20 |
| AG.G.01 | 0.51 | 0.06 | 0.10 | 0.43 | 0.06 | 0.17 | 0.05 | 0.57 | 0.00 | 0.23 |
| AG.SP.01 | 43.84 | 0.08 | 0.11 | 0.14 | 0.23 | 0.00 | 0.11 | 0.35 | 0.00 | 0.32 |
| AG.SP.02 | 0.05 | 0.02 | 0.04 | 1.41 | 0.01 | 0.04 | 0.03 | 1.62 | 0.02 | 0.19 |
| AG.SP.03 | 0.29 | 0.03 | 0.07 | 1.92 | 0.23 | 0.11 | 0.49 | 0.28 | 0.03 | 0.21 |

For most of the biochars used in this study, the inorganic ash content is less than 10 wt. % of the total biochar mass. Only biochars SW.FP.04, SW.SP.02, HW.SP.02, and AG.SP.01 have more than 10 wt. % inorganic content. Total ash content (wt. %) is largely driven by feedstock type, and to a smaller degree pyrolysis technique, whereas composition of the inorganic oxides is feedstock specific. XRF cannot detect carbon or oxygen (or any element with less than two valence shells, i.e., any element before sodium in the periodic table) so the XRF results only show the composition of the inorganic components. Though XRF reports elemental compositions, for inorganic ash these elements are assumed to be present as simple oxides. Table 5 shows the composition of each biochar's ash. These values indicate the wt. % of oxides normalized by the ash content and the overall dry weight of the biochar. FIG. 15 shows the CaO, SiO₂, Al₂O₃, and Fe₂O₃ content in the ash for each biochar, since these may contribute pozzolanic properties in cementitious systems.

There was no statistically significant single-variable correlations between any of the measured oxides and compressive strengths of the concrete compositions comprising biochars, likely because most of the biochars had less than 10 wt. % inorganic ash content and were not found to be significantly soluble or reactive. It was previously believed that biochars exhibited pozzolanic activity. Surprisingly and unexpectedly, biochars of the present disclosure may demonstrate no pozzolanic behavior and may be inert. Biochars of the present disclosure may react to product calcium carbonate.

### Example 4

To measure the pH of each biochar, 10 g of biochar were mixed into 100 ml of DI water and stirred at 100-300 rpm on a stir plate for one hour. Then the biochar was filtered out using 3-μm filter paper. A pH probe (was immersed into the filtrate and allowed to stabilize before recording. All of the biochars used in this experiment had alkaline pHs but none were as alkaline as cement pore solution (pH about 13). In general, there was a trend that biochars pyrolyzed at a higher temperature had more alkaline pHs than biochars pyrolyzed at a lower temperature. FIG. 4 shows the pH of each biochar segmented by feedstock.

Two solvents to acquire ion concentrations were used. DI water was used but is limited by having a neutral pH, and so a simulated cement pore solution was created to provide more realistic alkaline conditions to measure the soluble ion concentrations of the biochars.

To investigate the soluble ions in each biochar, a one-gram sample of biochar was mixed with 100 g of DI water for 18 hours while being continuously stirred. The biochar was then filtered out and a sample of the filtrate was collected through a 0.45-micron filter, diluted twice, and analyzed with a PerkinElmer ICP-AES machine. The elemental content report results showed the mg/L of elements that had leached into the DI water during the biochar's exposure, summarized in Table 6 and FIG. 2.

Table 6 summarizes the relevant concentrations of soluble ions for each biochar sample. Though DI water will interact with the biochar differently than a highly alkaline cement slurry, this test is an indication of how strongly the inorganic content is bound to the surface of each biochar. The composition of the inorganic content, or ash content, of each biochar is mainly dictated by the feedstock source. The total soluble mass was not well correlated with the ash content. FIG. 2 shows the split of anions and cations dissolved for each biochar in DI water. Generally, fast pyrolysis biochars had a lower quantity of total soluble ions, except for HW.FP.02. For all the biochars, except SW.SP.01 and HW.SP.01, most of the dissolved ionic content was cations.

TABLE 6
Concentration of ions soluble in DI water for each biochar sample.

| | Al³⁺ | Ca²⁺ | K⁺ | Mg²⁺ | Na⁺ | P²⁻ | S²⁻ | Si |
|---|---|---|---|---|---|---|---|---|
| Sample/Mix | (mg/L) | (mg/L) | (mg/L) | (mg/L) | (mg/L) | (mg/L) | (mg/L) | (mg/L) |
| SW.FP.01 | 0.3 | 2.8 | 42.5 | 1.3 | 3.6 | 1.4 | 1.8 | 1.2 |
| SW.FP.02 | 0.6 | 5.0 | 39.9 | 0.6 | 6.3 | 0.3 | 4.2 | 1.2 |
| SW.FP.03 | 0.4 | 5.0 | 38.0 | 0.7 | 2.5 | 1.1 | 2.4 | 1.5 |
| SW.FP.04 | 0.4 | 5.0 | 30.7 | 0.6 | 2.0 | 1.7 | 2.4 | 1.6 |
| SW.FP.05 | 0.2 | 8.8 | 44.7 | 4.0 | 0.9 | 2.8 | 3.4 | 2.1 |
| SW.SP.01 | 0.1 | 6.3 | 70.3 | 5.9 | 1.2 | 1.5 | 1.0 | 1.7 |
| SW.SP.02 | 0.4 | 14.2 | 140.4 | 0.9 | 6.1 | 0.0 | 42.4 | 18.4 |
| SW.SP.03 | 0.5 | 2.5 | 42.3 | 0.9 | 29.4 | 1.6 | 1.4 | 1.6 |
| HW.FP.01 | 0.1 | 5.0 | 29.0 | 1.0 | 2.0 | 0.4 | 0.5 | 4.7 |
| HW.FP.02 | 0.4 | 5.8 | 92.0 | 1.9 | 7.6 | 2.8 | 4.2 | 2.7 |
| HW.SP.01 | 0.2 | 55.9 | 65.7 | 9.5 | 2.1 | 118.3 | 3.4 | 1.0 |
| HW.SP.02 | 1.5 | 16.9 | 27.7 | 0.9 | 4.0 | 0.0 | 1.0 | 6.8 |
| AG.G.01 | 0.2 | 6.7 | 224.7 | 6.7 | 5.6 | 30.1 | 9.4 | 2.3 |
| AG.SP.01 | 0.0 | 1.1 | 23.7 | 1.5 | 0.7 | 9.9 | 0.3 | 25.2 |
| AG.SP.02 | 0.0 | 2.4 | 57.9 | 0.7 | 0.8 | 0.7 | 0.3 | 1.1 |
| AG.SP.03 | 0.2 | 3.3 | 16.6 | 0.8 | 50.1 | 1.8 | 0.7 | 1.2 |

Concrete develops its strength through a complex precipitation reaction which ultimately forms hydration products in place of anhydrous cement grains. The progressive dissolution of cement powder and subsequent precipitation of hydration products out of the cement solution drives the reaction as it tries to maintain ionic equilibrium. The addition of biochar with soluble ions has the potential to alter the chemical process occurring during cement hydration.

An important cement hydration product is calcium-silicate-hydrate (“C—S—H”) which gives concrete its compressive strength. Adding a siliceous additive into a cement mix is a common way to increase the precipitation of C—S—H, typically yielding a stronger final product via pozzolanic reactions. Silica, present in many of the biochar samples studied here, becomes increasingly soluble as pH increases, so it should be noted that DI water with a neutral pH might not properly model the soluble quantity in cement solutions with a pH of 12-13. It was previously believed that biochars exhibited pozzolanic activity. Surprisingly and unexpectedly, biochars of the present disclosure may demonstrate no pozzolanic behavior and may be inert. Biochars of the present disclosure may react to product calcium carbonate.

The simulated cement pore solution was comprised of four salts to create the alkaline environment, which are listed in Table 7 below.

TABLE 7
Compounds and concentrations used to create
the simulated cement pore solution.

| Salt | Concentration |
|---|---|
| KOH | 0.1062M |
| Na₂SO₄ | 0.0489M |
| K₂SO₄ | 0.0370M |
| Ca(OH)₂ | 0.0212M |

Using the simulated cement pore solution and repeating the same wash and ICP-AES analysis done on the biochar in DI water, ion concentrations in a more realistic setting were collected, shown in Table 8 and visualized in FIG. 3. Besides the availability of calcium, potassium, sulfur, and sodium in cementitious solutions compared to the DI water wash, the simulated pore solution mimics concrete's alkaline environment with a pH of about 13. This alkaline pH will significantly change the solubility limits and overall kinetics of the solution. A “blank” of filtered pore solution was sent in for ICP-AES and was used to deduct the starting ion concentration from the biochar samples. Positive concentrations indicate ions that were released into the pore solution. Negative concentrations indicate ions that were consumed from the pore solution. Cations with relevant concentration changes are aluminum, calcium, potassium, magnesium, and sodium. Anions include sulfur and phosphorus assumed to be in the form of sulfate and phosphate. Silicon was not included in the cation or anion categories but was added to the total dissolved mass.

Many of the biochars consumed a significant amount of calcium and potassium from the simulated cement pore solution while releasing sulfur and sodium. The filtrates tested are expected to be at charge equilibrium so the cations consumed or released will need to be in solution with a balanced charge of anions. These anions could be carbonates, hydroxyls, phosphates, sulfates or other anions. These anions are not detectable with the ICP-AES method used. This shows that there may be more than a purely physical interaction happening when biochar is integrated into concrete compositions comprising biochar, dispelling the idea that biochar is a purely inert filler. This experiment demonstrates biochar's significant cation exchange capacity, shown in FIG. 3. Though there is significant ion exchange occurring in these systems, none of the ion concentrations measured after cement pore solution interaction were statistically significant in predicting final compressive strength.

TABLE 8
Concentration of soluble ions in simulated cement
pore solution for each biochar sample

| | Al³⁺ | Ca²⁺ | K⁺ | Na⁺ | P²⁻ | S²⁻ | Si |
|---|---|---|---|---|---|---|---|
| Sample/Mix | (mg/L) | (mg/L) | (mg/L) | (mg/L) | (mg/L) | (mg/L) | (mg/L) |
| Pore Solution | 0 | 437.3 | 6175.5 | 2190.5 | 0 | 3149.9 | 0 |
| SW.FP.01 | 0.02 | −75.2 | 118.6 | 29.3 | 0.0 | 2.3 | 1.6 |
| SW.FP.02 | 0.02 | −19.3 | 107.7 | 84.2 | −0.7 | 213.5 | 0.5 |
| SW.FP.03 | 0.05 | −18.6 | 100.2 | 83.3 | −1.3 | 228.3 | 0.0 |
| SW.FP.04 | 0.01 | −64.5 | −86.0 | −9.6 | 0.3 | 130.8 | 1.9 |
| SW.FP.05 | 0.08 | −183.9 | −120.5 | −50.9 | 0.0 | 44.5 | 1.1 |
| SW.SP.01 | 0.07 | −146.7 | −300.5 | −127.4 | −0.2 | −79.2 | 1.6 |
| SW.SP.02 | 0.08 | −201.0 | 180.8 | 19.7 | 0.8 | 115.5 | 2.3 |
| SW.SP.03 | 0.04 | −116.0 | −224.7 | −55.8 | 0.0 | 19.6 | 1.5 |
| HW.FP.01 | −0.02 | −78.4 | 99.3 | 7.4 | 0.0 | 20.8 | 0.1 |
| HW.FP.02 | 0.04 | −25.2 | 127.1 | 69.7 | 0.6 | 200.6 | −0.2 |
| HW.SP.01 | −0.02 | −100.6 | −19.5 | −43.8 | 0.2 | 20.0 | 0.5 |
| HW.SP.02 | 0.00 | −87.6 | 131.5 | 21.1 | 0.1 | 20.0 | 0.6 |
| AG.G.01 | −0.03 | −84.6 | 308.9 | 25.2 | 1.6 | 190.6 | 0.8 |
| AG.SP.01 | 0.08 | −397.4 | −414.2 | −128.1 | 0.6 | 68.5 | 23.5 |
| AG.SP.02 | 0.00 | 116.1 | 133.2 | 73.3 | −0.1 | 298.1 | −1.0 |
| AG.SP.03 | −0.43 | 122.7 | 124.4 | −20.6 | −4.1 | 155.2 | −1.9 |

The aqueous concentration of soluble silicon ions dissolved from biochar in DI water was found to have a positive influence on mortar compressive strength. Cement mixes with pozzolanic materials tend to gain strength slowly, reaching ultimate strength well beyond 28 days, however the concrete compositions comprising biochar did not seem to have any delay in strength development. Without being bound by any particular theory, it is more likely that the easily soluble silicon in the biochar reacts to form C—S—H first rather than in pozzolanic reactions where the slowly dissolving silicon reacts with the Ca(OH)₂ produced from the initial cement hydration reaction. This phenomenon also explains why the concentration of soluble silica is higher for the biochar-DI water analyte than for the biochar-pore-solution analyte, despite the solubility of silica increasing as pH increases. Since the simulated cement pore solution contains CaO, the soluble silica may be removed from solution by precipitating C—S—H, leaving a decreased concentration of soluble silica compared to the DI water analyte. Due to the alkaline pH, it is likely that the soluble silica available for precipitation of C—S—H is actually higher for biochar in a cement pore solution than in DI water; thus, the concentration measured after a DI water wash is likely a conservative estimate of the available soluble silica in a cementitious solution. It is possible that even stronger correlations with compressive strength would be observed if the simulated cement pore wash experiment were repeated with an alkaline pH solution devoid of calcium.

### Example 5

Each biochar used in this Example was stored in snap-close buckets from the time of milling until use. These containers allowed some exposure to the ambient atmosphere, resulting in some ambient moisture content in the biochars. Because the water to cement ratio is of such high importance for comparing compressive strength development in concrete compositions comprising biochar, the ambient moisture content of the biochars was measured and accounted for in the concrete compositions comprising biochar. Using TGA, 5 mg to 20 mg of ambiently stored biochar was run under a nitrogen flow and heated to 105° C. at 10° C./min and isothermally held until the weight stabilized, typically under 60 minutes. The mass loss was assumed to be 100% water vapor and used as the ambient moisture content.

Ambient saturation is a metric used to represent how “full” the biochar is with ambient moisture compared to its total uptake capacity. Each biochar has a different maximum sorption capacity, so the ambient saturation allows for comparison among different biochars. DI water was used for the ambient saturation calculation rather than the simulated cement pore solution (from Example 4) due to the higher cation exchange capacity of biochar in simulated cement pore solution compared to DI water. The exchanged mass muddies the change in mass from pure water uptake.

To measure the maximum water sorption capacity of each milled biochar sample, One gram of biochar was submerged in 10 g of DI water in a closed container. The biochar remained in solution for at least 24 hours to allow the biochar to fully adsorb. It has been shown in other studies that 24 hours is ample time for the biochars to fully saturate and low variability was confirmed. After saturation, the biochars were vacuum filtered through a prewetted 1 μm filter in a Buchner funnel for 5 to 10 seconds or until the standing water was removed and the matte black surface of the saturated biochar was exposed. A 10 mg to 30 mg sample was collected from the filter paper and run in the TGA under N₂ flow and isothermally held at 105° C. until the mass stabilized (about 20 minutes). The percent mass loss was divided by the remaining mass percent, resulting in the total liquid uptake capacity. The ambient saturation percentage was determined by dividing ambient moisture with total DI water uptake capacity. This metric compares the available potential of each biochar to uptake mix water once integrated into a mix. Equation (2) describes how saturated the biochar is before being integrated into the mortars.

$$ambient saturation ( \% ) = \frac{ambient moisture}{total DI uptake capacity} \qquad ( 2 )$$

The ambient saturation percentage of each biochar (the ratio of ambient moisture content and total water uptake capacity, calculated in equation (2)) has a negative influence on compressive strength, meaning that the biochars that were more saturated (normalized by their total capacity) before integration into a mortar mix ultimately developed less compressive strength than biochars that were less saturated and had more available liquid uptake capacity. Without being limited by any particular theory, the more water that a biochar may uptake (by weight) at the moment of integration (viz., the available liquid uptake percentage), the lower the effective w/c ratio in the composite after the biochar has fully saturated with water, and the higher the strength of the final composite. This is because the initial spacing of the anhydrous cement particles, which is controlled by the w/c ratio, is predictive of the void space in the hardened concrete. Additionally, if the biochar releases the adsorbed water over time, it may facilitate the precipitation of more hydration products, further densifying the pore network and increasing compressive strength. Here, the same quantity of biochar was added to each concrete composition comprising biochar, and the biochars that had higher ambient saturation compared to their total water uptake potential exhibited lower compressive strengths.

This experiment was repeated with the same process for biochars exposed to the simulated cement pore solution as described in Example 4. The results of ambient moisture content and ambient saturation percent for both liquids are in Table 9.

Some biochars have higher capacity for DI water than for the simulated cement pore solution while others show the opposite trend. Table 9 reports the DI water and simulated cement pore solution maximum sorption capacity for each biochar sample, per weight of dry biochar. Fast pyrolysis softwood biochars had higher adsorption capacity than the slow pyrolysis softwood biochars for both liquids. Generally, the sorption capacity for all softwood biochars was comparable regardless of liquid. The hardwood biochars produced by fast pyrolysis had higher DI water sorption capacity than the softwood biochars produced by slow pyrolysis. For all agricultural biochars, the simulated cement pore solution sorption capacity was higher than the DI water sorption capacity, most significantly for the slow pyrolysis biochars. There is no statistically significant correlation between liquid sorption capacity and surface area for these biochars, indicating that water sorption may not be purely a physical phenomenon in biochars. Without being limited by any particular theory, this suggests that if internal curing is driving strength development in biochar concrete, there is a chemical component that leads to water uptake.

TABLE 9
Liquid sorption capacities of biochar samples

| | | | Cement | |
|---|---|---|---|---|
| | | | pore | |
| | | DI water | solution | |
| | Ambient | uptake | uptake | Ambient |
| | Moisture | capacity | capacity | Saturation |
| Sample/Mix | (%) | (%) | (%) | (%) |
| SW.FP.01 | 1.2 | 109.1 | 111.9 | 1.1 |
| SW.FP.02 | 2.8 | 100.8 | 93.6 | 2.7 |
| SW.FP.03 | 1.5 | 106.3 | 100.9 | 1.4 |
| SW.FP.04 | 2.6 | 93.5 | 99.9 | 2.7 |
| SW.FP.05 | 2.8 | 102.7 | 116.7 | 2.6 |
| SW.SP.01 | 3.2 | 71.6 | 73.4 | 4.2 |
| SW.SP.02 | 5.0 | 66.2 | 59.2 | 7.0 |
| SW.SP.03 | 3.7 | 89.7 | 80.6 | 4.0 |
| HW.FP.01 | 1.7 | 118.4 | 112.1 | 1.4 |
| HW.FP.02 | 2.9 | 127.4 | 114.8 | 2.3 |
| HW.SP.01 | 2.1 | 96.4 | 156.0 | 2.2 |
| HW.SP.02 | 1.4 | 96.9 | 112.8 | 1.4 |
| AG.G.01 | 6.3 | 100.1 | 106.6 | 5.9 |
| AG.SP.01 | 5.7 | 70.2 | 104.7 | 7.5 |
| AG.SP.02 | 13.4 | 67.7 | 101.4 | 16.5 |
| AG.SP.03 | 13.7 | 76.8 | 79.8 | 15.1 |

### Example 6

All cementitious composition samples were made using the same Type I/II OPC powder from test sand sourced, conforming to ASTM C150 and C778 respectively. The XRF oxide composition of the cement used in this trial is shown in Table 10. Particle size distributions of dry materials used may be seen in FIG. 5. Each mix design used varying dosages of water reducing admixture, a liquid high-range water reducer, hereafter referred to as superplasticizer. Mix water was unfiltered tap water added at a ratio of 0.45 water to cement. Note that water was kept at a 0.45 ratio of cement, not binder; biochar was not considered cementitious in this experiment. The biochar was not stored in a humidity regulated environment; the ambient moisture content of the biochar was taken into consideration for the mix design. To keep the overall water to cement ratio constant for each mix, the ambient water content was subtracted from the overall mix water.

TABLE 10
Oxide composition of the OPC used herein, measured by XRF

| | SiO₂ | Al₂O₃ | Fe₂O₃ | CaO | MgO | SO₃ | Na₂O | K₂O | P₂O₅ | TiO₂ |
|---|---|---|---|---|---|---|---|---|---|---|
| | (wt. %) | (wt. %) | (wt. %) | (wt. %) | (wt. %) | (wt. %) | (wt. %) | (wt. %) | (wt. %) | (wt. %) |
| OPC | 19.34% | 4.12% | 3.29% | 62.96% | 0.75% | 3.01% | 0.17% | 0.84% | 0.10% | 0.17% |

The experiments disclosed herein used the same mix design method for each concrete composition comprising biochar as well as the control concrete composition without biochar. The base design was to make a control concrete composition without biochar with cement, sand, water, superplasticizer and for each concrete composition comprising biochar, replace about 10% of the control cement mass with an equal mass of biochar. The mix design was governed by a water to cement (w/c) mass ratio of 0.45.

Each concrete composition made twelve 50-mm³ cementitious cubes. All mixing was done in a mixer with the whisk attachment on speed four to speed 6. The dry ingredients were added first (sand, cement, and biochar) and dry mixed until visually homogeneous (about 5 minutes). Then, about 90% of the mix water was added while mixing, and then the remaining 10% of the water was mixed with superplasticizer and biochar and added slowly to the mixing bowl. The addition of water triggered the start of the mix time, which was carried out for about two to four minutes for all mixes with additional superplasticizer being added if the mix was too stiff, as measured by its flow following the procedure outlined in ASTMC1473. The actual superplasticizer dosage used is shown in Table 11. Finally, the concrete compositions were cast into the cubic molds per ASTMC109 and allowed to cure in a sealed environment 24 hours. The cubes were then demolded and moist cured in a saturated limewater bath until testing age.

The skeletal density of the milled biochars was measured using a pycnometer with helium gas as the displacement medium. The density measurement was conducted by averaging five cycles of pressurized inlet gas into a known volume and sample mass. The biochar was not dried prior to analysis. Results are included in the mix information in Table 11.

Note that for the concrete compositions comprising biochar which used biochar as a partial cement replacement, the w/c was kept at 0.45 though less cement was being used. The biochar was not considered to be cementitious in this situation, so the biochar mixes used slightly less water overall. Additionally, the biochars all had an ambient water content, which was measured and subtracted from the total mix water added. Table 11 shows the relevant measurements and resulting mix ratios used for each sample.

TABLE 11
Mix designs for the biochar mortars.

| | | Biochar | | | | | | Wet |
|---|---|---|---|---|---|---|---|---|
| | Biochar | Ambient | | | | | Superplasticizer: | Mix |
| | Density | Moisture | Cement | Sand | Biochar | Water | Cement | Flow |
| Sample/Mix | (g/cm³) | (wt. %) | (g) | (g) | (g) | (g) | (wt. %) | (%) |
| Control | — | — | 1000 | 2230 | 0 | 450 | 0.01 | 108 |
| SW.FP.01 | 1.9535 | 1.21% | 900 | 2230 | 100 | 403.8 | 1.01 | 128 |
| SW.FP.02 | 1.8635 | 2.84% | 900 | 2230 | 100 | 402.2 | 0.78 | 116 |
| SW.FP.03 | 1.8081 | 1.50% | 900 | 2230 | 100 | 403.5 | 0.80 | 115 |
| SW.FP.04 | 1.6942 | 2.57% | 900 | 2230 | 100 | 402.4 | 0.78 | 124 |
| SW.FP.05 | 1.5771 | 2.76% | 900 | 2230 | 100 | 402.2 | 1.34 | 120 |
| SW.SP.01 | 1.3974 | 3.15% | 900 | 2230 | 100 | 401.9 | 1.19 | 136 |
| SW.SP.02 | 2.6804 | 4.95% | 900 | 2230 | 100 | 400.1 | 0.44 | 107 |
| SW.SP.03 | 2.2774 | 3.73% | 900 | 2230 | 100 | 401.3 | 0.88 | 128 |
| HW.FP.01 | 1.6519 | 1.67% | 900 | 2230 | 100 | 403.3 | 1.12 | 110 |
| HW.FP.02 | 1.8868 | 2.94% | 900 | 2230 | 100 | 402.1 | 0.78 | 104 |
| HW.SP.01 | 1.5515 | 2.13% | 900 | 2230 | 100 | 402.9 | 2.78 | 99 |
| HW.SP.02 | 2.0772 | 1.37% | 900 | 2230 | 100 | 403.6 | 0.84 | 112 |
| AG.G.01 | 1.9382 | 6.25% | 900 | 2230 | 100 | 398.8 | 1.20 | 97 |
| AG.SP.01 | 1.7260 | 5.69% | 900 | 2230 | 100 | 399.3 | 1.12 | 140 |
| AG.SP.02 | 1.7520 | 13.40% | 900 | 2230 | 100 | 391.6 | 0.65 | 100 |
| AG.SP.03 | 1.8820 | 13.70% | 900 | 2230 | 100 | 391.3 | 0.64 | 96 |

### Example 7

Biochar was added to the mortar mix as a fine powder, with the average particle size smaller than the anhydrous cement grains added. Additionally, biochar is roughly half as dense as cement powder, so a 10% mass replacement is a much larger volume addition. Adding inert fillers has been shown to produce a filler effect which may increase the rate of dissolution of the cement grains in the mix, ultimately increasing the hydration product densification and thus the ultimate compressive strength. To investigate the impact of biochar particles on the shear rate the cement grains experience, calculations were run which took into account the measurements of cement, biochar, and sand surface areas, particle size distributions, and mix design proportions.

To investigate the impact of biochar particles added into mortar mixes, the interparticle shear rate and particle spacing were calculated. These values give an indication of the filler effect that is present in a mix. Using the mix proportions (M_{cement} and M_{biochar}), the surface area of the dry ingredients (BET_{cement} and BET_{biochar}), and the particle size distributions (D10 and D95 of all included particles), Equations (3) and (4) calculate the average distance between the surface of particles during mixing (δ). The relative packing fraction

$$( \frac{φ}{{φ}_{m}} )$$

uses the solid volume of the mix, φ, and the maximum packing fraction φₘ calculated in Equation (3).

$${φ}_{m} = 1 - 0.45 {( \frac{d 10}{d 95} )}^{0.19} \qquad ( 3 )$$

$$δ = ( \frac{6}{( \frac{{M}_{cement} * {BET}_{cement} + {M}_{biochar} * {BET}_{biochar}}{{M}_{c e m e n t} * B E {T}_{b i o c h a r}} ) \times ρ} ) \times ( {( \frac{φ}{{φ}_{m}} )}^{\frac{- 1}{3}} - 1 ) \qquad ( 4 )$$

The average distance between particle centers, H, is calculated by adding the distance between particle centers to the weighted average diameter of all particles included in the mix. Using the distance between particle surfaces, found in equation (4), and the average distance between particle centers, H, the shear rate experienced by the surface of the particles during mixing, γ, may be modeled by equation (5). The speed of the mixer (rpm), the distance from the center of the blade to the edge of the container, R₁, and the radius of the blade, R₂, are all relevant factors in calculating the shear rate on the particles in each mix.

$$γ = ( 2 \times rpm \times 2 π \times \frac{{R}_{1}^{2}}{{R}_{1}^{2} - {R}_{2}^{2}} ) \times \frac{H}{δ} \qquad Equation ( 5 )$$

For this experiment, rpm, R₁, and R₂ were held constant.

Table 12 reports the relative particle packing, interparticle distance, and shear rate values for each mix. Though all of the biochar mixes had significantly lower interparticle spacing and thus a higher interparticle shear rate, none of these factors emerged as highly impactful variables in predicting ultimate compressive strength. All biochar mixes had comparable or increased compressive strength compared to the control. Without being bound by any particular theory, it is possible that the higher shear rate of biochar mixes contributes to the strength development of mixes with less cement content, or it is possible that increased particle packing leads to a stronger composite, or it is possible both are contributing factors.

TABLE 12
Shear rate and interparticle spacing calculation results for each mix design.

| | $( \frac{φ}{{φ}_{m}} )$ | (δ) | |
|---|---|---|---|
| | Relative | Interparticle | (γ) |
| | Packing | Distance | Shear Rate |
| Sample/Mix | Fraction | [μm] | [s⁻¹] |
| Control | 0.862 | 0.1868 | 1592 |
| SW.FP.01 | 0.890 | 0.0094 | 30979 |
| SW.FP.02 | 0.894 | 0.0155 | 18651 |
| SW.FP.03 | 0.880 | 0.0165 | 17591 |
| SW.FP.04 | 0.888 | 0.0168 | 17438 |
| SW.FP.05 | 0.892 | 0.0127 | 23002 |
| SW.SP.01 | 0.891 | 0.0138 | 21184 |
| SW.SP.02 | 0.890 | 0.0130 | 22387 |
| SW.SP.03 | 0.892 | 0.0120 | 24104 |
| HW.FP.01 | 0.897 | 0.0097 | 29601 |
| HW.FP.02 | 0.875 | 0.0359 | 8230 |
| HW.SP.01 | 0.877 | 0.0095 | 30884 |
| HW.SP.02 | 0.896 | 0.0127 | 22999 |
| AG.G.01 | 0.894 | 0.0155 | 18758 |
| AG.SP.01 | 0.888 | 0.0377 | 7664 |
| AG.SP.02 | 0.891 | 0.0105 | 27486 |
| AG.SP.03 | 0.896 | 0.0102 | 28393 |

### Example 8

Compressive strength was used as the performance metric to evaluate how variance in biochar properties affects the cement structure. The cubes from Example 6 were used in these tests. The cubes were removed from the limewater bath in batches of 3 for compressive strength testing. After the desired cure time, the cubes were surface dried and weighted to calculate bulk density. The cubes were tested for unconfined compressive strength per ASTM C109. The stress at break was recorded for each of the three samples and averaged.

Compared to the control concrete composition without biochar, 13 of the 16 concrete compositions comprising biochar had comparable or improved compressive strength after 28 days of limewater curing, as shown in FIGS. 6 and 7. FIG. 8 shows a visual of the control concrete composition without biochar cube and a concrete composition comprising biochar cube after compressive strength testing with the fractures.

Unlike many other published works in this field, a 10% replacement of cement powder with milled biochar exhibited comparable or improved compressive strength after 28 days of curing, regardless of feedstock type or pyrolysis conditions for this subset. However, not all biochars behaved the same way. Most notably, HW.FP.01 improved the control compressive strength by just over 48%. While both feedstock and the pyrolysis process are important predictors of biochar characteristics, it is the physical and chemical characteristics of biochar that directly affect concrete strength development. These final compressive strengths were used as response variables to track which biochar characteristics best correlate with increased compressive strength.

### Example 9

To investigate the relevant variables that influence the 28-day compressive strength of concrete compositions comprising biochar with a 10% cement replacement, all the measured characteristics were aggregated from all of the above Examples, and several data processing techniques were applied to analyze variable importance. With more than 90 predictor variable categories (experimental measurements) and only 16 independent variables (biochar samples), it was infeasible to analyze all possible variable combinations in a best-subset linear model; there would be 2\hat{ }(# variables) which in this case is 90, resulting in 1.2×10²⁷ possible linear combinations. Even if the best-subset was feasible, this is a highly dimensional dataset which is susceptible to multicollinearity, meaning that there are likely several combinations of biochar characteristic variables that could potentially predict compressive strength results without being mechanistically sound.

To better understand the relevant predictor characteristics for compressive strength of concrete compositions comprising biochar, Pearson correlations, random forests, and boosted trees (“GBM”) were employed to study the intercorrelation and importance of individual predictor variables. The ultimate goal of these processing techniques was to optimize the final selection of the most important variables for a multivariate linear model. Primary component analysis (“PCA”) was used to better visualize the large dataset reduced to 2 dimensions (or primary components). Specific numerical outcomes of some of the tests performed follow below.

Ensemble methods like decision trees, random forests, and boosted trees are useful machine learning techniques in cases with highly dimensional datasets and output a score for each predictor variable. For the Random Forest and Boosted Tree algorithms used, the variable score is the measure of the reduction of Gini impurity that the variable contributes to the model.

For the Random Forest model, hyperparameters for the number of trees and “m” (the number of predictors to consider at each split) were tuned with 10-fold cross validation. Using the best hyperparameters, the average cross-validation RMSE was 4.317. Unfortunately, the best hyperparameters also resulted in a model that limited the number of variables to be considered for variable importance measures. Therefore, slightly different hyperparameters were used (RMSE of 4.785) that would allow for variable importance measures for nearly all variables across the ten folds.

In a similar fashion, a GBM model was constructed with hyperparameter tuning for the number of trees and learning rate “lambda”. The average cross-validation RMSE for GBM was 6.04. Provided the Random Forest model provided higher statistical scores, top 40 Random Forest variables were collected and used as the new variable subset to build linear models.

The top 40 variable scores from random forest were used to build linear models to fit the compressive strength results. Random Forest helped reduce the possible linear combinations from 1.2×10²⁷ down to 1.10×10¹². While it is still a large number of combinations, the computation is feasible with enough processing power and time. A ten-fold cross validation exhaustive best subset model and forward best subset model looped through all variable combinations to determine the top 1 to 11 variables, each time returning the best subset for each fold. After 4 to 5 predictor variables, depending on random seed for the model, the error (RMSE) increased drastically. This is the result of model overfit suffering from high variance. The most common variables picked for the best subset across the various folds were then used to create individual multiple regression models with weighted variable equations, RMSE, correlation coefficients, and p-values.

Principle component analysis (“PCA”) was conducted on the entire set of characteristic variables to condense the dimensionality of this dataset to see what variables and biochar samples are driving variances. FIG. 9 shows the first and second principal components of the biochar samples which explain 30% and 18% of the variance in the dataset, respectively. The farther from (0,0) a biochar is plotted on the 2D PCA graph, the more that biochar varies from the rest. Much of the variance within the entire characteristic dataset is driven by AG.SP.02, AG.SP.03, SW.SP.02, and SW.FP.05.

After pairing down the biochar characteristics to the most impactful 40 variables via random forest and GBM, then considering the top one, two, three, and four variable models from the 10-fold exhaustive and forward best subsets, several combinations of best variable subsets were linearly modeled. One variable combination emerged as a good linear model for the compressive strength results: oxygen to carbon atomic ratio (“O/C”), ambient saturation percentage, and soluble silica wt. %. This linear combination, Equation (6), had an average RMSE of 3.2 MPa, average variance across the 10 folds of 7.3 MPa, and a multiple R² value of 0.77 and an adjusted R² value of 0.71. This model has a strong negative dependence on ambient saturation percentage, showing that the higher the ambient saturation of a biochar, the less compressive strength it will likely contribute in concrete compositions comprising biochar. Additionally, there is a negative correlation between O/C and compressive strength. This model shows a positive dependence on soluble silicon concentration in each biochar, demonstrating that more Si is beneficial for strength development in concrete compositions comprising biochar. FIG. 10 shows a graphical correlation between the measured compressive strength values for each concrete composition comprising biochar and the strength calculated from Equation (6) taking these three key characteristic variables into consideration.

$$Compressive Strength = 65.03 - 71 \text{.2} * ( ambient saturation \% ) + 0.2 * ( DI Soluble Silicon ) - 18. 4 * ( \frac{O xygen \%}{C arbon \%} ) \qquad ( 6 )$$

This model found that a linear combination of initial saturation %, oxygen to carbon atomic ratio, and the quantity of Si soluble in DI water may explain 71% of the variance in the compressive strength results (adjusted R²=0.71 with an RMSE of 3.25 MPa). The linear regression model shows a negative correlation between initial saturation and compressive strength, a negative correlation between O/C and compressive strength, and a positive correlation between the concentration of soluble Si and compressive strength.

It should be noted that though this variable combination models this dataset well, it does not mean that another variable combination does not exist that would yield a statistically significant model of these compressive strength results. However, by using additional analysis methods to determine variable importance (random forest and GBM) and reducing the dimensionality of the initial characterization dataset, this is a strong analysis of the factors impacting compressive strength in this biochar dataset.

### Example 10

Cement paste comprising biochar and a control cement paste without biochar were mixed and analyzed via hyphenated thermogravimetric analysis with Fourier transform infrared spectroscopy (“TGA-FTIR”) to thermally decompose the hydrated pastes and analyze the evolved CO₂ gas via FTIR. The cement pastes used the mix proportions shown in Table 13 and were cast into individually sealed bags to prevent atmospheric carbonation. Therefore, all chemically combined CO₂ measured is from the interaction of the biochar and the cement system. The cement pastes were allowed to cure for ample time to ensure full hydration (70 days to 230 days). Several samples were tested to get an average chemically combined CO₂ content. After subtracting out the CO₂ decomposing from the biochar itself, the CO₂ evolved from the decomposing sample above about 600° C. is from carbonates.

TABLE 13
Mix proportions of cement pastes tested

| | |
|---|---|
| Control (OPC paste) | 5% Biochar (BC11 paste) |

| | | | | |
|---|---|---|---|---|
| Cement (OPC) | 10 | g | 9.5 | g |
| Biochar | 0 | g | 0.5 | g |
| DI Water | 9 | g | 9 | g |

Using both the mass loss and the FTIR spectra collected, the chemically bound water of hydrated cement pastes (which indicates successful cement hydration which is well correlated with compressive strength development) and CO₂ evolved from decomposing carbonates was quantified. Using the novel hyphenation of TGA-FTIR, the contribution of the biochar hydrates and carbonates was subtracted from the final chemically bound H₂O and CO₂ quantities. This shows that the control cement paste without biochar does not produce as much carbonation as a cement paste comprising biochar. The weight percent of CO₂ lost from decomposing carbonates in the cement pastes is shown in FIG. 30.

### Example 11

The goal of this study was to contact biochars with a simulated cement pore solution in order to study the chemical interactions separate from a cement system. The simulated cement pore solution is used in cementitious studies to model the key ionic concentrations and pH present in cement slurries. The compounds used in the simulated cement pore solution are shown in Table 14 below.

TABLE 14
Compounds used in the simulated cement pore solution

| Compounds | Concentration [M] |
|---|---|
| KOH | 0.1062 |
| Na₂SO₄ | 0.0489 |
| K₂SO₄ | 0.0370 |
| Ca(OH)₂ | 0.0212 |

One gram of ambiently dry biochar was added to a 250 mL flask with a magnetic stir bar, then 100 mL of a simulated cement pore solution was added to the flask and mixed for three different contact times (10 minutes, 4 hours, and 18 hours—note each contact time was a new One gram biochar/100 mL liquid setup) before being vacuum filtered to separate the chemically treated biochar and the leachate. This experiment was repeated with DI water as well. A portion of the leachate was additionally filtered through a 0.45 μm filter and acidified for ICP-AES analysis. About 30 mL of leachate was collected for alkalinity titrations. The chemically treated biochar was rinsed with isopropanol to remove the DI water or simulated cement pore solution and dried in a vacuum desiccator to significantly limit the potential for atmospheric carbonation. Once the treated biochar was dried, it was analyzed via ATR-FTIR analysis to identify changes in chemical composition. The dry biochar was also analyzed under SEM to investigate physical morphology. A summary of the experimental setup is shown in FIG. 32. Four biochars were used in this experiment that were prepared from different feedstocks and by different pyrolysis techniques. A summary of the characteristics of biochars used in this study is summarized in Table 15.

TABLE 15
Summary of biochar characteristics

| | BC10 | BC17 | BC18 | BC28 |
|---|---|---|---|---|
| Feedstock Group | Hardwood | Agricultural | Softwood | Softwood |
| Feedstock Source | Poplar | Rice Hulls | Pine | Forest |
| | | | | Residue |
| Pyrolysis Speed | Fast | Slow | Slow | Fast |
| Pyrolysis Temperature | 500 | 450 | 800 | 700 |
| (° C.) | | | | |
| Carbon % | 78.4% | 42.2% | 50.4% | 84.7% |
| *O/C ratio | 0.131 | 0.161 | 0.366 | 0.052 |
| *DI Soluble SI (mg/L) | 2.74 | 25.16 | 1.98 | 0.98 |
| *Ambient Saturation | 2.3% | 7.5% | 2.2% | 84.0% |
| (wt. %) | | | | |

ICP analysis showed that biochars contacted with the simulated cement pore solution consumed calcium ions; the calcium ion concentration of the simulated cement pore solution was higher prior to the biochars being contacted with the simulated cement pore solution. Each biochar consumed calcium ions present in the simulated cement pore solution, as shown in FIG. 33.

Biochars contacted with the simulated cement pore solution were also analyzed with ATR-FTIR. As seen in FIGS. 34A, 34B, 34C, and 34D as the contact time of biochars to the simulated cement pore solution increases, the peak indicating Ca—O bonding increases in intensity, showing CaCO₃ formation.

An SEM image of a biochar following 18-hour contact with the simulated pore solution in FIG. 35 shows crystal growth of CaCO₃ on the surface of the biochar particles.

Using thermal decomposition and XRD analysis, biochar BC10 (also referred to as HW.SP.02) was shown to form CaCO₃ after contact with the simulated cement pore solution, shown in FIGS. 36 and 37. CaCO₃ is known to decompose from about 600° C. to about 900° C. in inert environments.

The preceding examples may be repeated with similar success by substituting the generically or specifically described reactants and/or operating conditions of this invention for those used in the preceding examples.

Note that in the specification and claims, “about” or “approximately” means within twenty percent (20%) of the numerical amount cited. The terms, “a”, “an”, “the”, and “said” mean “one or more” unless context explicitly dictates otherwise.

Although the invention has been described in detail with particular reference to these embodiments, other embodiments may achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A concrete composition, comprising:
cementitious material;
carbonaceous material;
reactive silica; and
insoluble silicon.

2. The concrete composition of claim 1, further comprising a pozzolan.

3. The concrete composition of claim 2, wherein the pozzolan has pozzolanic activity.

4. The concrete composition of claim 1, wherein the carbonaceous material comprises biochar.

5. The concrete composition of claim 1, further comprising a supplementary cementitious material.

6. The concrete composition of claim 1, further comprising a dispersing agent.

7. The concrete composition of claim 4, wherein the biochar comprises at least about 60% organic material by weight.

8. A concrete composition comprising:
cementitious material; and
carbonaceous material, wherein at least a portion of the carbonaceous material has no pozzolanic activity.

9. The concrete composition of claim 8, wherein the carbonaceous material comprises biochar.

10. The concrete composition of claim 8, further comprising a supplementary cementitious material.

11. The concrete composition of claim 8, further comprising a dispersing agent.

12. The concrete composition of claim 9, wherein the biochar comprises at least about 40% organic material by weight.

13. The concrete composition of claim 8, further comprising soluble silicon.

14. A method of making a concrete composition, comprising:
milling a carbonaceous material to form a milled carbonaceous material, wherein at least a portion of the milled carbonaceous material has no pozzolanic activity;
combining the milled carbonaceous material with a cementitious material;
contacting the cementitious material with an aggregate;
contacting the cementitious material with water; and
subjecting the carbonaceous material to pyrolysis.

15. The method of claim 14, wherein the carbonaceous material comprises a biochar.

16. The method of claim 15, wherein the biochar comprises ash.

17. The method of claim 14, further comprising contacting the cementitious material with a dispersing agent.

18. The method of claim 14, wherein the water to cementitious material ratio is about 0.3 to about 0.7.

19. The method of claim 14, wherein the pyrolysis is a slow pyrolysis.

20. The method of claim 14, further comprising curing the milled carbonaceous material and cementitious material.
